(19) United States
(12) Patent Application Publication
(10) Pub. No.: US 2009/0075218 A1
(43) Pub. Date: Mar. 19, 2009

(54) SILVER HALIDE COLOR PHOTOGRAPHIC LIGHT-SENSITIVE MATERIAL

(75) Inventor: Shigeru Shibayama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/912,437

(22) PCT Filed: Apr. 27, 2006
(86) PCT No.: PCT/JP2006/309216

§ 371 Date: Oct. 24, 2007

(30) Foreign Application Priority Data
Apr. 28, 2005 (JP) 2005-131438

(51) Int. Cl. G03C 1/46

(52) U.S. Cl. 430/503

(57) ABSTRACT

A silver halide color photographic light-sensitive material, in which at least one of silver halide emulsion layers contains a silver halide emulsion having a silver chloride content of at least 90 mol % and being chemically sensitized with at least one compound of formula (1):

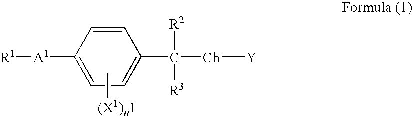

wherein Ch represents a sulfur, selenium, or tellurium atom; A¹ represents an oxygen or sulfur atom, or NR⁴; R¹ represents a hydrogen atom, or an alkyl alkenyl, alkynyl, aryl, heterocyclic, or acyl group; R², R³, and R⁴ represent a hydrogen atom, or an alkyl alkenyl, alkynyl, aryl, or heterocyclic group; X¹ represents a substituent; n¹ is 0 to 4; and Y represents, for example, a group of formula (2):

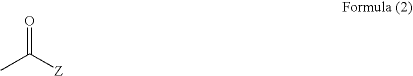

wherein Z represents an alkyl, alkenyl, alkynyl, aryl, or heterocyclic group, or OR⁵, or NR⁶R⁷, in which R⁵, R⁶ and R⁷ represent an alkyl alkenyl, alkynyl, aryl, or heterocyclic group.

### TECHNICAL FIELD

The present invention relates to a silver halide color photographic light-sensitive material. More specifically, the present invention concerns a silver halide color photographic light-sensitive material for print having excellent rapid-processing suitability, which material uses a silver halide emulsion that ensures high sensitivity and low fog by containing a novel chalcogen compound.

### BACKGROUND ART

In recent years, digitalization has been remarkably propagated also in the field of a color print using a silver halide color photographic light-sensitive material. For example, a digital exposure system by laser scanning exposure has been rapidly spread in comparison with a conventional analog exposure system of directly conducting a printing from a processed color negative film using a color printer. The digital exposure system is characterized in that a high image quality is obtained by conducting image processing, and it greatly contributes to improvement of qualities of color prints using a color photographic light-sensitive material. Further, it is also considered to be an important factor that a print with a high image quality is easily obtained from image information from these electronic recording media such as digital cameras. It is believed that they will lead to further remarkable popularization.

On the other hand, as a color print method, techniques, such as an ink jet method, a sublimated type method, and color xerography have progressed and are recognized for their ability of providing comparable image qualities to photography. In these competing techniques, characteristics of the digital exposure method using silver halide color photographic light-sensitive material reside in high image quality, high throughput, and high solidity (fastness) of obtained image. It is desired to further develop these characteristics and to provide high image quality color prints with low cost and in short period of time.

If so-called one-stop service of color prints becomes possible (i.e., one shop receives a recording medium of a digital camera from a customer and finishes processing, to return a high image-quality print to the customer in a short time such as a few minutes), the predominance of the color print using silver halide color photographic light-sensitive material will further increase. If rapid-processing suitability of silver halide color photographic light-sensitive material is raised, a processing apparatus can be downsized, and a printing apparatus which is smaller in size and lower in costs while having high productivity, can be used, and thus the one-stop service of a color print is expected to spread further.

To realize the one-stop service, analyses of silver halide color photographic light-sensitive material from various viewpoints, such as shortening of exposure time, shortening of so-called latent image time from the exposure to the initiation of the processing, shortening of processing time, and shortening of drying time after processing are required. Thus, conventionally, various kinds of proposals have been proposed based on such viewpoints.

Silver halide emulsions for use in silver halide color photographic light-sensitive material for print must meet various requirements as mentioned above. In a point of silver halide composition, a silver halide emulsion of a high silver chloride content (also referred to as “high-silver-chloride emulsion”) has been used primarily because of a demand for rapid processing. Further, it is known that developing speed is increased by reduction in sizes of emulsion grains (also referred to as “grain diameter”) contained in a silver halide emulsion, and arts relating thereto are disclosed (see, e.g., abstracts of lectures at the 2004 Autumn Convention of the Society of Photographic Science and Technology of Japan, (pages 20-21)). However, size reduction of emulsion grains causes reduced sensitivity, so the problem occurs that the sensitivity necessary for digital exposure cannot be attained. Therefore, there has been a need for development of techniques to increase sensitivities of high-silver-chloride emulsions.

Silver halide emulsions for use in silver halide photographic light-sensitive materials are, in general, chemically sensitized by using various chemical substances to obtain, for example, desired sensitivity and gradation. As typical methods for the chemical sensitization, various sensitizing methods, such as sulfur sensitization, selenium sensitization, tellurium sensitization; noble metal sensitization using, for example, gold; and combinations of these sensitizing methods, are known. Various improvements in the aforementioned sensitizing methods have been recently made to cope with a strong need, for example, for excellent granularity, high sharpness, and high sensitivity of silver halide photographic light-sensitive materials, and further rapid processing promoted by accelerating development.

It is known that a serenocarboxylate; namely, a sereno ester, may be used as a selenium sensitizer in a selenium sensitization among the aforementioned sensitizing methods. Examples of disclosures showing specific compounds include U.S. Pat. No. 3,297,446, U.S. Pat. No. 3,297,447, and JP-B-57-22090 (“JP-B” means examined Japanese patent publication).

Although there is the case in which a selenium sensitizer has a greater sensitizing effect than a sulfur sensitizer used in the fields of the art, such a selenium sensitizer largely tends to cause much fogging, to result softened gradation, and to cause increased variation of sensitivity during storage. Many patent publications have been disclosed aiming to improve these drawbacks. However, satisfactory results have not yet been brought by these improvements, and there has been a strong need for basic improvement, in particular, for greater suppression of the occurrence of fogging. Also, if sulfur sensitization, selenium sensitization, or tellurium sensitization is used in combination with gold sensitization, respectively, sensitivity is significantly increased in each case. However, fogging is increased at the same time. Although, particularly, gold-selenium sensitization and gold-tellurium sensitization result in greater sensitivity than gold-sulfur sensitization, they also result in much fogging, and they are apt to result increased gradation softness. There remains, therefore, a strong need for development of a selenium sensitizer and a tellurium sensitizer that give increased sensitivity, less fogging, and increased gradation hardness.

In this situation, the following compounds are described as examples of useful selenium sensitizers: diacyl serenide compounds, as described in JP-A-4-271341 (“JP-A” means unexamined published Japanese patent application); compounds in which two carbonyl groups are bonded with a selenium atom, as described in JP-A-5-11385; and selenocarboxylic acid (Se-ester) compounds, as described in JP-A-7-140579. Although these compounds are disclosed to enable suppressing fogging to a low level and achieving high sensitivity, they nonetheless remain unsatisfactory, and development of compounds that can better suppress fogging and attain higher sensitivity has been desired.

It is also known that many selenium compounds and tellurium compounds generally have lower stability than corresponding sulfur compounds. Not a few selenium compounds and tellurium compounds to be used as chemical sensitizers have less comparative stability. When these compounds are stored in a solution state, they resultantly gradually decompose. There is, therefore, a tendency for there to be a large difference in sensitivity, fogging, gradation, and the like, between the case of producing a light-sensitive emulsion just after a solution of a selenium compound or tellurium compound is prepared, and the case of producing a light-sensitive emulsion a while after the solution is prepared. Therefore, chemical sensitizers that suppress fogging to attain high sensitivity are desired to have higher stability.

In this background, there is strong need for development of a gold-chalcogen sensitizer that can largely increase the sensitivity and causes less occurrence of fogging.

### DISCLOSURE OF INVENTION

According to the present invention, there is provided the following means:

(1) A silver halide color photographic light-sensitive material having, on a support, at least one red-sensitive silver halide emulsion layer, at least one green-sensitive silver halide emulsion layer, and at least one blue-sensitive silver halide emulsion layer, wherein at least one of the silver halide emulsion layers contains a silver halide emulsion having a silver chloride content of at least 90 mol % and being chemically sensitized with at least one compound represented by the following formula (1):

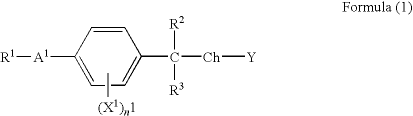

wherein, in formula (1), Ch represents a sulfur atom, a selenium atom, or a tellurium atom; A¹ represents an oxygen atom, a sulfur atom, or NR⁴; R¹ represents a hydrogen atom, an alkyl group, an alkenyl group, an alkynyl group, an aryl group, a heterocyclic group, or an acyl group; R², R³, and R⁴ each independently represent a hydrogen atom, an alkyl group, an alkenyl group, an alkynyl group, an aryl group, or a heterocyclic group; X¹ represents a substituent; n¹ is an integer from 0 to 4; when n¹ is 2 or more, X¹s may be the same or different; and Y represents a group selected from groups represented by the following formula (2), (3), (4), or (5):

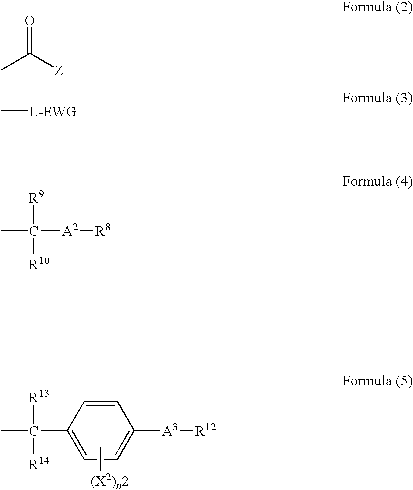

wherein, in formula (2), Z represents an alkyl group, an alkenyl group, an alkynyl group, an aryl group, a heterocyclic group, OR⁵, or NR⁶R⁷, in which R⁵, R⁶, and R⁷ each independently represent an alkyl group, an alkenyl group, an alkynyl group, an aryl group, or a heterocyclic group;

wherein, in formula (3), L represents a divalent linking group; and EWG represents an electron withdrawing group;

wherein, in formula (4), A² represents an oxygen atom, a sulfur atom, or NR¹¹; and R⁸, R⁹, R¹⁰, and R¹¹ each independently represent a hydrogen atom, an alkyl group, an alkenyl group, an alkynyl group, an aryl group, or a heterocyclic group;

wherein, in formula (5), A³ represents an oxygen atom, a sulfur atom, or NR¹⁵; R¹² represents a hydrogen atom, an alkyl group, an alkenyl group, an alkynyl group, an aryl group, a heterocyclic group, or an acyl group; R¹³, R¹⁴, and R¹⁵ each independently represent a hydrogen atom, an alkyl group, an alkenyl group, an alkynyl group, an aryl group, or a heterocyclic group; X² represents a substituent; n² is an integer from 0 to 4; when n² is 2 or more, X²s may be the same or different.

(2) The silver halide color photographic light-sensitive material as described in (1), wherein the blue-sensitive silver halide emulsion layer is substantially free of silver halide grains greater than 0.50 μm in side length.

The present invention provides a small-sized, high-silver-chloride silver halide emulsion that is increased in sensitivity, reduced in fog, and improved in storability. Further, the present invention provides a silver halide color photographic light-sensitive material that has rapid-processing suitability and is improved in fog attributable to processing variations.

In accordance with the present invention, a small-sized, high-silver-chloride silver halide emulsion ensuring high sensitivity, slight fog, and good storage stability can be provided. By use of such an emulsion, a silver halide color photographic light-sensitive material having excellent rapid-processing suitability, and showing an improvement in fog attributable to processing variations, can be provided.

Other and further features and advantages of the invention will appear more fully from the following description.

### BEST MODE FOR CARRYING OUT INVENTION

Embodiments of the present invention are described below in detail.

The silver halide color photographic light-sensitive material of the present invention is a silver halide color photographic light-sensitive material having, on a support, at least one red-sensitive silver halide emulsion layer, at least one green-sensitive silver halide emulsion layer, and at least one blue-sensitive silver halide emulsion layer, and at least one of these silver halide emulsion layers contains a silver halide emulsion having a silver chloride content of 90 mol % or more and being chemically sensitized with at least one compound represented by the foregoing formula (1).

The silver halide emulsion having a silver halide content of at least 90 mol % (also referred to as “high-silver-chloride emulsion”) according to the present invention and silver halide emulsion grains constituting the emulsion are described in detail.

From the viewpoint of rapid-processing suitability, it is desirable for the silver chloride content in a silver halide emulsion for use in the present invention to be generally 90 mol % or more, preferably 95 mol % or more, especially preferably 97 mol % or more. One light-sensitive silver halide emulsion layer may contain a mixture of two or more types of silver halide emulsions. In this case, the foregoing value of 90 mol % or more concerning the silver chloride content means the average silver chloride content in all silver halide emulsions included in the emulsion layer. The average silver chloride content in this case is also preferably 95 mol % or more, especially preferably 97 mol % or more.

Silver halide emulsions for use in the present invention may contain silver bromide, and the silver bromide contents therein are preferably from 0 to 5.0 mol %. From the viewpoints of increasing sensitivity and improving reciprocity law failure, it is favorable to contain silver bromide in a proportion of at least 0.1 mol %. In this sense, the silver bromide content is preferably 0.3 mol % or more, especially preferably 0.5 mol % or more. From the viewpoint of rapid-processing suitability, on the other hand, in order to suppress development retardation arising from accumulation of bromide ions in a processing solution, the silver bromide content is preferably 4 mol % or less, especially preferably 3 mol % or less.

Silver halide emulsions for use in the present invention may also contain silver iodide, and the silver iodide contents therein are preferably from 0 to 1 mol %. From the viewpoint of increasing sensitivity, it is favorable to contain silver iodide in a proportion of at least 0.05 mol %. In this sense, the silver iodide content is preferably 0.1 mol % or more, and especially preferably 0.15 mol % or more. From the viewpoint of processing suitability, on the other hand, the silver iodide content is preferably 0.5 mol % or less, especially preferably 0.3 mol % or less.

The halogen compositions of silver halide emulsions can be identified by arbitrary combining X-ray diffraction, EPMA (also called as XMA) method (in which silver halide emulsion grains are scanned by an electron beam, to detect their silver halide compositions), ESCA (also called as XPS) method (in which X rays are radiated, to perform spectroscopy for photoelectrons emitted from the grain surface), and the like.

The silver halide grains in the silver halide emulsion for use in the present invention, each preferably have a silver-bromide-containing phase and/or a silver-iodide-containing phase. Herein, the term “silver-bromide-containing phrase” or “silver-iodide-containing phase” means a region where the content of silver bromide or silver iodide is higher than that in the surrounding regions. The halogen compositions of the silver-bromide-containing phase or the silver-iodide-containing phase and of the surrounding region (outer periphery) may vary either continuously or drastically. Such a silver-bromide-containing phase or silver-iodide-containing phase may form a layer which has an approximately constant concentration in a certain width at a portion in the grain, or it may form a maximum point having no spread. The local silver bromide content in the silver-bromide-containing phase is preferably 5 mol % or more, more preferably from 10 to 50 mol %, and most preferably from 15 to 30 mol %. The local silver iodide content in the silver-iodide-containing phase is preferably 0.3 mol % or more, more preferably from 0.5 to 8 mol %, and most preferably from 1 to 5 mol %. Such a silver-bromide- or silver-iodide-containing phase may be present in plural numbers in layer form, within the grain. In this case, the phases may have different silver bromide or silver iodide contents from each other.

It is preferable that, when the silver halide emulsion grains for use in the present invention have the silver-bromide-containing phase or silver-iodide-containing phase, the phrase be formed in a layer form so as to surround the grain center. One preferred embodiment is that the silver-bromide-containing phase or silver-iodide-containing phase formed in a layer form so as to surround the grain, has a uniform concentration distribution, in the circumferential direction of the grain, in each phase. However, in the silver-bromide-containing phase or the silver-iodide-containing phase formed in a layer form so as to surround the grain, there may be the maximum point or the minimum point of the silver bromide or silver iodide concentration in the circumferential direction of the grain, to have a concentration distribution. For example, when an emulsion grain has a silver-bromide-containing phase or silver-iodide-containing phase formed in a layer form so as to surround the grain, in the vicinity of the grain surface, the silver bromide or silver iodide concentration of a corner portion or of an edge of the grain can be different from that of a principal face of the grain. Further, aside from the silver-bromide-containing phase and/or silver-iodide-containing phase formed in a layer form so as to surround the grain, another silver-bromide-containing phase and/or silver-iodide-containing phase not surrounding the grain may exist in isolation at a specific portion of the surface of the grain.

In a case where a silver halide emulsion grain contains a silver-bromide-containing phase, it is preferable that said silver-bromide-containing phase be formed in a layer form so as to have a concentration maximum of silver bromide inside the grain. Likewise, in a case where a silver halide emulsion grain contains a silver-iodide-containing phase, it is preferable that said silver-iodide-containing phase be formed in a layer form so as to have a concentration maximum of silver iodide on the surface of the grain. Such a silver-bromide-containing phase or silver-iodide-containing phase is constituted preferably with a silver amount of 5% to 30%, more preferably with a silver amount of 10% to 20%, in terms of the grain volume, in the viewpoint of increasing the local concentration with a smaller silver bromide or silver iodide content.

The silver halide grains of the silver halide emulsion for use in the present invention preferably each contain both a silver-bromide-containing phase and a silver-iodide-containing phase. In this case, the silver-bromide-containing phase and the silver-iodide-containing phase may exist either at the same place in the grain or at different places thereof. Further, a silver-bromide-containing phase may contain silver iodide. Alternatively, a silver-iodide-containing phase may contain silver bromide. In general, an iodide added during formation of high-silver-chloride grains is liable to ooze to the surface of the grain more than a bromide, so that the silver-iodide-containing phase is liable to be formed at the vicinity of the surface of the grain. Accordingly, when a silver-bromide-containing phase and a silver-iodide-containing phase exist at different places in a grain, it is preferred that the silver-bromide-containing phase be formed more internally than the silver-iodide-containing phase. In such a case, another silver-bromide-containing phase may be provided further outside the silver-iodide-containing phase in the vicinity of the surface of the grain.

A silver bromide content and/or a silver iodide content necessary for exhibiting effects such as achievement of high sensitivity and realization of hard gradation, each increase with the silver-bromide-containing phase and/or the silver-iodide-containing phase being formed in more inside of the grain. This causes the silver chloride content to decrease to more than necessary, resulting in the possibility of impairing rapid processing suitability. Accordingly, for putting together these phases or functions for controlling photographic actions in the vicinity of the surface of the grain, it is preferred that the silver-bromide-containing phase and the silver-iodide-containing phase be placed adjacent to each other or coexist in the same position. From these points, it is preferred that the silver-bromide-containing phase be formed at any of the position ranging from 50% to 100% of the grain volume measured from the inside, and that the silver-iodide-containing phase be formed at any of the position ranging from 70% to 100% of the grain volume measured from the inside. Further, it is more preferred that the silver-bromide-containing phase be formed at any of the position ranging from 70% to 100% of the grain volume measured from the inside, and that the silver-iodide-containing phase be formed at any of the position ranging from 85% to 100% of the grain volume measured from the inside.

With respect to the addition of bromide ion or iodide ion, which may be conducted in order to introduce silver bromide or silver iodide in a silver halide emulsion, a bromide salt or iodide salt solution may be added singly, or the solution may be added in combination with both a silver salt solution and a chloride salt solution. In the latter case, the bromide or iodide salt solution and the chloride salt solution may be added separately, or as a mixture solution of these salts of bromide or iodide and chloride. The bromide or iodide salt is generally added in a form of a soluble salt, such as an alkali or alkali earth bromide or iodide salt. Alternatively, bromide or iodide ion may be introduced by cleaving the bromide or iodide ion from an organic molecule, as described in U.S. Pat. No. 5,389,508. As another source of bromide or iodide ion, fine silver bromide grains or fine silver iodide grains may be used.

The addition of a bromide salt or iodide salt solution may be concentrated at one time of grain formation process or may be performed over a certain period of time. For obtaining an emulsion with high sensitivity and low fog, the position of the introduction of iodide ions to a high-silver-chloride emulsion may be limited to a preferable range. The deeper in the emulsion grain iodide ions are introduced, the smaller is the increment of sensitivity. Accordingly, the addition of an iodide salt solution is preferably started at 50% or outer side of the volume of the grain, more preferably 70% or outer side, and most preferably 85% or outer side. Moreover, the addition of an iodide salt solution is preferably finished at 98% or inner side of the volume of the grain, more preferably 96% or inner side. When the addition of an iodide salt solution is finished at a little inner side of the grain surface, an emulsion having higher sensitivity and lower fog can be obtained.

On the other hand, the addition of a bromide salt solution is preferably started at 50% or outer side, more preferably 70% or outer side of the volume of the grain.

The distribution of a bromide ion concentration and iodide ion concentration in the depth direction of the grain can be measured, according to an etching/TOF-SIMS (Time of Flight—Secondary Ion Mass Spectrometry) method by means of, for example, TRIFT II Model TOF-SIMS apparatus (trade name, manufactured by Phi Evans Co.). A TOF-SIMS method is specifically described in, edited by Nippon Hyomen Kagakukai, “Hyomen Bunseki Gijutsu Sensho Niji Ion Shitsuryo Bunsekiho (Surface Analysis Technique Selection—Secondary Ion Mass Analytical Method)”, Maruzen Co., Ltd. (1999). When an emulsion grain is analyzed by the etching/TOF-SIMS method, it can be analyzed that iodide ions ooze toward the surface of the grain, even though the addition of an iodide salt solution is finished at an inner side of the grain. In the analysis with the etching/TOF-SIMS method, it is preferred that the emulsion for use in the present invention have the maximum concentration of iodide ions at the surface of the grain, that the iodide ion concentration decrease inwardly in the grain, and that the bromide ions have the maximum concentration in the inside of the grain. The local concentration of silver bromide can also be measured with X-ray diffractometry, as long as the silver bromide content is high to some extent.

The variation coefficient of intergrain silver iodide content distribution of the silver halide grains for use in the present invention is preferably 20% or less, more preferably 15% or less, and especially preferably 10% or less. When the variation coefficient of intergrain silver iodide content distribution of the silver halide grains is too large, the light-sensitive material using the same cannot attain hard gradation, and increase of fog and reduction of sensitivity induced by pressure becomes larger, which are not preferable.

The silver iodide content of individual silver halide grains can be measured by a composition analysis of the individual silver halide grains by using X-ray micro analyzer. The coefficient of variation of intergrain silver iodide content distribution is a value determined by the steps of: the silver iodide contents of at least 100, more preferably 200 or more, and especially preferably 300 or more of emulsion grains are measured, to obtain the standard deviation of the silver iodide content and the average silver iodide content; and the coefficient of variation is calculated by using the following relation:

(Standard deviation/Average silver iodide content)×100=Coefficient of variation.

The measurement of the silver iodide content of the individual grains is described, for example, in European Patent No. 147,868.

In the present invention, as silver halide emulsions, it is preferable to use emulsions having a narrow silver-bromide-content distribution among emulsion grains such that 68% or more of the total silver halide grains are grains having their silver bromide contents within ±18% of the average silver bromide content. As to the silver-bromide-content distribution, those disclosed in JP-A-2003-270749 can be referred to.

Next, the compound represented by formula (1) for use in the present invention will be explained in detail below.

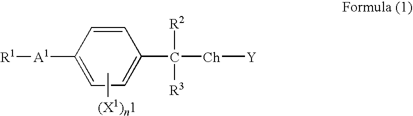

Although Ch in formula (1) represents a sulfur atom, a selenium atom, or a tellurium atom, it is preferred in the present invention that Ch represent a selenium atom or a tellurium atom, and more preferred that Ch represent a selenium atom. More specifically, it is preferable in formula (1) that Ch represent a selenium atom or a tellurium atom; A¹ represent an oxygen atom, a sulfur atom, or NR⁴; R¹ represents a hydrogen atom, an alkyl group, an alkenyl group, an alkynyl group, an aryl group, a heterocyclic group, or an acyl group; R² to R⁴ each independently represent a hydrogen atom, an alkyl group, an alkenyl group, an alkynyl group, an aryl group, or a heterocyclic group; X¹ represents a substituent; and n¹ represents an integer of 0 to 4 (when n¹ is 2 or more, X's may be the same or different); and it is more preferable that Ch represent a selenium atom; A¹ represents an oxygen atom, a sulfur atom, or NR⁴; R¹ represents a hydrogen atom, an alkyl group, an alkenyl group, an alkynyl group, an aryl group, a heterocyclic group, or an acyl group; R² to R⁴ each independently represent a hydrogen atom, an alkyl group, an alkenyl group, an alkynyl group, an aryl group, or a heterocyclic group; X¹ represents a substituent; and n¹ represents an integer of 0 to 4 (when n¹ is 2 or more, X¹s may be the same or different).

The term “alkyl group” as represented by any of R¹ to R⁴ in formula (1) means a straight-chain, branched or cyclic, substituted or unsubstituted alkyl group. Preferred examples thereof include a straight-chain or branched, substituted or unsubstituted alkyl group having 1 to 30 carbon atoms (e.g., a methyl group, an ethyl group, an isopropyl group, an n-propyl group, an n-butyl group, a t-butyl group, a 2-pentyl group, an n-hexyl group, an n-octyl group, a t-octyl group, a 2-ethylhexyl group, a 1,5-dimethylhexyl group, an n-decyl group, an n-dodecyl group, an n-tetradecyl group, an n-hexadecyl group, a hydroxyethyl group, a hydroxypropyl group, a 2,3-dihydroxypropyl group, a carboxymethyl group, a carboxyethyl group, a sodium-sulfoethyl group, a diethylaminoethyl group, a diethylaminopropyl group, a butoxypropyl group, an ethoxyethoxyethyl group, and an n-hexyloxypropyl group); a substituted or unsubstituted cycloalkyl group having 3 to 18 carbon atoms (e.g., a cyclopropyl group, a cyclopentyl group, a cyclohexyl group, a cyclooctyl group, an adamanthyl group, and a cyclododecyl group); a substituted or unsubstituted bicycloalkyl group having 5 to 30 carbon atoms (that is, a monovalent group formed by removing one hydrogen atom from a bicycloalkane having 5 to 30 carbon atoms, e.g. a bicyclo[1,2,2]heptane-2-yl group, a bicyclo[2,2,2]octane-3-yl group); and a cycloalkyl group having more ring structures, such as a tricycloalkyl group. Examples of the alkenyl group represented by any of R¹ to R⁴ include an alkenyl group having 2 to 16 carbon atoms (e.g., an allyl group, a 2-butenyl group, and a 3-pentenyl group). Examples of the alkynyl group represented by any of R¹ to R⁴ include an alkynyl group having 2 to 10 carbon atoms (e.g., a propargyl group, and a 3-pentynyl group).

Preferred examples of the aryl group represented by any of R¹ to R⁴ include a substituted or unsubstituted aryl group having 6 to 30 carbon atoms; e.g., phenyl, p-tolyl, naphthyl, m-chlorophenyl, o-hexadecanoylaminophenyl. The heterocyclic group represented by any of R¹ to R⁴ means a 5- to 7-membered, substituted or unsubstituted, and saturated or unsaturated heterocyclic group containing at least one nitrogen, oxygen, or sulfur atom. These may be monocyclic, or further form a condensed ring together with other aryl or heterocyclic ring. Preferable examples of the heterocyclic group include a 5- to 6-membered heterocyclic group, e.g. a pyrrolyl group, a pyrrolidinyl group, a pyridyl group, a piperidyl group, a piperazinyl group, an imidazolyl group, a pyrazolyl group, a pyrazinyl group, a pyrimidinyl group, a triazinyl group, a triazolyl group, a tetrazolyl group, a quinolyl group, an isoquinolyl group, an indolyl group, an indazolyl group, a benzoimidazolyl group, a furyl group, a pyranyl group, a chromenyl group, a thienyl, an oxazolyl group, an oxadiazolyl group, a thiazolyl group, a thiadiazolyl group, a benzoxazolyl group, a benzothiazolyl group, a morpholino group, and a morpholinyl group.

The acyl group represented by R¹ is preferably a substituted or unsubstituted acyl group having 2 to 30 carbon atoms, and examples of the acyl group represented by R¹ include an acetyl group, a pivaloyl group, a 2-chloroacetyl group, a stearoyl group, a benzoyl group, and a p-n-octyloxyphenylcarbonyl group.

In the present invention, R¹ is preferably a hydrogen atom, an alkyl group, an aryl group, or an acyl group; more preferably a hydrogen atom, an alkyl group, or an acyl group; and further preferably an alkyl group. R² and R³ each are preferably a hydrogen atom, an alkyl group, or an aryl group; more preferably a hydrogen atom or an alkyl group, and still more preferably the case where one of R² and R³ is a hydrogen atom and the other is a hydrogen atom or an alkyl group. R⁴ is preferably a hydrogen atom, an alkyl group, or an aryl group; more preferably a hydrogen atom or an alkyl group; and further preferably an alkyl group.

In formula (1), A¹ represents an oxygen atom, a sulfur atom, or NR⁴. Among these, in the present invention, A¹ is preferably an oxygen atom or a sulfur atom, and more preferably an oxygen atom.

In formula (1), X¹ represents a substituent. Examples of the substituent include a halogen atom (e.g. fluorine atom, chlorine atom, bromine atom, and iodine atom), an alkyl group, an alkenyl group, an alkynyl group, an aryl group, a heterocyclic group, an acyl group, an alkoxycarbonyl group, an aryloxycarbonyl group, a heterocyclicoxycarbonyl group, a carbamoyl group, an N-hydroxycarbamoyl group, an N-acylcarbamoyl group, an N-sulfonylcarbamoyl group, an N-carbamoylcarbamoyl group, a thiocarbamoyl group, an N-sulfamoylcarbamoyl group, a carbazoyl group, a carboxy group (including its salt), an oxalyl group, an oxamoyl group, a cyano group, a formyl group, a hydroxy group, an alkoxy group (including a group containing an ethyleneoxy group or propyleneoxy group unit repeatedly), an aryloxy group, a heterocyclic oxy group, an acyloxy group, an alkoxycarbonyloxy group, an aryloxycarbonyloxy group, a carbamoyloxy group, a sulfonyloxy group, a silyloxy group, a nitro group, an amino group, an alkyl-, aryl- or heterocyclic-amino group, an acylamino group, a sulfonamido group, a ureido group, a thioureido group, an N-hydroxyureido group, an imido group, an alkoxycarbonylamino group, an aryloxycarbonylamino group, a sulfamoylamino group, a semicarbazide group, a thiosemicarbazide group, a hydrazino group, an ammonio group, an oxamoylamino group, an N-(alkyl or aryl)-sulfonylureido group, an N-acylureido group, an N-acylsulfamoylamino group, a hydroxyamino group, a heterocyclic group containing a quaternary nitrogen atom (e.g., a pyridinio group, an imidazolio group, a quinolinio group and an isoquinolinio group), an isocyano group, an imino group, an alkylthio group, an arylthio group, a heterocyclic thio group, an alkyl-, aryl- or heterocyclic-dithio group, an alkyl- or aryl-sulfonyl group, an alkyl- or aryl-sulfinyl group, a sulfo group (including its salt), a sulfamoyl group, an N-acylsulfamoyl group, an N-sulfonylsulfamoyl group (including its salt), and a silyl group. Herein, the term “salt” means salts of a cation, such as an alkali metal, alkali earth metal, and heavy metal, or of an organic cation, such as an ammonium ion and phosphonium ion.

In the present invention, preferable examples of X¹ include a halogen atom, an alkyl group, an aryl group, a heterocyclic group, an acyl group, an alkoxycarbonyl group, an aryloxycarbonyl group, a carbamoyl group, an N-acylcarbamoyl group, an N-sulfonylcarbamoyl group, an N-carbamoylcarbamoyl group, a thiocarbamoyl group, N-sulfamoylcarbamoyl group, a carbazoyl group, a carboxy group including a salt thereof, a cyano group, a formyl group, a hydroxy group, an alkoxy group, an aryloxy group, a heterocyclic oxy group, an acyloxy group, a nitro group, an amino group, an alkyl-, aryl-, or heterocyclic-amino group, an acylamino group, a sulfonamido group, a ureido group, a thioureido group, an alkylthio group, an arylthio group, a heterocyclic thio group, an alkyl- or aryl-sulfonyl group, an alkyl- or aryl-sulfinyl group, a sulfo group including a salt thereof, and a sulfamoyl group. More preferable examples thereof include a halogen atom, an alkyl group, an aryl group, a heterocyclic group, a carboxy group including a salt thereof, a hydroxy group, an alkoxy group, an aryloxy group, a heterocyclic oxy group, an acyloxy group, an amino group, an alkyl-, aryl-, or heterocyclic-amino group, an acylamino group, a ureido group, a thioureido group, an alkylthio group, an arylthio group, a heterocyclic thio group, and a sulfo group including a salt thereof. Further more preferred examples thereof include an alkyl group, an aryl group, a carboxy group including a salt thereof, a hydroxy group, an alkoxy group, an aryloxy group, an alkyl-, aryl-, or heterocyclic-amino group, a ureido group, an alkylthio group, an arylthio group, and a sulfo group including a salt thereof.

In formula (1), n¹ represents an integer of from 0 to 4. In the present invention, n¹ is preferably an integer of from 0 to 2, and more preferably an integer of 0 or 1.

In formula (1), Y is a group selected from groups represented by formula (2), (3), (4), or (5).

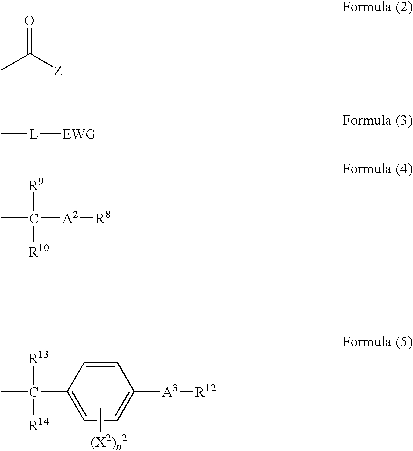

In formula (2), Z represents an alkyl group, an alkenyl group, an alkynyl group, an aryl group, a heterocyclic group, —OR⁵, or —NR⁶R⁷. R⁵, R⁶, and R⁷ each independently represent an alkyl group, an alkenyl group, an alkynyl group, an aryl group, or a heterocyclic group. The alkyl group so-called herein has the same meaning as the aforementioned alkyl group represented by any of R¹ to R⁴ in formula (1), and the preferable range is also the same. Likewise, the alkenyl group, alkynyl group, aryl group, and heterocyclic group have the same meanings as the aforementioned alkenyl group, alkynyl group, aryl group, and heterocyclic group, represented by any of R¹ to R⁴, and the preferable ranges are also the same.

When Y in formula (1) is represented by formula (2), preferred in the invention is a case where Ch represents a selenium atom, A¹ represents an oxygen atom or a sulfur atom, R¹ represents a hydrogen atom, an alkyl group, an aryl group, or an acyl group, R² and R³ each represent a hydrogen atom, an alkyl group, or an aryl group, n¹ represents an integer of 0 to 2, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), and Z is an alkyl group, an aryl group, or a heterocyclic group; more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents an integer of 0 or 1, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), and Z is an alkyl group, an aryl group, or a heterocyclic group; and further more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents 0, and Z is an alkyl group or an aryl group.

Next, formula (3) will be explained.

In formula (3), the divalent linking group represented by L preferably represents an aliphatic group having 2 to 20 carbon atoms; more preferably represents a straight-chain, branched or cyclic alkylene group having 2 to 10 carbon atoms (e.g., ethylene, propylene, cyclopentylene, and cyclohexylene), an alkenylene group (e.g., vinylene), or an alkynylene group (e.g., propynylene); and L further preferably represents a group represented by formula (L1) or (L2).

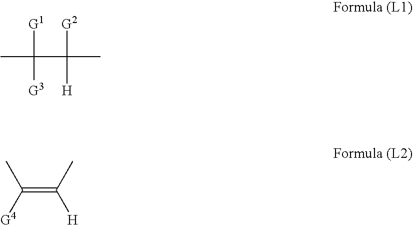

In formulae (L1) and (L2), G¹, G², G³, and G⁴ each independently represent a hydrogen atom, an alkyl group having 1 to 10 carbon atoms, an aryl group having 6 to 20 carbon atoms, or a heterocyclic group having 1 to 10 carbon atoms. Any two of G¹, G², and G³ may bond together, to form a ring. G, G², G³, and G⁴ each are preferably a hydrogen atom, an alkyl group, or an aryl group, and more preferably a hydrogen atom or an alkyl group.

In formula (3), EWG represents an electron-withdrawing group. The term “electron-withdrawing group” so-called herein means a group having a positive value of Hammett's substituent constant σₚ value, and preferably a σₚ value of 0.2 or more, with its upper limit being 1.0 or less. Specific examples of the electron-withdrawing group having a σₚ value of 0.2 or more, include an acyl group, a formyl group, an acyloxy group, an acylthio group, a carbamoyl group, an alkoxycarbonyl group, an aryloxycarbonyl group, a cyano group, a nitro group, a dialkylphosphono group, a diarylphosphono group, a dialkylphosphinyl group, a diarylphosphinyl group, a phosphoryl group, an alkylsulfinyl group, an arylsulfinyl group, an alkylsulfonyl group, an arylsulfonyl group, a sulfonyloxy group, an acylthio group, a sulfamoyl group, a thiocyanato group, a thiocarbonyl group, an imino group, an imino group substituted with an N atom, a carboxy group (or its salt), an alkyl group substituted with at least two or more halogen atoms; an alkoxy group having at least two or more halogen atoms; an aryloxy group having at least two or more halogen atoms; an acylamino group, an alkylamino group having at least two or more halogen atoms; an alkylthio group having at least two or more halogen atoms; an aryl group substituted with other electron-withdrawing group having a σₚ value of 0.2 or more; a heterocyclic group; a halogen atom, an azo group, and a selenocyanate group.

In the present invention, EWG is preferably an acyl group, a formyl group, a carbamoyl group, an alkoxycarbonyl group, an aryloxycarbonyl group, a cyano group, a nitro group, a dialkylphosphono group, a diarylphosphono group, a dialkylphosphinyl group, a diarylphosphinyl group, an alkylsulfinyl group, an arylsulfinyl group, an alkylsulfonyl group, an arylsulfonyl group, a sulfamoyl group, a thiocarbonyl group, an imino group, an imino group substituted with an N atom; a phosphoryl group, a carboxy group (or its salt), an alkyl group substituted with at least two or more halogen atoms; an aryl group substituted with other electron-withdrawing group having a σₚ value of 0.2 or more; a heterocyclic group, or a halogen atom; more preferably an acyl group, a formyl group, a carbamoyl group, an alkoxycarbonyl group, an aryloxycarbonyl group, a cyano group, a nitro group, an alkylsulfonyl group, an arylsulfonyl group, a carboxy group, or an alkyl group substituted with at least two or more halogen atoms; and further preferably an acyl group, a formyl group, a cyano group, a nitro group, an alkylsulfonyl group, an arylsulfonyl group, or an alkyl group substituted with at least two or more halogen atoms.

When Y in formula (1) is represented by formula (3), preferred is a case where Ch represents a selenium atom, A¹ represents an oxygen atom or a sulfur atom, R¹ represents a hydrogen atom, an alkyl group, an aryl group, or an acyl group, R² and R³ each represent a hydrogen atom, an alkyl group, or an aryl group, n¹ represents an integer of 0 to 2, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), L represents a group represented by formula (L1) or formula (L2), and EWG represents an acyl group, a formyl group, a carbamoyl group, an alkoxycarbonyl group, an aryloxycarbonyl group, a cyano group, a nitro group, an alkylsulfonyl group, an arylsulfonyl group, a carboxyl group, or an alkyl group substituted by at least two halogen atoms; more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents an integer of 0 or 1, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), L represents a group represented by formula (L1) or formula (L2), and EWG represents an acyl group, a formyl group, a cyano group, a nitro group, an alkylsulfonyl group, an arylsulfonyl group, or an alkyl group substituted by at least two halogen atoms; and further more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents 0, L is a group represented by formula (L1), and EWG represents an acyl group, a formyl group, a cyano group, a nitro group, an alkylsulfonyl group, an arylsulfonyl group, or an alkyl group substituted by at least two halogen atoms.

Next, formula (4) will be explained.

In formula (4), R⁸ to R¹¹ each independently represent a hydrogen atom, an alkyl group, an alkenyl group, an alkynyl group, an aryl group, or a heterocyclic group. The alkyl group so-called herein has the same meaning as the aforementioned alkyl group represented by any of R¹ to R⁴ in formula (1), and the preferable range is also the same. Likewise, the alkenyl group, alkynyl group, aryl group, and heterocyclic group have the same meanings as the aforementioned alkenyl group, alkynyl group, aryl group, and heterocyclic group, represented by any of R¹ to R⁴, and the preferable ranges are also the same.

In the present invention, R¹ is preferably an alkyl group; R⁹ and R¹⁰ each are preferably a hydrogen atom, an alkyl group, or an aryl group, more preferably a hydrogen atom or an alkyl group, and most preferably one of R⁹ and R¹⁰ is a hydrogen atom and the other is a hydrogen atom or an alkyl group. R¹¹ is preferably a hydrogen atom, an alkyl group, or an aryl group, more preferably a hydrogen atom or an alkyl group, and most preferably an alkyl group.

In formula (4), A² represents an oxygen atom, a sulfur atom, or —NR¹¹. In the present invention, A² is preferably an oxygen atom or a sulfur atom, and more preferably an oxygen atom.

When Y in formula (1) is represented by formula (4), preferred is a case where Ch represents a selenium atom, A¹ represents an oxygen atom or a sulfur atom, R¹ represents a hydrogen atom, an alkyl group, an aryl group, or an acyl group, R² and R³ each represent a hydrogen atom, an alkyl group, or an aryl group, n¹ represents an integer of 0 to 2, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), A² represents an oxygen atom or a sulfur atom, R³ represents an alkyl group or an aryl group, and R⁹ and R¹⁰ each represents a hydrogen atom, an alkyl group, an aryl group, or a heterocyclic group; more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents an integer of 0 or 1, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), A² represents an oxygen atom or a sulfur atom, R³ represents an alkyl group or an aryl group, and R⁹ and R¹⁰ each represent a hydrogen atom, an alkyl group, an aryl group, or a heterocyclic group; and further more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents 0, A² represents an oxygen atom, R⁸ represents an alkyl group or an aryl group, and R⁹ and R¹⁰ each represent a hydrogen atom, an alkyl group, or an aryl group.

Next, formula (5) will be explained.

In formula (5), A³ represents an oxygen atom, a sulfur atom, or —NR¹⁵; R¹² represents a hydrogen atom, an alkyl group, an alkenyl group, an alkynyl group, an aryl group, a heterocyclic group, or an acyl group; R¹³, R¹⁴, and R¹⁵ each independently represent a hydrogen atom, an alkyl group, an alkenyl group, an alkynyl group, an aryl group, or a heterocyclic group. The alkyl group represented by R¹² to R¹⁵ has the same meaning as the aforementioned alkyl group represented by any of R¹ to R⁴ in formula (1), and the preferable range is also the same. Likewise, the alkenyl group, alkynyl group, aryl group, and heterocyclic group have the same meanings as the aforementioned alkenyl group, alkynyl group, aryl group, and heterocyclic group, represented by any of R¹ to R⁴, and the preferable ranges are also the same. The acyl group represented by R¹² has the same meaning as the aforementioned acyl group in formula (1), and the preferable range is also the same.

n² and X² in formula (5) have the same meanings as the above n¹ and X¹ in formula (1) respectively, and each preferable range is also the same.

In formula (5), A³ represents an oxygen atom, a sulfur atom, or NR¹⁵. In the present invention, A³ is preferably an oxygen atom or a sulfur atom.

When Y in formula (1) is represented by formula (5), preferred is a case where Ch represents a selenium atom, A¹ represents an oxygen atom or a sulfur atom, R¹ represents a hydrogen atom, an alkyl group, an aryl group, or an acyl group, R² and R³ each represent a hydrogen atom, an alkyl group, or an aryl group, n¹ represents an integer of 0 to 2, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), A³ represents an oxygen atom or a sulfur atom, R¹² represents a hydrogen atom, an alkyl group, an aryl group, or an acyl group, R¹³ and R¹⁴ each represent a hydrogen atom, an alkyl group, or an aryl group, n² represents an integer of 0 to 2, X² represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof); more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents an integer of 0 or 1, X¹ represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof), A³ represents an oxygen atom, R¹² represents an alkyl group, an aryl group, or an acyl group, R¹³ and R¹⁴ each represent a hydrogen atom, an alkyl group, or an aryl group, n² represents an integer of 0 or 1, X² represents an alkyl group, an aryl group, a carboxyl group (including a salt thereof), a hydroxyl group, an alkoxy group, an aryloxy group, an alkyl-, aryl-, or heterocyclic-amino group, an ureido group, an alkylthio group, an arylthio group, or a sulfo group (including a salt thereof); and further more preferred is a case where Ch represents a selenium atom, A¹ represents an oxygen atom, R¹ represents an alkyl group, an aryl group, or an acyl group, R² and R³ each represent a hydrogen atom, an alkyl group, or an aryl group, n¹ represents 0, A³ represents an oxygen atom, R¹² represents an alkyl group, an aryl group, or an acyl group, R¹³ and R¹⁴ each represent a hydrogen atom, an alkyl group or an aryl group, and n² represents 0.

Of the compounds represented by formula (1), cases where Y is chosen from the groups represented by formula (2), formula (3), or formula (4) are preferred in the present invention, cases where Y is chosen from the groups represented by formula (2) or formula (3) are more preferred, and cases where Y is chosen from the groups represented by formula (3) are especially preferred.

Next, specific examples of the compounds represented by formula (1) are shown below, but the present invention is not limited to those.

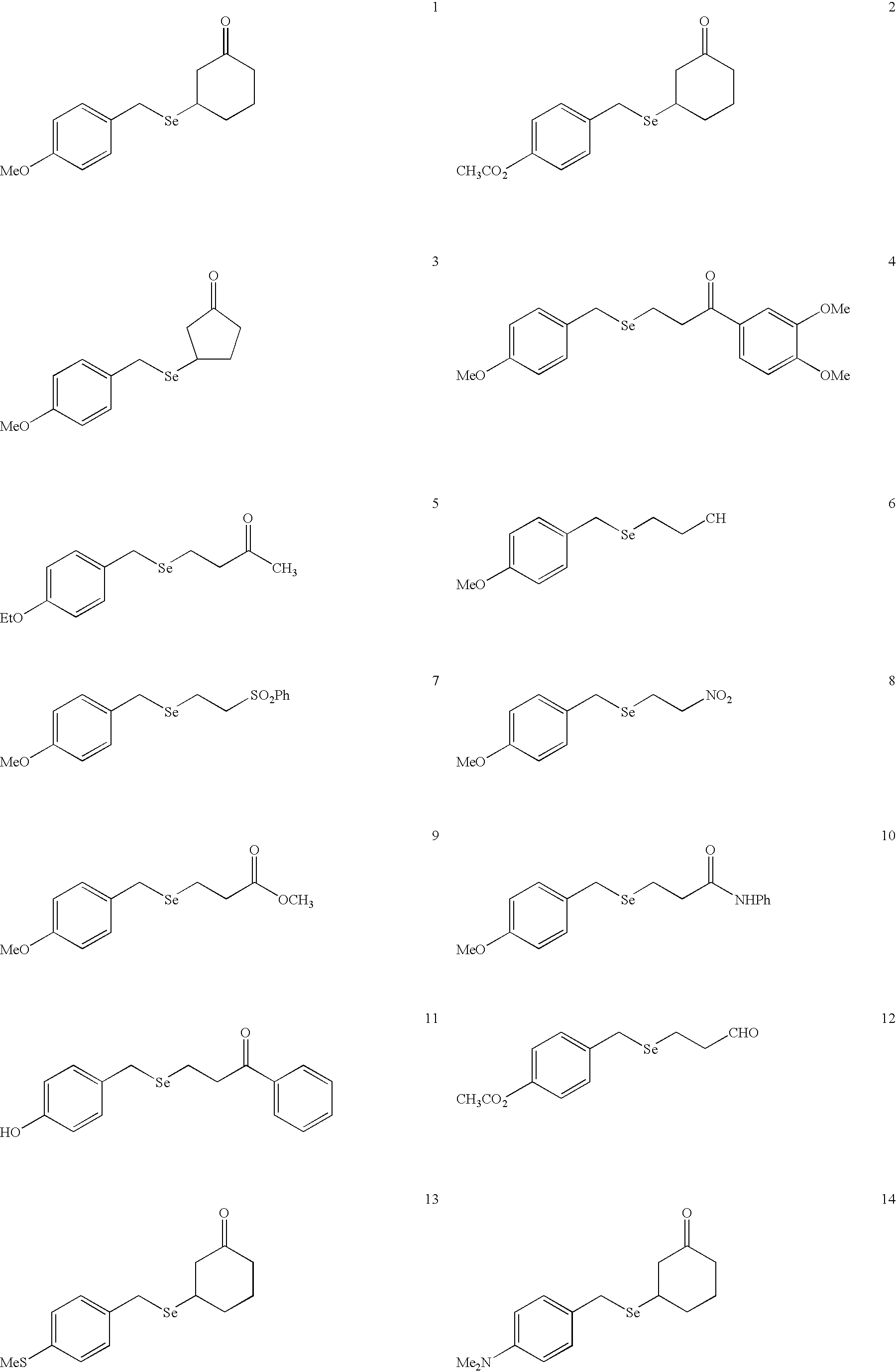

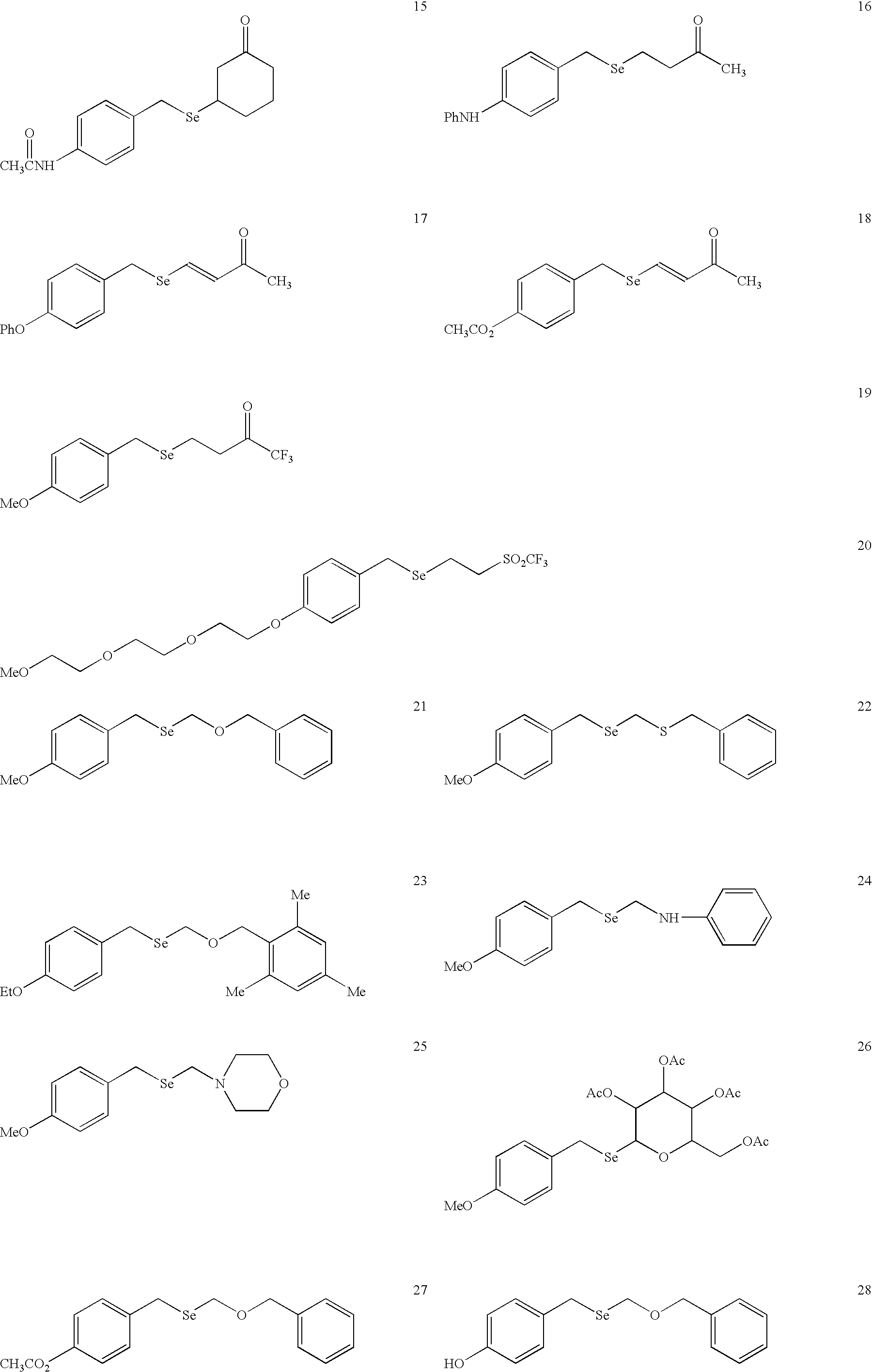

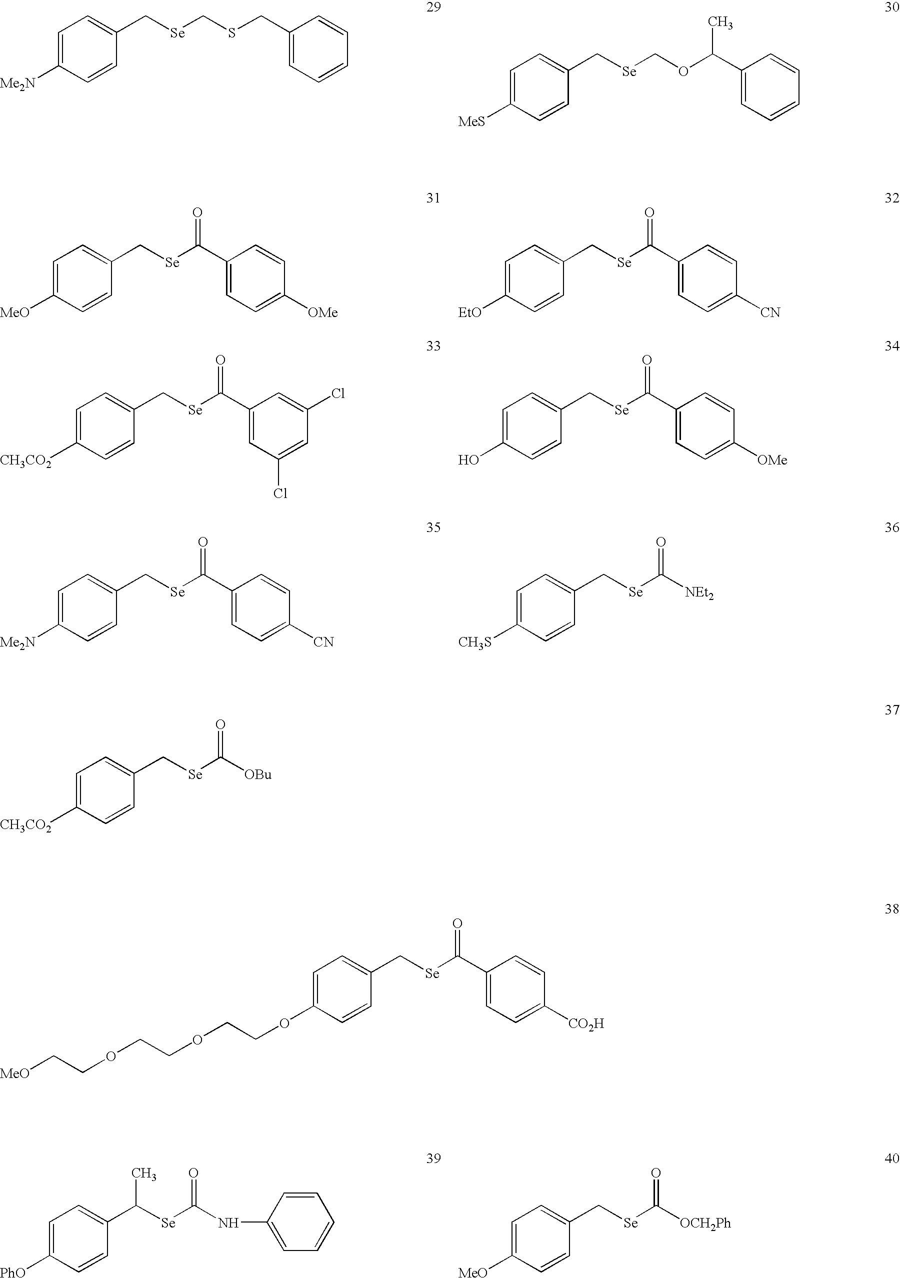

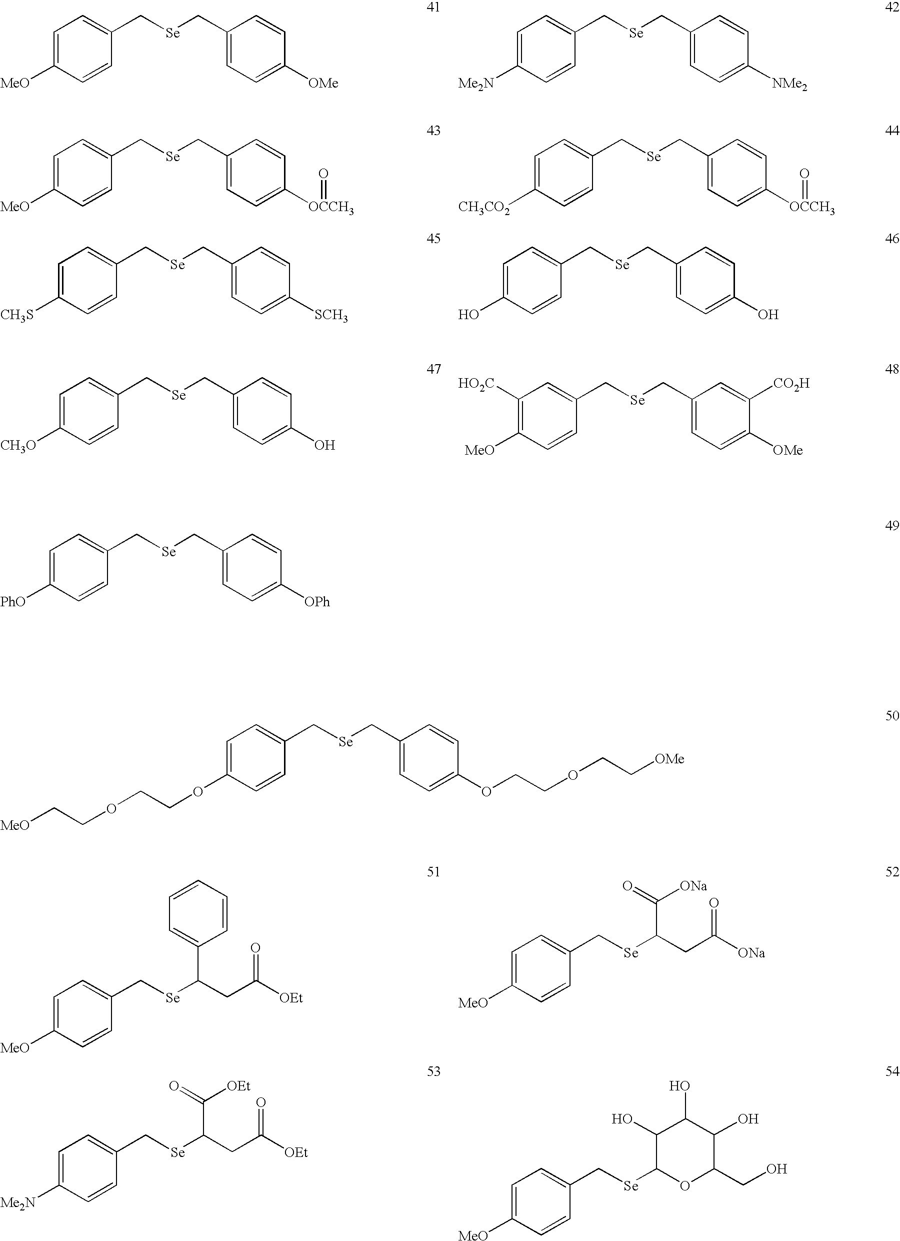

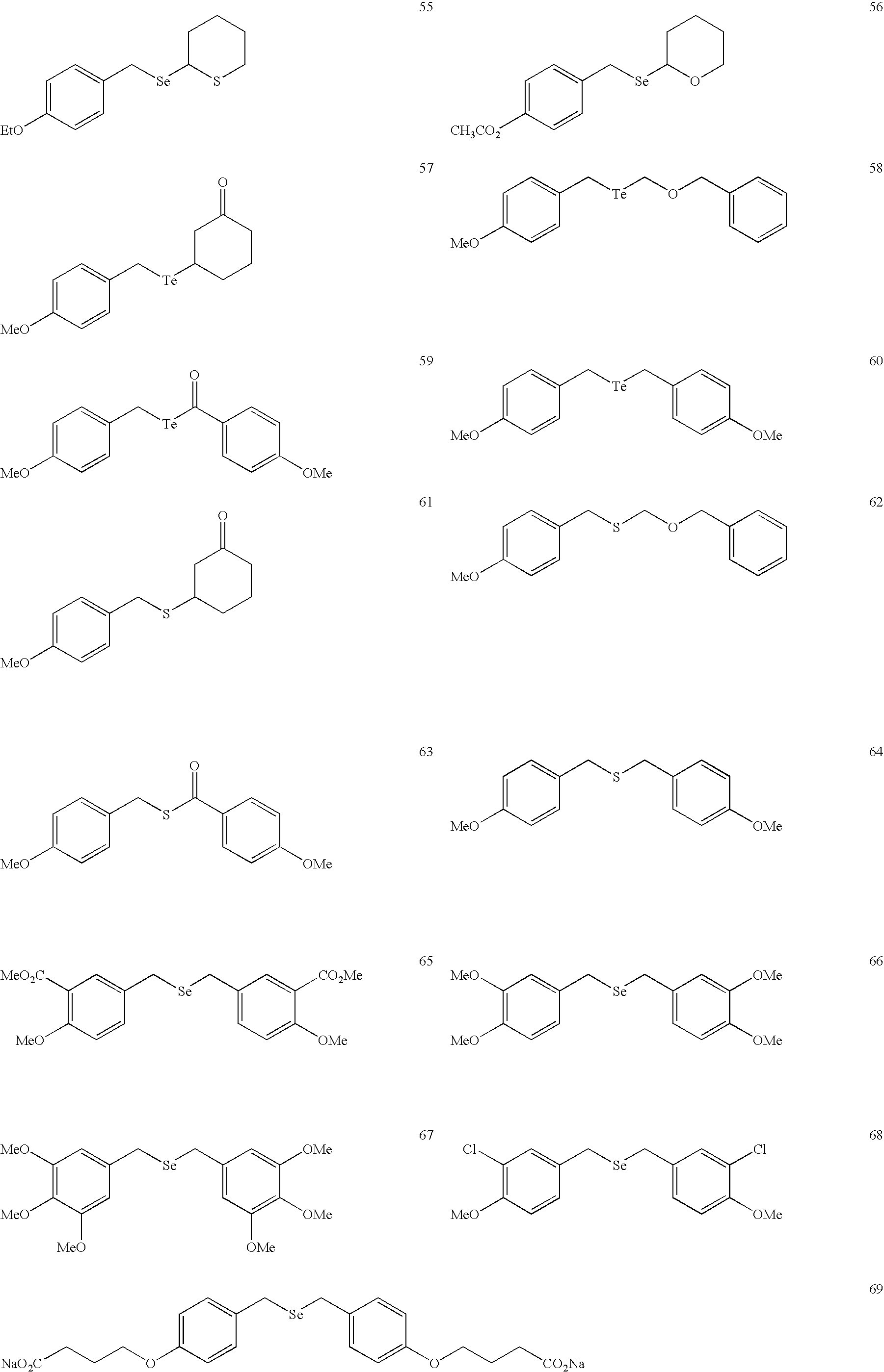

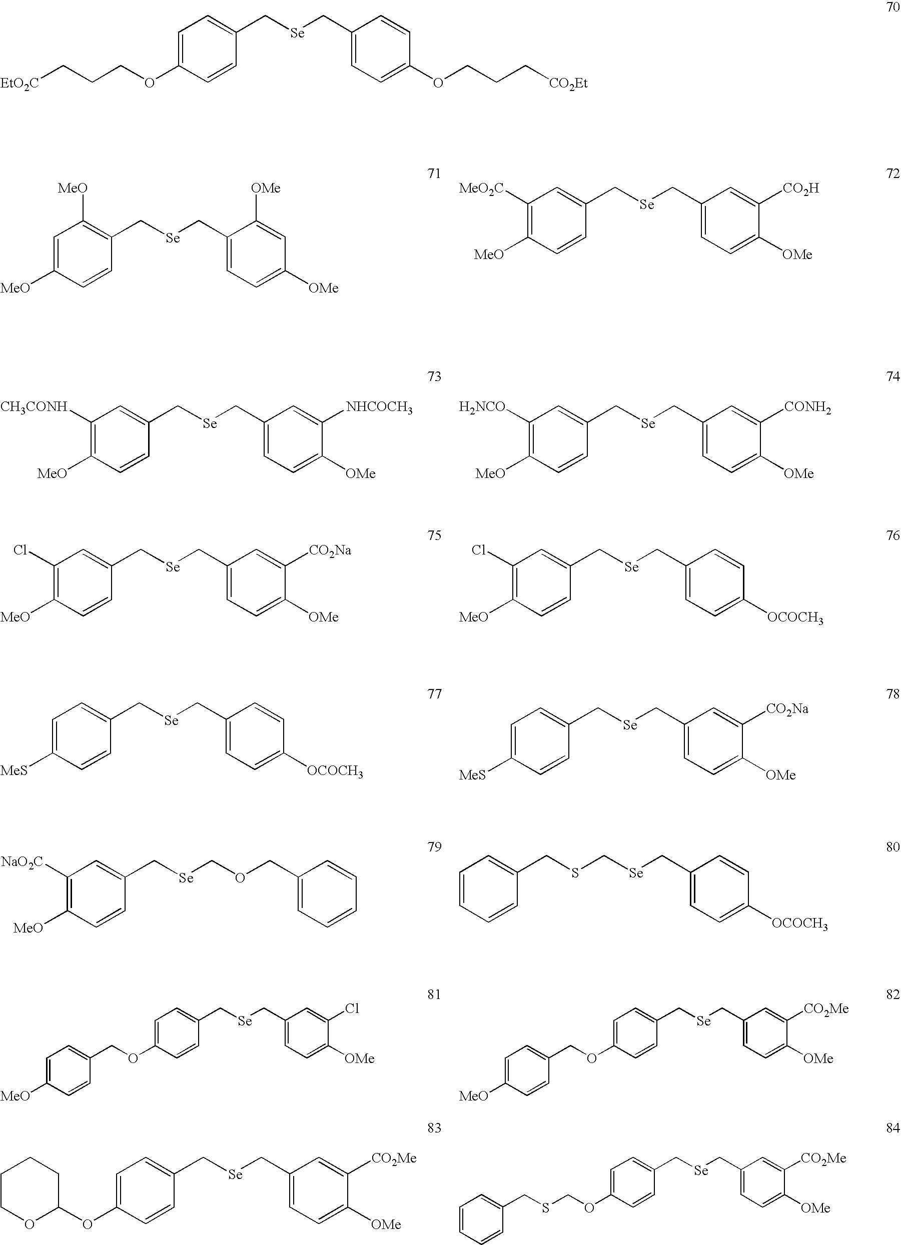

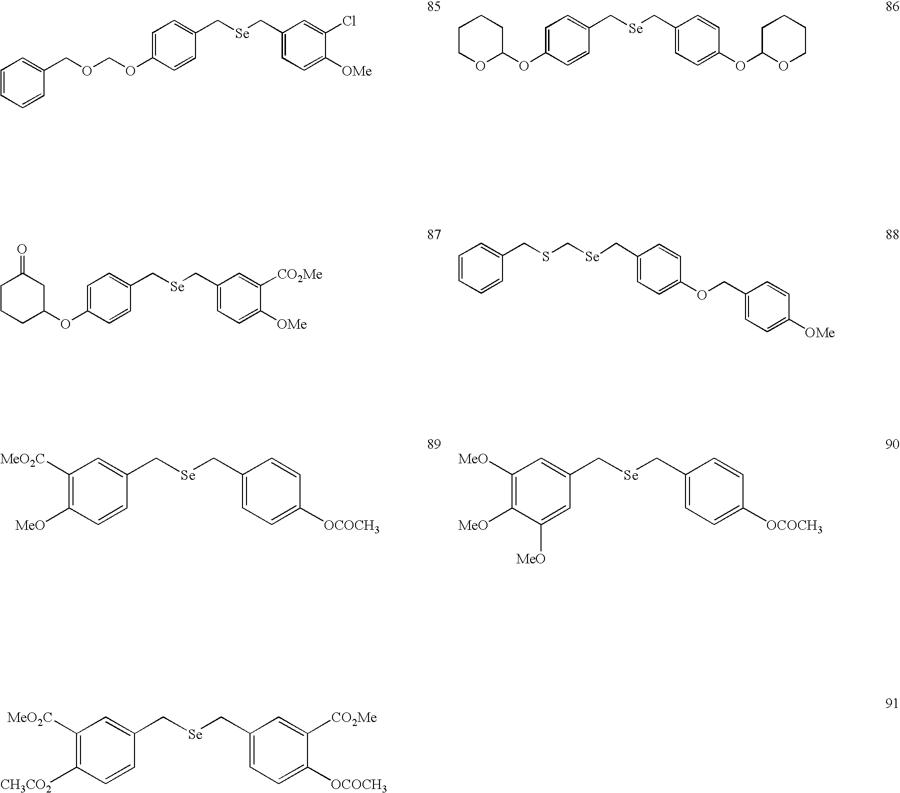

In the above specific examples, Me means a methyl group, Et means an ethyl group, and Ph means a phenyl group.

The compound represented by formula (1) according to the present invention can be synthesized by various known methods. Although no example of a synthetic method to be generalized can be given, because an optimum synthetic method is to be selected according to individual compound, useful synthesis routes among these methods will be explained.

### (Synthesis of Exemplified Compound 1)

To 2 g of p-methoxybenzyl chloride and 1.4 g of selenourea, was added 60 mL of acetone, and the resulting mixture was refluxed under heating for one hour, under a nitrogen atmosphere. The reaction solution was cooled, and the precipitated crystals were collected by filtration. 40 mL of methanol was added to 1.9 g of the resulting crystals, which were then cooled with ice. To these crystals were added 2.8 mL of a sodium methoxide methanol solution, 0.63 mL of trifluoroacetic acid, and then 0.65 g of cyclohexenone. The mixture was stirred at room temperature for 30 minutes. 100 mL of ethyl acetate and 100 mL of dilute hydrochloric acid were added to the mixture. The organic layer was separated and dried over magnesium sulfate, followed by concentrating under reduced pressure. The residue was purified by silica gel column chromatography, to give 1.2 g of Exemplified compound 1.

¹H NMR (CDCl₃) δ: 1.6-1.9 (m, 2H), 2.0-2.2 (m, 2H), 2.3-2.5 (m, 3H), 2.75 (m, 1H), 3.11 (m, 1H), 3.79 (s, 3H), 3.81 (s, 2H), 6.81 (d, 2H), 7.22 (d, 2H)

### (Synthesis of Exemplified Compound 65)

To 54.6 g of 5-formylsalicylic acid, was added 500 mL of methanol, and then 36 mL of thionyl chloride was slowly added dropwise to the mixture. After the mixture was refluxed under heating for 5 hours, the solvents were distilled off. 600 mL of ethyl acetate and an aqueous sodium chloride solution were added to the mixture, to extract the organic phase, which was then dried over sodium sulfate, followed by distilling off the solvents, to give 58.7 g of methyl 5-formylsalicylate. 500 mL of acetone was added to this methyl ester, and then 67.6 g of potassium carbonate and 30 mL of methyl iodide were added to the mixture, which was then refluxed under heating for 6 hours. The precipitated salt was separated by filtration, and then the solvents were distilled off. Then, 200 mL of chloroform and 100 mL of an aqueous 5% potassium carbonate solution were added to the salt, to extract the organic phase, which was then dried over sodium sulfate, and then the solvents were distilled off. 100 mL of ethanol was added to the residue, and the precipitated crystals were collected by filtration, to give 14.5 g of methyl 5-formyl-2-methoxybenzoate. To the methyl 5-formyl-2-methoxybenzoate, was added 80 mL of methanol, and then gradually added 2.8 g of sodium borohydride under cooling with ice. The mixture was stirred at room temperature for 4 hours, and then the solvent was distilled off. Ethyl acetate and dilute hydrochloric acid were added to the residue, to extract the organic phase, which was then washed with an aqueous sodium chloride solution. Then, sodium sulfate was added, to dry the organic phase. The solvents were distilled off, to give 12.8 g of methyl 5-hydroxymethyl-2-methoxybenzoate. A solution prepared by dissolving 1.8 g of thionyl chloride and 1.8 g of 1,2,3-benzotriazole in 10 mL of methylene chloride was added to a solution prepared by adding 10 mL of methylene chloride to 2 g of methyl 5-hydroxymethyl-2-methoxybenzoate. The precipitated depositions were separated by filtration, and then an aqueous sodium chloride solution was added thereto, to wash the organic phase, which was then dried by adding sodium sulfate, followed by distillation of solvents, to give 2 g of methyl 5-chloromethyl-2-methoxybenzoate. To the resulting product, were added 20 mL of acetone and 920 mg of selenourea. The mixture was refluxed under heating for one hour and then cooled with ice. The precipitated crystals were collected by filtration. To 3.8 g of the resulting crystals were added 2.42 g of methyl 5-chloromethyl-2-methoxybenzoate and 100 mL of acetone. Then, a solution prepared by dissolving 1.27 g of potassium hydroxide in 10 mL of water was added dropwise to the mixture, which was then stirred at room temperature for 0.5 hours, followed by distilling the solvents off. Ethyl acetate and an aqueous sodium chloride solution were added thereto, to extract the organic phase, which was then dried over magnesium sulfate, followed by distilling the solvents off. The residue was purified by silica gel column chromatography, to give 3.7 g of Exemplified compound 65.

¹H NMR (CDCl₃) δ: 3.67 (s, 4H), 3.89 (s, 6H), 3.90 (s, 6H), 6.90 (d, 2H), 7.38 (d, 2H), 7.69 (s, 2H)

### (Synthesis of Exemplified Compound 48)

To 0.7 g of Exemplified compound 65 was added 5 mL of methanol, thereto was then added dropwise a solution prepared by dissolving 0.26 g of sodium hydroxide in 4 mL of water. The mixture was stirred at 70° C. for one hour. Then, dilute hydrochloric acid was added thereto, to precipitate crystals. The crystals were collected by filtration, to give 0.26 g of Exemplified compound 48.

¹H NMR (D₂O) δ: 3.84 (s, 6H), 3.859 (s, 4H), 7.01 (d, 2H), 7.22 (d, 2H), 7.30 (s, 2H)

### (Synthesis of Exemplified Compound 72)

To 0.8 g of Exemplified compound 65, was added 20 mL of methanol, then was added thereto, dropwise, 0.4 mL of an aqueous 5M sodium hydroxide solution, and the resulting mixture was stirred at 70° C. for one hour. After distilling the solvents off, ethyl acetate and dilute hydrochloric acid were added to the mixture, to extract the organic phase, and then was added thereto magnesium sulfate, to dry the organic phase. After distilling the solvents off, the residue was purified by silica gel column chromatography, to give 0.11 g of Exemplified compound 72.

¹H NMR (CDCl₃) δ: 3.69 (s, 4H), 3.89 (s, 6H), 4.09 (s, 3H), 6.94 (d, 1H), 6.98 (d, 1H), 7.39 (d, 1H), 7.49 (s, 1H), 7.66 (s, 1H), 8.03 (s, 1H)

### (Synthesis of Exemplified Compound 67)

To 10 g of 3,4,5-trimethoxybenzyl alcohol, was added 80 mL of methylene chloride, then was added thereto, dropwise, a solution prepared by dissolving 4.8 mL of thionyl chloride and 7.8 g of 1,2,3-benzotriazole in 40 mL of methylene chloride. After the mixture was stirred at room temperature for 2.5 hours, insoluble matter was separated by filtration, followed by addition of water, and the organic phase was washed with the added water. After the organic phase was dried over magnesium sulfate, solvents were distilled off, to thereby give 3,4,5-trimethoxybenzyl chloride. 1.34 g of selenourea and 80 mL of acetone were added to 2.6 g of 3,4,5-trimethoxybenzyl chloride, the mixture was refluxed under heating for 1.5 hours, and the precipitated crystals were collected by filtration. 40 mL of methanol was added to 2.2 g of these crystals. Thereto, 2.6 mL of a 28% sodium methoxide methanol solution was added dropwise, and then 1.4 g of 3,4,5-trimethoxybenzyl chloride was added to the methanol solution. The mixture was stirred for 0.5 hours and then solvents were distilled off. Ethyl acetate and dilute hydrochloric acid were added to the residue, to extract the organic phase, and the organic phase was then dried over magnesium sulfate, followed by distilling solvents off. The crystals precipitated by adding ethanol to the residue were collected by filtration, to give 1 g of Exemplified compound 67.

¹H NMR (CDCl₃) δ: 3.70 (s, 4H), 3.86 (s, 18H), 6.50 (s, 4H)

In the present invention, the addition amount of the compound represented by formula (1) can vary in a wide range depending on the occasions, and it is generally in the range of 1×10⁻⁷ to 5×10⁻³ mol, preferably in the range of 5×10⁻⁷ to 5×10⁻⁴ mol, per mol of silver halide.

In the present invention, the compound represented by formula (1) may be added dissolved in a solvent, for example, of water, an alcohol (e.g., methanol, ethanol), a ketone (e.g., acetone), an amide (e.g., dimethylformamide), a glycol (e.g., methylpropylene glycol), or an ester (e.g., ethyl acetate).

In the present invention, the compound represented by formula (1) may be added in any stage of the production of emulsion. It is preferable to add the compound at an appropriate time after the formation of silver halide grains but before the completion of chemical sensitization step.

The silver halide emulsion for use in the present invention may contain silver halide grains chemically sensitized by a selenium sensitizer using an unstable-type (labile) selenium compound and/or a non-unstable-type (non-labile) selenium compound, as disclosed in known patent publications, besides the silver halide grains chemically sensitized by the selenium compound for use in the present invention. The silver halide emulsion of the present invention may be chemically sensitized by a combination of the selenium sensitizer for use in the present invention, and any of the above-mentioned selenium sensitizers. A selenium compound is generally utilized in such a manner that it is added to an emulsion, and the emulsion is stirred at a high temperature, preferably at a temperature of 40° C. or more, for a given time. As the labile selenium compounds, use can be made of the compounds described in JP-B-44-15748, JP-B-43-13489, JP-A-4-25832, JP-A-4-109240, and the like. The non-labile selenium sensitizer refers to a compound which causes, without use of any nucleophilic agent, silver selenide formed upon the addition of the non-labile selenium sensitizer only in an amount of 30% or less to the amount of the added non-labile selenium sensitizer. As the non-labile selenium sensitizer, there can be mentioned compounds described in, for example, JP-B-46-4553, JP-B-52-34492, and JP-B-52-34491. When the non-labile selenium sensitizer is used, it is preferred to use a nucleophilic agent in combination with the non-labile selenium sensitizer. As the nucleophilic agent, there can be mentioned compounds described in, for example, JP-A-9-15776.

The silver halide emulsion for use in the present invention may be additionally subjected to gold sensitization known in the field of arts concerned. As a gold sensitizer for the gold sensitization, the oxidation number of gold may be either +1 valence or +3 valences, and various inorganic gold compounds, gold (I) complexes having inorganic ligands, or gold (I) compounds having organic ligands may be utilized. Typical examples of the gold sensitizer include compounds such as a chloroaurate, potassium chloroaurate, auric trichloride, potassium auric thiocyanate, potassium iodoaurate, tetracyano auric acid, ammonium aurothiocyanate, pyridyl trichlorogold, gold sulfide, gold selenide; gold dithiocyanate compounds, e.g., potassium gold (I) dithiocyanate; and gold dithiosulfate compounds, e.g., trisodium gold (I) dithiosulfate. The amount of the gold sensitizer to be added varies depending on various conditions, but, as a standard, the amount thereof is generally 1×10⁻⁷ to 5×10⁻³ mol, preferably 5×10⁻⁶ to 5×10⁻⁴ mol, per mol of silver halide.

As the gold (I) compounds having organic ligands (organic compounds), use can be made of bis-gold (I) mesoionic heterocycles described in JP-A-4-267249, e.g. bis(1,4,5-trimethyl-1,2,4-triazolium-3-thiolato) aurate (I) tetrafluoroborate; organic mercapto gold (I) complexes described in JP-A-11-218870, e.g. potassium bis(1-[3-(2-sulfonatobenzamido)phenyl]-5-mercaptotetrazole potassium salt) aurate (I) pentahydrate; and gold (I) compound with a nitrogen compound anion coordinated therewith, as described in JP-A-4-268550, e.g. bis(1-methylhydantoinato) gold (I) sodium salt tetrahydrate. As these gold (I) compounds having organic ligands, use can be made of those which are synthesized in advance and isolated, as well as those which are generated by mixing an organic ligand and an Au compound (e.g., chlroauric acid or its salt), to add to an emulsion without isolating the gold(I) compound. Moreover, an organic ligand and an Au compound (e.g., chlroauric acid or its salt) may be separately added to an emulsion, to generate the gold (I) compound having the organic ligand, in the emulsion.

Also, the gold (I) thiolate compound described in U.S. Pat. No. 3,503,749, the gold compounds described in JP-A-8-69074, JP-A-8-69075 and JP-A-9-269554, and the compounds described in U.S. Pat. Nos. 5,620,841, 5,912,112, 5,620,841, 5,939,245, and 5,912,111 may be used.

The amount of the above compound to be added can be varied in a wide range depending on the occasion, and it is generally in the range of 5×10⁻⁷ mol to 5×10⁻³ mol, preferably in the range of 5×10⁻⁶ mol to 5×10⁻⁴ mol, per mol of silver halide.

Further, in the present invention, colloidal gold sulfide can also be used, for example, to subject the silver halide emulsion of the present invention to gold sensitization. A method of producing the colloidal gold sulfide is described in, for example, Research Disclosure, No. 37154; Solid State Ionics, Vol. 79, pp. 60 to 66 (1995); and Compt. Rend. Hebt. Seances Acad. Sci. Sect. B, Vol. 263, p. 1328 (1996). In the above Research Disclosure, a method is described in which a thiocyanate ion is used in the production of colloidal gold sulfide. It is, however, possible to use a thioether compound, such as methionine or thiodiethanol, instead.

Colloidal gold sulfide having various grain sizes are applicable, and it is preferable to use those having an average grain diameter of 50 nm or less, more preferably 10 nm or less, and further preferably 3 nm or less. The grain diameter can be measured from a TEM photograph. Also, the composition of the colloidal gold sulfide may be Au₂S_{1.1} or may be sulfur-excess compositions such as Au₂ S₁ to Au₂S₂ which are preferable. Au₂S_{1.1} to Au₂S_{1.8} are more preferable.

The composition of the colloidal gold sulfide can be analyzed in the following manner: for example, gold sulfide grains are taken out, to find the content of gold and the content of sulfur, by utilizing analysis methods such as ICP and iodometry, respectively. If gold ions and sulfur ions (including hydrogen sulfide and its salt) dissolved in the liquid phase exist in the gold sulfide colloid, this affects the analysis of the composition of the gold sulfide colloidal grains. Therefore, the analysis is made after the gold sulfide grains have been separated by ultrafiltration or the like. The amount of the colloidal gold sulfide to be added can be varied in a wide range depending on the occasion, and it is generally in the range of 5×10⁻⁷ mol to 5×10⁻³ mol, preferably in the range of 5×10⁻⁶ mol to 5×10⁻⁴ mol, in terms of gold atom, per mol of silver halide.

The emulsion for use in the present invention may be additionally subjected to sulfur sensitization in the chemical sensitization.

The sulfur sensitization is generally carried out by adding a sulfur sensitizer, and stirring the resulting emulsion for a certain period at a high temperature, preferably at 40° C. or higher.

In the above sulfur sensitization, known sulfur sensitizers can be used. Examples thereof include thiosulfates, allyl thiocarbamidothiourea, allyl isothiocyanate, cystine, p-toluenethiosulfonates, and rhodanine. In addition, sulfur sensitizers described, for example, in U.S. Pat. Nos. 1,574,944, 2,410,689, 2,278,947, 2,728,668, 3,501,313, and 3,656,955, German Patent No. 1,422,869, JP-B-56-24937, and JP-A-55-45016, can also be used. The amount of the sulfur sensitizer to be added is suitably an amount sufficient to effectively increase the sensitivity of the emulsion. That amount varies in a substantially wide range depending on various conditions, such as the pH, the temperature, and the size of the silver halide grains, and preferably the amount is 1×10⁻⁷ mol or more but 5×10⁻⁵ mol or less, per mol of silver halide.

Chalcogen sensitization and gold sensitization can be conducted by using the same molecule such as a molecule capable of releasing AuCh⁻, in which Au represents Au (I), and Ch represents a sulfur atom, a selenium atom, or a tellurium atom. Examples of the molecule capable of releasing AuCh⁻ include gold compounds represented by AuCh-L, in which L represents a group of atoms bonding to AuCh to form the molecule. Further, one or more ligands may coordinate to Au together with Ch-L. The gold compounds represented by AuCh-L have a tendency to form AgAuS when Ch is S, AgAuSe when Ch is Se, or AgAuTe when Ch is Te, when the gold compounds are reacted in a solvent in the presence of silver ions. Examples of these compounds include those in which L is an acyl group. In addition, gold compounds represented by formula (AuCh1), formula (AuCh2), or formula (AuCh3) are exemplified.

R₁—X-M-ChAu Formula (AuCh 1)

In formula (AuCh1), Au represents Au (I); Ch represents a sulfur atom, a selenium atom, or a tellurium atom; M represents a substituted or unsubstituted methylene group; X represents an oxygen atom, a sulfur atom, a selenium atom, or NR₂; R₁, represents a group of atoms bonding to X to form the molecule (e.g., an organic group, such as an alkyl group, an aryl group, or a heterocyclic group); R₂ represents a hydrogen atom or a substituent (e.g., an organic group, such as an alkyl group, an aryl group, or a heterocyclic group); and R₁, and M may combine together to form a ring.

Regarding the compound represented by formula (AuCh1), Ch is preferably a sulfur atom or a selenium atom; X is preferably an oxygen atom or a sulfur atom; and R₁ is preferably an alkyl group or an aryl group. Examples of more specific compounds include Au(I) salts of thiosugar (for example, gold thioglucose (such as a-gold thioglucose), gold peracetyl thioglucose, gold thiomannose, gold thiogalactose, gold thioarabinose), Au(I) salts of selenosugar (for example, gold peracetyl selenoglucose, gold peracetyl selenomannose), and Au(I) salts of tellurosugar. Herein, the terms “thiosugar,” “selenosugar”, and “tellurosugar” each mean the compound in which a hydroxy group in the anomer position of the sugar is substituted with a SH group, a SeH group, or a TeH group, respectively.

W₁W₂C═CR₃ChAu Formula (AuCh2)

In formula (AuCh2), Au represents Au(I); Ch represents a sulfur atom, a selenium atom, or a tellurium atom; R₃ and W₂ each independently represent a hydrogen atom or a substituent (e.g., a halogen atom, and an organic group such as alkyl, aryl, or heterocyclic group); W₁ represents an electron-withdrawing group having a positive value of the Hammett's substituent constant σₚ value; and R₃ and W₁, R₃ and W₂, or W₁ and W₂ may bond together to form a ring.

In the compound represented by formula (AuCh2), Ch is preferably a sulfur atom or a selenium atom; R₃ is preferably a hydrogen atom or an alkyl group; and W₁ and W₂ each are preferably an electron-withdrawing group having the Hammett's substituent constant σp value of 0.2 or more. Examples of the specific compound include (NC)₂C═CHSAu, (CH₃OCO)₂C═CHSAu, and CH₃CO(CH₃OCO)C═CHSAu.

W₃-E-ChAu Formula (AuCh3)

In formula (AuCh3), Au represents Au(I); Ch represents a sulfur atom, a selenium atom, or a tellurium atom; E represents a substituted or unsubstituted ethylene group; W₃ represents an electron-withdrawing group having a positive value of the Hammett's substituent constant σₚ value.

In the compound represented by formula (AuCh3), Ch is preferably a sulfur atom or a selenium atom; E is preferably an ethylene group having thereon an electron-withdrawing group whose Hammett's substituent constant σₚ value is a positive value; and W₃ is preferably an electron-withdrawing group having the Hammett's substituent constant σₚ value of 0.2 or more. An addition amount of these compounds can vary over a wide range according to the occasions, and the amount is generally in the range of 5×10⁻⁷ to 5×10⁻³ mol, preferably in the range of 3×10⁻⁶ to 3×10⁻⁴ mol, per mol of silver halide.

In the present invention, the above-mentioned gold sensitization may be combined with other sensitization, such as sulfur sensitization, selenium sensitization, tellurium sensitization, reduction sensitization, and noble metal sensitization using noble metals other than gold compounds. In particular, the gold sensitization is preferably combined with sulfur sensitization and/or selenium sensitization.

The chemical sensitization can be carried out in the presence of a silver halide solvent.

Examples of the silver halide solvent that can be used in the present invention include (a) organic thioethers described, for example, in U.S. Pat. Nos. 3,271,157, 3,531,289 and 3,574,628, JP-A-54-1019, and JP-A-54-158917; (b) thiourea derivatives described, for example, in JP-A-53-82408, JP-A-55-77737, and JP-A-55-2982; (c) silver halide solvents having a thiocarbonyl group between an oxygen or sulfur atom and a nitrogen atom, as described in JP-A-53-144319; (d) imidazoles described in JP-A-54-100717; (e) sulfites; and (f) thiocyanates.

Preferable silver halide solvents are thiocyanates and tetramethylthiourea. The amount of the solvent to be used varies depending on the type of the solvent, and the amount to be used is preferably 1×10⁻⁴ mol or more, but 1×10⁻² mol or less, per mol of silver halide.

The silver halide emulsion for use in the present invention may be subjected to reduction sensitization during grain formation; after grain formation, but before or in the course of chemical sensitization; or after chemical sensitization.

As the reduction sensitization, any one may be selected from the followings: a method in which a reduction sensitizing agent is added to a silver halide emulsion; a so-called silver ripening method in which a silver halide is grown or ripened in the low pAg atmosphere with pAg of 1 to 7; and a so-called high-pH ripening method in which growth or ripening is carried out in the high pH atmosphere with pH of 8 to 11. Further, two or more of those methods may be used in combination.

The above method in which a reduction-sensitizing agent is added to a silver halide emulsion is preferable from the point that the level of reduction sensitization can be delicately controlled.

Examples of known reduction-sensitizing agents include stannous salts, ascorbic acid and its derivatives, amines, polyamines, hydrazine derivatives, formamidine sulfinic acids, silane compounds, and borane compounds. The reduction-sensitizing agent for use in the present invention may be selected from these known compounds, and two or more kinds of compounds may be used in combination. Preferable reduction-sensitizing agents for use in the present invention are stannous chloride, thiourea dioxide, dimethylamine borane, and ascorbic acid and its derivatives. The addition amount of the reduction-sensitizing agent varies depending on the conditions of producing emulsions, and therefore it is necessary to determine an addition amount thereof. A proper addition amount is generally in the range of from 10⁻⁷ to 10⁻³ mol, per mol of silver halide.

A reduction sensitizer may be added in the course of the growth of silver halide grains, in the form of a solution having the reduction sensitizer dissolved in water or such an organic solvent as alcohols, glycols, ketones, esters, and amides. The reduction sensitizer may be added to a reaction vessel in advance, but preferably the reduction sensitizer is added at any proper stage during the growth of grains. Alternatively, use can be made of a method in which the reduction sensitizer is added to an aqueous solution of a water-soluble silver salt or a water-soluble alkali halide in advance, and then silver halide grains are precipitated by using these aqueous solutions. Further, a method in which a solution of the reduction sensitizer is added in parts or successively for a long period of time during the growth of silver halide grains, is also preferred.

In the present invention, preferably an oxidizing agent for silver be added, in the course of the process of the production of emulsion. The oxidizing agent for silver refers to a compound that acts on metal silver to convert it to silver ion. Particularly useful is a compound that converts quite fine silver grains, which are concomitantly produced during the formation of silver halide grains and during the chemical sensitization, to silver ions. The thus produced silver ions may form a silver salt that is hardly soluble in water, such as a silver halide, silver sulfide, and silver selenide, or they may form a silver salt that is readily soluble in water, such as silver nitrate. The oxidizing agent for silver may be inorganic or organic. Examples of inorganic oxidizing agents include ozone, hydrogen peroxide and its adducts (e.g. NaBO₂.H₂O₂.3H₂O, 2NaCO₃.3H₂O₂, Na₄P₂O₇.2H₂O₂, and 2Na₂SO₄.H₂O₂.2H₂O); oxygen acid salts, such as peroxyacid salts (e.g. K₂S₂O₈, K₂C₂O₆, and K₂P₂O₈), peroxycomplex compounds (e.g. K₂[Ti(O₂)C₂O₄].3H₂O, 4K₂SO₄.Ti(O₂)OH.SO₄.2H₂O, and Na₃[VO(O₂)(C₂H₄)₂].6H₂O), permanganates (e.g. KMnO₄), and chromates (e.g. K₂Cr₂O₇); halogen elements, such as iodine and bromine; perhalates (e.g. potassium periodate), salts of metals having higher valences (e.g. potassium hexacyanoferrate (III)); inorganic sulfur; and sulfur-releasing compounds typified by thiosulfonic acid salts and polysulfide compounds.

Examples of the organic oxidizing agents include quinones, such as p-quinone; organic peroxides, such as peracetic acid and perbenzoic acid; and compounds that can release active halogen (e.g. N-bromosuccinimido, chloramine T, and chloramine B).

Oxidizing agents suitably used in the invention include inorganic sulfur and sulfur-releasing oxidants, such as thiosulfonic acid salts and polysulfide compounds. Particularly, it is a favorable mode to add a thiosulfonic acid salt and/or a polysulfide compound during the chemical sensitization process. The addition amount of these sulfur-containing oxidizing agents is preferably from 10⁻⁷ to 10⁻⁴ mole per mole of silver halide emulsion, and it is especially favorable to use them in the range of 10⁻⁶ to 10⁻⁵ mole per mole of silver halide emulsion. These oxidizing agents can be added before and/or after the addition of chemical sensitizers including the compounds represented by formula (1) according to the present invention, known chalcogen sensitizers, and gold sensitizers, or halfway through additions of two or more of the sensitizers.

It is a preferable mode to conduct the foregoing reduction sensitization in conjunction with the use of an oxidizing agent for silver. Herein, it is possible to adopt the method of carrying out reduction sensitization after the use of the oxidizing agent, or the method of using the oxidizing agent after the reduction sensitization, or the method of performing both at the same time. These methods are applicable in both the grain formation process and the chemical sensitization process.

The silver halide emulsion according to the present invention is not particularly limited from the viewpoint of grain shape. In the present invention, use can be preferably made of a silver halide emulsion, in which the proportion of silver halide grains composed of cubic, tetradecahedral, or octahedral crystal grains, substantially having (100) planes, which grains may be rounded at the apexes thereof and may have planes of higher order, accounts for 50% or more in terms of the total projected area of all the silver halide grains. Alternatively, use can also be preferably made of a silver halide emulsion, in which the proportion of silver halide grains composed of tabular grains having an aspect ratio of 2 or more (preferably 5 to 200) and being composed of (100) or (111) planes as the main face, accounts for 50% or more in terms of the total projected area of all the silver halide grains. The term “aspect ratio” refers to the value obtained by dividing the diameter of a circle having an area equivalent to the projected area of an individual grain, by the thickness of the grain. Among these, it is preferable to use a silver halide emulsion including cubic or tetrahedral grains substantially having (100) planes, or a silver halide emulsion including tabular grains whose main faces are made up of (111) planes. It is most preferable to use a silver halide emulsion including cubic or tetrahedral grains substantially having (100) planes.

In this specification, the grain size of each individual silver halide emulsion grain is represented by a length of one side (a side length) of a cube having the same volume as the each individual grain. The sphere-equivalent diameter (the diameter of a sphere having the same volume as the each individual grain has) of 1 μm is equal to 0.806 μm in side-length terms. The circle-equivalent diameter (the diameter of a circle having the same area as the projected area of the each individual grain) of 1 μm is equal to 0.886 μm in side-length terms.

The silver halide emulsions for use in the present invention have no particular restrictions as to grain sizes, however, in point of rapid processing suitability, it is preferable that the silver halide emulsion layer containing the silver halide emulsion chemically sensitized with the compound represented by formula (1) be substantially free of large-sized grains having side lengths greater than 0.50 μm. The expression “substantially free of grains having side lengths greater than 0.50 μm” means that the proportion of silver halide grains having side lengths greater than 0.50 μm to the total silver halide grains in the layer concerned is 20% or less by number. Herein, it is more preferable that such the silver halide emulsion layer be substantially free of grains greater than 0.45 μm in side length, and it is particularly preferable that such the silver halide emulsion layer is free of grains greater than 0.40 μm in side length.

It is a preferred embodiment of the silver halide color photographic light-sensitive material of the present invention that the blue-sensitive silver halide emulsion layer be made up of silver halide emulsion layer substantially free of large-sized grains having side lengths greater than 0.50 μm.

It is a further preferred embodiment that the silver halide color photographic light-sensitive material of the present invention be made up of silver halide emulsion layers all of which are free of large-sized grains having side lengths greater than 0.50 μm.

More specifically, the lower limit of grain sizes is preferably 0.05 μm, and more preferably 0.10 μm; while the upper limit of grain sizes is preferably less than 0.50 μm, more preferably less than 0.45 μm, and further more preferably less than 0.40 μm.

Preferably, the emulsion for use in the present invention comprise grains having a monodisperse grain size distribution. The variation coefficient of grain size is preferably 20% or less, more preferably 15% or less, and still more preferably 10% or less. The variation coefficient of grain size is expressed as a percentage of the standard deviation of side length of each grain, to the average of side length. In this connection, for the purpose of obtaining broad latitude, it is preferred that the above-mentioned monodisperse emulsions be used as blended in the same layer, or coated by a multilayer coating method.

In the silver halide emulsion for use in the present invention, a metal complex may be added and incorporated during grain formation; after grain formation but before chemical sensitization; or during chemical sensitization. The metal complex may be separately added and incorporated in several times. However, 50% or more of the total metal complex incorporated in the silver halide grain is preferably located in the layer within a half in terms of silver amount, from the outermost surface of the silver halide grain. On the outer side of the above-mentioned metal complex-containing layer, a layer containing no metal complex may be provided.

In the present invention, the above-mentioned metal complexes are preferably dissolved in water or a proper solvent, and added directly to the reaction solution at the time of silver halide grain formation, or added to an aqueous halide solution, or aqueous silver salt solution or other solution, for forming silver halide grains, and incorporated into silver halide grains by conducting grain formation using such solution. Furthermore, it is also preferable to employ a method, in which a metal complex is incorporated into silver halide grains, by adding and dissolving silver halide fine grains which are doped with metal complex in advance, and depositing them on another silver halide grains.

The hydrogen ion concentration in a reaction solution to which a metal complex is added, is preferably 1 or more, but 10 or less; more preferably 2 or more, but 7 or less, in terms of pH.

The metal complex that can be preferably used in the present invention, is represented by formula (I) or formula (II):

[IrX^{I}ₙL^{I}₍₆₋ₙ₎]^{m} Formula (I)

In formula (1), X^{I} represents a halogen ion or a pseudohalogen ion other than a cyanate ion; L^{I} represents a ligand different from X^{I}; n is 3, 4, or 5; and m is 4−, 3−, 2−, 1−, 0, or 1+. Herein, three to five of X^{I}s may be the same or different from each other. When plural L^{I}s are present, these plural L^{I}s may be the same or different from each other.

In the above, the pseudohalogen (halogenoid) ion means an ion having a nature similar to that of halogen ion, and examples of the same include cyanide ion (CN⁻), thiocyanate ion (SCN⁻), selenocyanate ion (SeCN⁻), tellurocyanate ion (TeCN⁻), azidodithiocarbonate ion (SCSN₃⁻), cyanate ion (OCN⁻), fulminate ion (ONC⁻), and azide ion (N₃⁻).

X^{I} is preferably a fluoride ion, a chloride ion, a bromide ion, an iodide ion, a cyanide ion, an isocyanate ion, a thiocyanate ion, a nitrate ion, a nitrite ion, or an azide ion. Among these, chloride ion and bromide ion are particularly preferable. L^{I} is not particularly limited, and it may be an organic or inorganic compound that may or may not have electric charge(s), with organic or inorganic compounds with no electric charge being preferable.

Preferable specific examples of the metal complex represented by formula (1) are shown below, but the present invention is not limited to these complexes.
[IrCl₅(H₂O)]²⁻
[IrCl₄(H₂O)₂]⁻
[IrCl₅(H₂O)]⁻
[IrCl₄(H₂O)₂]⁰
[IrCl₅(OH)]³⁻
[IrCl₄(OH)₂]²⁻
[IrCl₅(OH)]²⁻
[IrCl₄(OH)₂]²⁻
[IrCl₅(O)]⁴⁻
[IrCl₅(O)]³⁻
[IrCl₄(O)₂]⁴⁻
[IrCl₃Br(H₂O)]²⁻
[IrCl₃Br(H₂O)₂]⁻
[IrCl₄Br(H₂O)]⁻
[IrCl₃Br(H₂O)₂]⁰
[IrCl₃I(H₂O)]²⁻
[IrCl₃I(H₂O)]⁻
[IrCl₄I(H₂O)]⁻
[IrCl₃I(H₂O)₂]⁰
[IrBr₅(H₂O)]²⁻
[IrBr₄(H₂O)₂]⁻
[IrBr₅(H₂O)]⁻
[IrBr₄(H₂O)₂]⁰
[IrBr₅(OH)]³⁻
[IrBr₄(OH)₂]⁻
[IrBr₅(OH)]²⁻
[IrBr₄(OH)₂]²⁻
[IrBr₅(O)]⁴⁻
[IrBr₅(O)]³⁻
[IrBr₄(O)₂]⁴⁻
[IrBr₄Cl(H₂O)]²⁻
[IrBr₃Cl(H₂O)₂]⁻
[IrBr₄Cl(H₂O)]⁻
[IrBr₃Cl(H₂O)₂]⁰
[IrCl₅(OCN)]³⁻
[IrBr₅(OCN)]³⁻
[IrCl₅(thiazole)]²⁻
[IrCl₄(thiazole)₂]⁻
[IrCl₃(thiazole)₃]⁰
[IrBr₅(thiazole)]²⁻
[IrBr₄(thiazole)₂]⁻
[IrBr₃(thiazole)₃]⁰
[IrCl₅(5-methylthiazole)]²⁻
[IrCl₄(5-methylthiazole)₂]⁻
[IrBr₅(5-methylthiazole)]²⁻
[IrBr₄(5-methylthiazole)₂]⁻

Among these, [IrCl₅(H₂O)]²⁻, [IrCl₅(thiazole)]²⁻, and [IrCl₅(5-methylthiazole)]²⁻ are preferred.

The metal complex represented by formula (II) that can also be preferably used in the present invention, is explained below:

[IrX^{II}ₙL^{II}₍₆₋ₙ₎]^{m-}

In formula (II), M represents Cr, Mo, Re, Fe, Ru, Os, Co, Rh, Pd, or Pt; X^{II} represents a halogen ion; L^{II} represents a ligand different from X^{II}; n represents 3, 4, 5, or 6; and m represents 4−, 3−, 2−, 1−, 0, or 1+.

X^{II} is preferably a fluoride ion, a chloride ion, a bromide ion, or an iodide ion, and particularly preferably a chloride ion or a bromide ion. L^{II} may be an organic or inorganic compound that may or may not have electric charges, with inorganic compounds having no electric charge being preferable. L^{II} is preferably H₂O, NO, or NS.

Herein, 3 to 6 X^{II}s may be the same or different from each other. When plural L^{II}s exist, the plural L^{II}s may be the same or different from each other.

Preferable specific examples of the metal complex represented by formula (II) are shown below, but the present invention is not limited to these complexes.
[ReCl₆]²⁻
[ReCl₅(NO)]²⁻
[RuCl₆]²⁻
[RuCl₆]³⁻
[RuCl₅(NO)]²⁻
[RuCl₅(NS)]²⁻
[RuBr₅(NS)]²⁻
[OsCl₆]⁴⁻
[OsCl₅(NO)]²⁻
[OsBr₅(NS)]²⁻
[RhCl₆]³⁻
[RhCl₅(H₂O)]²⁻
[RhCl₄(H₂O)₂]⁻
[RhBr₆]³⁻
[RhBr₅(H₂O)]²⁻
[RhBr₄(H₂O)₂]⁻
[PdCl₆]²⁻
[PtCl₆]²⁻

Among these, [RuCl₅(NO)]²⁻, [OsCl₅(NO)]²⁻, [RhBr₆]³⁻, and [RhCl₆]³⁻ are preferred, and [RuCl₅(NO)]²⁻ is particularly preferred.

The foregoing metal complexes are anions. When these are formed into salts with cations, the counter cations are preferably those easily soluble in water. Specifically, alkali metal ions, such as sodium ion, potassium ion, rubidium ion, cesium ion, and lithium ion; an ammonium ion, and an alkylammonium ion are preferable. These metal complexes can be used by being dissolved in water or a mixed solvent of water and an appropriate water-miscible organic solvent (such as alcohols, ethers, glycols, ketones, esters and amides).

In the present invention, it is preferable that the above-mentioned metal complex is incorporated into the silver halide grains, by directly adding the same to a reaction solution for the formation of the silver halide grains, or by adding to an aqueous solution of the halide for the formation of the silver halide grains or to another solution and then adding the solution to the reaction solution for the grain formation. It is also preferable that a metal complex be incorporated into the silver halide grains by physical ripening with fine grains having metal complex previously incorporated therein. Further, the metal complex can be also contained into the silver halide grains by a combination of these methods.

In the case where these metal complexes are doped to the inside of the silver halide grains, they are preferably uniformly distributed in the inside of the grains. On the other hand, as disclosed in JP-A-4-208936, JP-A-2-125245 and JP-A-3-188437, they are also preferably distributed only in the grain surface layer. Alternatively, they are also preferably distributed only in the inside of the grain, while the grain surface is covered with a layer free of the complex. Further, as disclosed in U.S. Pat. Nos. 5,252,451 and 5,256,530, it is also preferred that the silver halide grains be subjected to physical ripening in the presence of fine grains having the metal complexes incorporated therein, to modify the grain surface phase. Further, these methods may be used in combination. Two or more kinds of complexes may be incorporated in the inside of an individual silver halide grain.

The silver halide grains in the silver halide emulsion for use in the present invention may contain, in addition to the iridium complex represented by formula (1), another iridium complex in which all of 6 ligands are of Cl, Br, or I. In this case, Cl, Br, or I may coexist in the six-coordination complex. The iridium complex having Cl, Br, or I as ligands is particularly preferably incorporated in a silver-bromide-containing phase, for obtaining hard gradation upon high illuminance exposure.

Specific examples of the iridium complex in which the six ligands each are Cl, Br, or I are shown below, but the present invention is not limited to these complexes.
[IrCl₆]²⁻
[IrCl₆]³⁻
[IrBr₆]²⁻
[IrBr₆]³⁻
[IrI₆]³⁻

In the present invention, metal ion other than the above-mentioned metal complexes can be doped in the inside and/or on the surface of the silver halide grains. As the metal ion to be used, a transition metal ion is preferable, and an ion of iron, ruthenium, osmium, lead, cadmium, or zinc is more preferable. It is further preferable that these metal ions are used in the form of six-coordination complexes of octahedron-type having ligands. When employing an inorganic compound as a ligand, cyanide ion, halide ion, thiocyanato, hydroxide ion, peroxide ion, azide ion, nitrite ion, water, ammonia, nitrosyl ion, or thionitrosyl ion is preferably used. Such a ligand is preferably coordinated to any metal ion selected from the group consisting of the above-mentioned iron, ruthenium, osmium, lead, cadmium, and zinc. Two or more kinds of these ligands are also preferably used in one complex molecule. Further, an organic compound can also be preferably used as a ligand. Preferable examples of the organic compound include chain compounds having a main chain of 5 or less carbon atoms and/or heterocyclic compounds of 5- or 6-membered ring. More preferable examples of the organic compound are those having at least a nitrogen, phosphorus, oxygen, or sulfur atom in the molecule as an atom which is capable of coordinating to the metal. Particularly preferred organic compounds are furan, thiophene, oxazole, isooxazole, thiazole, isothiazole, imidazole, pyrazole, triazole, furazane, pyran, pyridine, pyridazine, pyrimidine, and pyrazine. Further, organic compounds which have, as basic skeletons, the above-mentioned compounds, and have a substituent introduced therein are also preferred.

Preferable combinations of a metal ion and a ligand are those of iron and/or ruthenium ion and cyanide ion. In the present invention, one of these compounds is preferably used in combination with the metal complex mentioned in the above. Preferred of these compounds are those in which the number of cyanide ions accounts for the majority of the coordination number intrinsic to the iron or ruthenium that is the central metal. The remaining coordination sites are preferably occupied by thiocyan, ammonia, water, nitrosyl ion, dimethylsulfoxide, pyridine, pyrazine, or 4,4′-bipyridine. Most preferably each of 6 coordination sites of the central metal is occupied by a cyanide ion, to form a hexacyano iron complex or a hexacyano ruthenium complex. These metal complexes having cyanide ion ligands are preferably added, during grain formation, in an amount of 1×10⁻⁸ mol to 1×10⁻² mol, and most preferably 1×10⁻⁶ mol to 5×10⁻⁴ mol, per mol of silver.

Also, the silver halide emulsion for use in the present invention may contain a spectral sensitizing dye, for the purpose of imparting a so-called spectral sensitivity thereto so that the emulsion exhibits light-sensitivity in a desired wavelength region. Examples of the dye that can be used include a cyanine dye, a merocyanine dye, a complex cyanine dye, a complex merocyanine dye, a holopolar cyanine dye, a hemicyanine dye, a styryl dye, and a hemioxonol dye. In particular, examples of usable dyes are those belonging to the cyanine dye, merocyanine dye, or complex merocyanine dye. For these dyes, any nucleus commonly used for cyanine dyes as a basic heterocyclic nucleus can be used. Examples of the nucleus include pyrroline nucleus, oxazoline nucleus, thiazoline nucleus, pyrrol nucleus, oxazole nucleus, thiazole nucleus, selenazole nucleus, imidazole nucleus, tetrazole nucleus, and pyridine nucleus; nuclei resulting from fusion of an alicyclic hydrocarbon ring to the aforementioned nuclei; and nuclei resulting from fusion of an aromatic hydrocarbon ring to the aforementioned nuclei, e.g., indolenine nucleus, benzindolenine nucleus, indole nucleus, benzoxazole nucleus, naphthooxazole nucleus, benzothiazole nucleus, naphthothiazole nucleus, benzoselenazole nucleus, benzimidazole nucleus, quinoline nucleus and so forth. These nuclei may have a substituent on a carbon atom.

For the merocyanine dye or complex merocyanine dye, a 5- or 6-membered heterocyclic nucleus such as pyrazolin-5-one nucleus, thiohydantoin nucleus, 2-thiooxazolidine-2,4-dione nucleus, thiazolidine-2,4-dione nucleus, rhodanine nucleus, and thiobarbituric acid nucleus may be used as a nucleus having a ketomethylene structure.

These sensitizing dyes can be used singly or in combination, and a combination of these sensitizing dyes is often used, particularly for the purpose of supersensitization. Typical examples thereof are described in U.S. Pat. Nos. 2,688,545, 2,977,229, 3,397,060, 3,522,052, 3,527,641, 3,617,293, 3,628,964, 3,666,480, 3,672,898, 3,679,428, 3,703,377, 3,769,301, 3,814,609, 3,837,862, and 4,026,707, British Patent Nos. 1,344,281 and 1,507,803, JP-B-43-4936, JP-B-53-12375, JP-A-52-110618, and JP-A-52-109925.

In the present invention, together with the sensitizing dye, a dye having no spectral sensitizing action itself, or a substance that does not substantially absorb visible light and that exhibits supersensitization, may be included in the emulsion.

As a time when the sensitizing dye is added to a silver halide emulsion, it may be any time of the processes for preparation of the emulsion that has been recognized to be useful. In the present invention, addition of the sensitizing dye is, most commonly, carried out after completion of chemical sensitization, but before coating. However, the sensitizing dye may be simultaneously added together with a chemical sensitizer, to carry out spectral sensitization and chemical sensitization at the same time, as described in U.S. Pat. Nos. 3,628,969 and 4,225,666. Besides, as described in JP-A-58-113928, the sensitizing dye may be added prior to chemical sensitization, or alliteratively the sensitizing dye may be added before completion of formation of precipitation of silver halide grains, to start spectral sensitization. Further, as taught in U.S. Pat. No. 4,225,666, it is possible that the sensitizing dye may be separately added, namely a part of sensitizing dye is added prior to chemical sensitization and the remaining of sensitizing dye is added after chemical sensitization. The sensitizing dye may be added in any stage during grain formation of silver halide, as exemplified by the method disclosed in U.S. Pat. No. 4,183,756.

The amount of the sensitizing dye to be added is preferably in the range of from 0.5×10⁻⁶ to 1.0×10⁻² mol, more preferably in the range of from 1.0×10⁻⁶ to 5.0×10⁻³ mol, per mol of silver halide.

At the time of chemical sensitization of the silver halide emulsion of the present invention, silver chlorobromide grains prepared in advance may be added and dissolved, to control photographic performances. The addition timing is not limited as long as it is during chemical sensitization. It is preferable that, first, a sensitizing dye and a chemical sensitizer be added, and subsequently a silver chlorobromide emulsion be added and dissolved. The silver chloride content of the silver chlorobromide grains to be used is generally lower than the surface silver chloride content of the host grains. The silver chloride content is preferably 70 mol % or less, and more preferably 40 mol % or less; and the silver chlorobromide emulsion to be added is particularly preferably a pure silver bromide emulsion. The grain size of the silver chlorobromide grains is not particularly limited, so long as the silver chlorobromide grains can be completely dissolved, and it is preferably 0.1 μm or less, more preferably 0.05 μm or less, in terms of side length. The addition amount of the silver iodobromide grains varies depending on the host grains to be used, but, basically it is preferably 0.005 to 5 mol %, more preferably 0.1 to 1 mol %, per mol of silver.

Various compounds or precursors thereof can be included in the silver halide emulsion for use in the present invention, to prevent fogging from occurring or to stabilize photographic performance, during manufacture, storage or photographic processing of the photosensitive material. Specific examples of compounds useful for the above purposes are disclosed in JP-A-62-215272, pages 39 to 72, and they can be preferably used. In addition, 5-arylamino-1,2,3,4-thiatriazole compounds (the aryl residual group has at least one electron-withdrawing group) disclosed in European Patent No. 0447647 can also be preferably used.

Further, in the present invention, to enhance storage stability of the silver halide emulsion, it is also preferred to use hydroxamic acid derivatives described in JP-A-11-109576; cyclic ketones having a double bond adjacent to a carbonyl group, both ends of said double bond being substituted with an amino group or a hydroxyl group, as described in JP-A-11-327094 (in particular, compounds represented by formula (S1); the description at paragraph Nos. 0036 to 0071 of JP-A-11-327094 is incorporated herein by reference); sulfo-substituted catecols or hydroquinones described in JP-A-11-143011 (for example, 4,5-dihydroxy-1,3-benzenedisulfonic acid, 2,5-dihydroxy-1,4-benzenedisulfonic acid, 3,4-dihydroxybenzenesulfonic acid, 2,3-dihydroxybenzenesulfonic acid, 2,5-dihydroxybenzenesulfonic acid, 3,4,5-trihydroxybenzenesulfonic acid, and salts of these acids); hydroxylamines represented by formula (A) described in U.S. Pat. No. 5,556,741 (the description of line 56 in column 4 to line 22 in column 11 of U.S. Pat. No. 5,556,741 is preferably applied to the present invention and is incorporated herein by reference); and water-soluble reducing agents represented by formula (I), (II), or (III) of JP-A-11-102045.

The silver halide color photographic light-sensitive material of the present invention (hereinafter referred to as “photosensitive material” or “light-sensitive material” in some cases) has, on a support, at least one red-sensitive silver halide emulsion layer, at least one green-sensitive silver halide emulsion layer, and at least one blue-sensitive silver halide emulsion layer, and is characterized in that at least one of the silver halide emulsion layers contains a silver halide emulsion having a silver chloride content of 90 mol % or more and being chemically sensitized with at least one compound represented by the foregoing formula (I).

The photosensitive material of the present invention preferably comprises, on a support, at least one silver halide emulsion layer containing yellow-dye-forming coupler, at least one silver halide emulsion layer containing magenta-dye-forming coupler, and at least one silver halide emulsion layer containing cyan-dye-forming coupler. In the present invention, the silver halide emulsion layer containing yellow-dye-forming coupler functions as a yellow-color-forming layer, the silver halide emulsion layer containing magenta-dye-forming coupler functions as a magenta-color-forming layer, and the silver halide emulsion layer containing cyan-dye-forming coupler functions as a cyan-color-forming layer. Preferably, the silver halide emulsions contained in the yellow-color-forming layer, the magenta-color-forming layer, and the cyan-color-forming layer may have photo-sensitivities to mutually different wavelength regions of light. As a preferable example can be given a silver halide color photographic light-sensitive material wherein an emulsion having its sensitivity in a blue region is contained in the yellow-color-forming layer, an emulsion having its sensitivity in a green region is contained in the magenta-color-forming layer, and an emulsion having its sensitivity in a red region is contained in the cyan-color-forming layer, but the invention should not be construed as being limited to this example.

In the present invention, at least two silver halide emulsions of different sensitivities may be used in a silver halide emulsion layer. The number of silver halide emulsions of different sensitivities may be greater than 3, but the number is preferably 2 or 3 from the viewpoint of designing a photosensitive material. Such a plurality of silver halide emulsions may be the same or different in grain size, halide composition or structure, or kinds or amounts of sensitizing dyes, chemical sensitizers, and antifoggants added thereto.

Although it is preferable that at least two silver halide emulsions of different sensitivities are incorporated as a mixture in one silver halide emulsion layer, each of them may be applied separately to form different emulsion layers. However, these layers are required to have almost the same color sensitivity and color hue. The expression “almost the same color sensitivity”, in the case of a color photographic light-sensitive material, indicates that color sensitivities of the layers are included in either a blue sensitivity group, or a green sensitivity group, or a red sensitivity group, and within this scope they may be different in spectral sensitivity. The expression “almost the same color hue”, in the case of a color photographic light-sensitive material, indicates that hues of colors developed in the layers are included in either a yellow hue group, or a magenta hue group, or a cyan hue group, and within this scope the layers may differ in color hue.

In addition to the yellow-color-forming layer, the magenta-color-forming layer, and the cyan-color-forming layer, the photosensitive material of the present invention may have, if desired, a hydrophilic colloid layer, an antihalation layer, an intermediate layer, and a colored layer as described hereinafter. Further, a color-forming layer differing in hue from the foregoing layers (e.g., a black-color-forming layer) may be provided. The silver halide emulsion contained in the layer of a different hue may be any of blue-sensitive, green-sensitive, and red-sensitive emulsions, but it can be made infrared-sensitive with the intention of enhancing discriminative properties.

In the light-sensitive material of the present invention, any of known materials or additives for photography may be used.

For example, as a photographic support (base), a transmissive type support or a reflective type support may be used. As the transmissive type support, it is preferred to use a transparent film, such as a cellulose nitrate film, and a polyethylene terephthalate film; or a polyester of 2,6-naphthalenedicarboxylic acid (NDCA) and ethylene glycol (EG), or a polyester of NDCA, terephthalic acid, and EG, each provided thereon with an information-recording layer such as a magnetic layer. As the reflective type support, it is especially preferable to use a reflective support having a substrate laminated thereon with a plurality of polyethylene layers or polyester layers, at least one of the water-proof resin layers (laminate layers) contains a white pigment such as titanium oxide. In the present invention, it is preferred to use the reflective type support (or reflective support).

In the present invention, examples of more preferable reflective support includes a support having a paper substrate provided with a polyolefin layer having micropores (fine holes), on the same side as silver halide emulsion layers to be provided. The polyolefin layer may be composed of multi-layers. In this case, it is more preferable for the support to be composed of a micropore-free polyolefin (e.g., polypropylene, polyethylene) layer adjacent to a gelatin layer on the same side as the silver halide emulsion layers, and a micropore-containing polyolefin (e.g., polypropylene, polyethylene) layer closer to the paper substrate. The density of the multi-layer or single-layer of polyolefin layer(s) existing between the paper substrate and photographic constituting layers is preferably in the range of 0.40 to 1.0 g/ml, more preferably in the range of 0.50 to 0.70 g/ml. Further, the thickness of the multi-layer or single-layer of polyolefin layer(s) existing between the paper substrate and photographic constituting layers is preferably in the range of 10 to 100 μm, more preferably in the range of 15 to 70 μm. Further, the ratio of thickness of the polyolefin layer(s) to that of the paper substrate is preferably in the range of 0.05 to 0.2, more preferably in the range 0.1 to 0.15.

Further, it is also preferable for enhancing rigidity of the reflective support, that a polyolefin layer be provided on the surface of the foregoing paper substrate opposite to the side of the photographic constituting layers, i.e., on the back surface of the paper substrate. In this case, it is preferable that the polyolefin layer on the back surface be polyethylene or polypropylene, the surface of which is matted, with the polypropylene being more preferable. The thickness of the polyolefin layer on the back surface is preferably in the range of 5 to 50 μm, more preferably in the range of 10 to 30 μm, and further the density thereof is preferably in the range of 0.7 to 1.1 g/ml. As to the reflective support for use in the present invention, preferable embodiments of the polyolefin layer to be provided on the paper substrate include those described in JP-A-10-333277, JP-A-10-333278, JP-A-11-52513, JP-A-11-65024, European Patent Nos. 0880065 and 0880066.

Further, it is preferred that the above-described water-proof resin layer contain a fluorescent whitening agent. Further, the fluorescent whitening agent may be dispersed and contained in a hydrophilic colloid layer, which is formed separately from the above layers in the light-sensitive material. Preferred examples of the fluorescent whitening agent that can be used, include benzoxazole-series, coumarin-series, and pyrazoline-series compounds. Further, fluorescent whitening agents of benzoxazolylnaphthalene-series and benzoxazolylstilbene-series are more preferably used. The amount of the fluorescent whitening agent to be used is not particularly limited, and it is preferably in the range of 1 to 100 mg/m². When a fluorescent whitening agent is mixed with a water-proof resin, the mixing ratio of the fluorescent whitening agent to be used in the water-proof resin is preferably in the range of 0.0005 to 3% by mass, and more preferably in the range of 0.001 to 0.5% by mass, to the resin.

Further, a transmissive type support or the foregoing reflective type support each having coated thereon a hydrophilic colloid layer containing a white pigment may be used as the reflective type support. Furthermore, a reflective type support having a mirror plate reflective metal surface or a secondary diffusion reflective metal surface may be employed as the reflective type support.

As the support for use in the light-sensitive material of the present invention, a support of the white polyester type, or a support provided with a white pigment-containing layer on the same side as the silver halide emulsion layer, may be adopted for display use. Further, it is preferable for improving sharpness that an antihalation layer be provided on the silver halide emulsion layer side or the reverse side of the support. In particular, it is preferable that the transmission density of support be adjusted to the range of 0.35 to 0.8, so that a display may be enjoyed by means of both transmitted and reflected rays of light.

In the light-sensitive material of the present invention, in order to improve, e.g., the sharpness of an image, a dye (particularly an oxonole-series dye) that can be discolored by processing, as described in European Patent No. 0,337,490 A2, pages 27 to 76, is preferably added to the hydrophilic colloid layer, such that an optical reflection density at 680 nm in the light-sensitive material is 0.70 or more. It is also preferable to add 12% by mass or more (more preferably 14% by mass or more) of titanium oxide that is surface-treated with, for example, a dihydric to tetrahydric alcohol (e.g., trimethylolethane) to a water-proof resin layer of the support.

The light-sensitive material of the present invention preferably contains, in the hydrophilic colloid layer, a dye (particularly oxonole dyes and cyanine dyes) that can be discolored by processing, as described in European Patent No. 0337490A2, pages 27 to 76, in order to prevent irradiation or halation or to enhance safelight safety, and the like. Further, a dye described in European Patent No. 0819977 may also be preferably used in the present invention. Among these water-soluble dyes, some deteriorate color separation or safelight safety when used in an increased amount. Preferable examples of the dye which can be used and which does not deteriorate color separation, include water-soluble dyes described in JP-A-5-127324, JP-A-5-127325 and JP-A-5-216185.

In the present invention, it is possible to use a colored layer which can be discolored during processing, in place of the water-soluble dye, or in combination with the water-soluble dye. The colored layer that can be discolored with a processing, to be used, may contact with an emulsion layer directly, or indirectly through an interlayer containing an agent for preventing color-mixing during processing, such as hydroquinone or gelatin. The colored layer is preferably provided as a lower layer (i.e. a layer closer to the support) with respect to the emulsion layer which develops the same primary color as the color of the colored layer. It is possible to provide colored layers independently, each corresponding to respective primary colors. Alternatively, only some layers selected from them may be provided. In addition, it is possible to provide a colored layer subjected to coloring so as to match a plurality of primary-color regions. About the optical reflection density of the colored layer, it is preferred that, at the wavelength which provides the highest optical density in a range of wavelengths used for exposure (a visible light region from 400 nm to 700 nm for an ordinary printer exposure, and the wavelength of the light generated from the light source in the case of scanning exposure), the optical density be 0.2 or more but 3.0 or less, more preferably 0.5 or more but 2.5 or less, and particularly preferably 0.8 or more but 2.0 or less.

The colored layer may be formed by a known method. For example, there are a method in which a dye in a state of a dispersion of solid fine particles is incorporated in a hydrophilic colloid layer, as described in JP-A-2-282244, from page 3, upper right column to page 8, and JP-A-3-7931, from page 3, upper right column to page 11, left under column; a method in which an anionic dye is mordanted in a cationic polymer; a method in which a dye is adsorbed onto fine grains of silver halide or the like and fixed in the layer; and a method in which a colloidal silver is used, as described in JP-A-1-239544. As to a method of dispersing fine-powder of a dye in solid state, for example, JP-A-2-308244, pages 4 to 13, describes a method in which fine particles of dye which is substantially water-insoluble at least at the pH of 6 or less, but substantially water-soluble at least at the pH of 8 or more, are incorporated. The method of mordanting anionic dyes in a cationic polymer is described, for example, in JP-A-2-84637, pages 18 to 26. U.S. Pat. Nos. 2,688,601 and 3,459,563 disclose methods of preparing colloidal silver for use as a light absorber. Among these methods, preferred examples are the method of incorporating fine particles of dye, the method of using colloidal silver, and the like.

The silver halide photographic light-sensitive material of the present invention can be used, for example, as a color negative film, a color positive film, a color reversal film, a color reversal photographic paper, a color photographic paper. Among these, the use as a color photographic paper is particularly preferable. The color photographic paper, as mentioned above, preferably contains at least one yellow-color-forming silver halide emulsion layer, at least one magenta-color-forming silver halide emulsion layer, and at least one cyan-color-forming silver halide emulsion layer. In general, the arranging order of these silver halide emulsion layers in the direction that goes away from the support is a yellow-color-forming silver halide emulsion layer, a magenta-color-forming silver halide emulsion layer, and a cyan-color-forming silver halide emulsion layer, however the present invention is not limited to these.

In the present invention, a yellow-coupler-containing silver halide emulsion layer may be provided at any position on a support. In the case where silver halide tabular grains are contained in the yellow-coupler-containing layer, it is preferable that the yellow-coupler-containing layer be positioned more apart from a support than at least one of a magenta-coupler-containing silver halide emulsion layer and a cyan-coupler-containing silver halide emulsion layer. Further, it is preferable that the yellow-coupler-containing silver halide emulsion layer be positioned most apart from a support than other silver halide emulsion layers, from the viewpoint of color-development acceleration, desilvering acceleration, and reducing residual color due to sensitizing dye. Further, it is preferable that the cyan-coupler-containing silver halide emulsion layer be disposed in the middle of the other silver halide emulsion layers, from the viewpoint of reducing blix fading. On the other hand, it is preferable that the cyan-coupler-containing silver halide emulsion layer be the lowest layer, from the viewpoint of reducing light fading. Further, each of the yellow-color-forming layer, the magenta-color-forming layer, and the cyan-color-forming layer may be composed of two or three layers. It is also preferable that a color-forming layer be formed by providing a silver-halide-emulsion-free layer containing a coupler in adjacent to a silver halide emulsion layer, as described in, for example, JP-A-4-75055, JP-A-9-114035, JP-A-10-246940, and U.S. Pat. No. 5,576,159.

The photographic additives that can be used in the present invention are described in the following Research Disclosures (RD), whose particular parts are given in the following table.

| Kind of Additive | | RD 17643 | RD 18716 | RD 307105 |
|---|---|---|---|---|
| 1 | Chemical sensitizers | p. 23 | p. 648 (right column) | p. 866 |
| 2 | Sensitivity-enhancing agents | | p. 648 (right column) | |
| 3 | Spectral sensitizers and | pp. 23-24 | pp. 648 (right column)-649 | pp. 866-868 |
| | Supersensitizers | | (right column) | |
| 4 | Brightening agents | p. 24 | pp. 647 (right column) | p. 868 |
| 5 | Light absorbers, Filter dyes, | pp. 25-26 | pp. 649 (right column)-650 | p. 873 |
| | and UV Absorbers | | (left column) | |
| 6 | Binders | p. 26 | p. 651 (left column) | pp. 873-874 |
| 7 | Plasticizers and Lubricants | p. 27 | p. 650 (right column) | p. 876 |
| 8 | Coating aids and Surfactants | pp. 26-27 | p. 650 (right column) | pp. 875-876 |
| 9 | Antistatic agents | p. 27 | p. 650 (right column) | pp. 876-877 |
| 10 | Matting agents | | | pp. 878-879 |

Preferred examples of silver halide emulsions and other materials (additives or the like) that can be used in the present invention, photographic constituting layers (arrangement of the layers or the like), and processing methods for processing the photographic materials and additives for processing, are disclosed in JP-A-62-215272, JP-A-2-33144, and European Patent No. 0355660 A2. Particularly, those disclosed in European Patent No. 0355660 A2 are preferably used. Further, it is also preferred to use or apply silver halide color photographic light-sensitive materials and processing methods thereof disclosed in, for example, JP-A-5-34889, JP-A-4-359249, JP-A-4-313753, JP-A-4-270344, JP-A-5-66527, JP-A-4-34548, JP-A-4-145433, JP-A-2-854, JP-A-1-158431, JP-A-2-90145, JP-A-3-194539, JP-A-2-93641, and European Patent Publication No. 0520457 A2.

In particular, in the present invention, use can be particularly preferably made of those described in the patent publications as shown in the following Table 1, as the above-described reflective support and silver halide emulsion, as well as the different kinds of metal ions to be doped in the silver halide grains, the storage stabilizers or antifogging agents of the silver halide emulsion, the methods of chemical sensitization (sensitizers), the methods of spectral sensitization (spectral sensitizers), the cyan, magenta, and yellow couplers and the emulsifying and dispersing methods thereof, the dye-image-stability-improving agents (stain inhibitors and discoloration inhibitors), the dyes (colored layers), the kinds of gelatin, the layer structure of the light-sensitive material, the film pH of the light-sensitive material, and the like.

TABLE 1

| Element | JP-A-7-104448 | JP-A-7-77775 | JP-A-7-301895 |
|---|---|---|---|
| Reflective type supports | Column 7, line 12 to column | Column 35, line 43 to | Column 5, line 40 to column 9, line 26 |
| | 12, line 19 | column 44, line 1 | |
| Silver halide emulsions | Column 72, line 29 to | Column 44, line 36 to | Column 77, line 48 to column 80, line |
| | column 74, line 18 | column 46, line 29 | 28 |
| Other metal ion species | Column 74, lines 19 to 44 | Column 46, line 30 to | Column 80, line 29 to column 81, line 6 |
| | | column 47, line 5 | |
| Storage stabilizers or antifoggants | Column 75, lines 9 to 18 | Column 47, lines 20 to 29 | Column 18, line 11 to column 31, line |
| | | | 37 (Especially, mercapto-heterocyclic |
| | | | compounds) |
| Chemical sensitizing methods | Column 74, line 45 to | Column 47, lines 7 to 17 | Column 81, lines 9 to 17 |
| (Chemical sensitizers) | column 75, line 6 | | |
| Spectral sensitizing methods | Column 75, line 19 to | Column 47, line 30 to | Column 81, line 21 to column 82, line |
| (Spectral sensitizers) | column 76, line 45 | column 49, line 6 | 48 |
| Cyan couplers | Column 12, line 20 to | Column 62, line 50 to | Column 88, line 49 to column 89, line |
| | column 39, line 49 | column 63, line 16 | 16 |
| Yellow couplers | Column 87, line 40 to | Column 63, lines 17 to 30 | Column 89, lines 17 to 30 |
| | column 88, line 3 | | |
| Magenta couplers | Column 88, lines 4 to 18 | Column 63, line 3 to column | Column 31, line 34 to column 77, line |
| | | 64, line 11 | 44 and column 88, lines 32 to 46 |
| Emulsifying and dispersing | Column 71, line 3 to column | Column 61, lines 36 to 49 | Column 87, lines 35 to 48 |
| methods of couplers | 72, line 11 | | |
| Dye-image-preservability | Column 39, line 50 to | Column 61, line 50 to | Column 87, line 49 to column 88, line |
| improving agents | column 70, line 9 | column 62, line 49 | 48 |
| (antistaining agents) | | | |
| Anti-fading agents | Column 70, line 10 to | | |
| | column 71, line 2 | | |
| Dyes (coloring agents) | Column 77, line 42 to | Column 7, line 14 to column | Column 9, line 27 to column 18, line |
| | column 78, line 41 | 19, line 42, and column 50, | 10 |
| | | line 3 to column 51, line 14 | |
| Gelatins | Column 78, lines 42 to 48 | Column 51, lines 15 to 20 | Column 83, lines 13 to 19 |
| Layer construction of | Column 39, lines 11 to 26 | Column 44, lines 2 to 35 | Column 31, line 38 to column 32, line |
| light-sensitive materials | | | 33 |
| Film pH of light-sensitive materials | Column 72, lines 12 to 28 | | |
| Scanning exposure | Column 76, line 6 to | Column 49, line 7 to column | Column 82, line 49 to column 83, line |
| | column 77, line 41 | 50, line 2 | 12 |
| Preservatives in developer | Column 88, line 19 to | | |
| | column 89, line 22 | | |

As cyan, magenta, and yellow couplers which can be used in the present invention, other than the above-mentioned ones, those disclosed in JP-A-62-215272, page 91, right upper column, line 4 to page 121, left upper column, line 6; JP-A-2-33144, page 3, right upper column, line 14 to page 18, left upper column, bottom line, and page 30, right upper column, line 6 to page 35, right under column, line 11; and European Patent No. 0355,660 (A2), page 4, lines 15 to 27, page 5, line 30 to page 28, bottom line, page 45, lines 29 to 31, page 47, line 23 to page 63, line 50, are also advantageously used.

Further, it is preferred in the present invention to add compounds represented by formula (II) or (III) in WO 98/33760 and compounds represented by formula (D) described in JP-A-10-221825.

As the cyan dye-forming coupler (hereinafter also simply referred to as “cyan coupler”) which can be used in the present invention, pyrrolotriazole-series couplers are preferably used, and more specifically, couplers represented by formula (I) or (II) in JP-A-5-313324, and couplers represented by formula (I) in JP-A-6-347960 are preferred. Exemplified couplers described in these publications are particularly preferred. Further, phenol-series or naphthol-series cyan couplers are also preferred. For example, cyan couplers represented by formula (ADF) described in JP-A-10-333297 are preferred. Preferable examples of cyan couplers other than the foregoing cyan couplers, include pyrroloazole-type cyan couplers described in European Patent Nos. 0 488 248 and 0 491 197 (A1); 2,5-diacylamino phenol couplers described in U.S. Pat. No. 5,888,716; pyrazoloazole-type cyan couplers having an electron-withdrawing group or a group bonding via hydrogen bond at the 6-position, as described in U.S. Pat. Nos. 4,873,183 and 4,916,051; and particularly, pyrazoloazole-type cyan couplers having a carbamoyl group at the 6-position, as described in JP-A-8-171185, JP-A-8-311360, and JP-A-8-339060.

Further, as a cyan coupler, use can also be made of a diphenylimidazole-series cyan coupler described in JP-A-2-33144; as well as a 3-hydroxypyridine-series cyan coupler (particularly a 2-equivalent coupler formed by allowing a 4-equivalent coupler of a coupler (42), to have a chlorine splitting-off group; and couplers (6) and (9), enumerated as specific examples, are particularly preferable) described in European patent 0333185 A2; a cyclic active methylene-series cyan coupler (particularly couplers 3, 8, and 34 enumerated as specific examples are particularly preferable) described in JP-A-64-32260; a pyrrolopyrozole-type cyan coupler described in European Patent No. 0456226 μl; and a pyrroloimidazole-type cyan coupler described in European Patent No. 0484909.

Among these cyan couplers, pyrroloazole-series cyan couplers represented by formula (I) described in JP-A-11-282138 are particularly preferred. The descriptions of the paragraph Nos. 0012 to 0059 including exemplified cyan couplers (1) to (47) of the above JP-A-11-282138 can be entirely applied to the present invention, and therefore they are preferably incorporated herein by reference as a part of the present specification.

The magenta dye-forming couplers (which may be referred to simply as “magenta coupler” hereinafter) that can be used in the present invention can be 5-pyrazolone-series magenta couplers and pyrazoloazole-series magenta couplers, such as those described in the above-mentioned patent publications in the above table. Among these, preferred are pyrazolotriazole couplers in which a secondary or tertiary alkyl group is directly bonded to the 2-, 3-, or 6-position of the pyrazolotriazole ring, such as those described in JP-A-61-65245; pyrazoloazole couplers having a sulfonamido group in its molecule, such as those described in JP-A-61-65246; pyrazoloazole couplers having an alkoxyphenylsulfonamido ballasting group, such as those described in JP-A-61-147254; and pyrazoloazole couplers having an alkoxy or aryloxy group at the 6-position, such as those described in European Patent Nos. 226849 A and 294785 A, in view of hue and stability of an image to be formed therefrom, and color-forming property of the couplers. Particularly, as the magenta coupler, pyrazoloazole couplers represented by formula (M-I) described in JP-A-8-122984 are preferred. The descriptions of paragraph Nos. 0009 to 0026 of the patent publication JP-A-8-122984 can be entirely applied to the present invention, and therefore are incorporated herein by reference as a part of the present specification. In addition, pyrazoloazole couplers having a steric hindrance group at both the 3- and 6-positions, as described in European Patent Nos. 854384 and 884640, can also be preferably used.

Further, as yellow dye-forming couplers (which may be referred to simply as “yellow coupler” herein), preferably use can be made of acylacetamide-type yellow couplers in which the acyl group has a 3-membered to 5-membered ring structure, such as those described in European Patent No. 0447969 A1; malondianilide-type yellow couplers having a ring structure, as described in European Patent No. 0482552 A1; pyrrol-2 or 3-yl or indol-2 or 3-yl carbonyl acetanilide-series couplers, as described in European Patent (laid open to public) Nos. 953870 A1, 953871 A1, 953872 A1, 953873 A1, 953874 A1, and 953875 A1; acylacetamide-type yellow couplers having a dioxane structure, such as those described in U.S. Pat. No. 5,118,599; acetanilide-type yellow couplers wherein the acyl group is substituted by a hetero ring, such as those described in JP-A-2003-173007, other than the compounds described in the above-mentioned table. Of these couplers, the acylacetamide-type yellow couplers whose acyl groups are 1-alkylcyclopropane-1-carbonyl groups, the malondianilide-type yellow couplers wherein either anilide forms an indoline ring, the acetanilide-type yellow couplers wherein the acyl group is substituted by a hetero ring are used to advantage. These couplers may be used singly or in combination.

It is preferred that coupler(s) for use in the present invention, be pregnated into a loadable latex polymer (as described, for example, in U.S. Pat. No. 4,203,716), in the presence (or absence) of the high-boiling-point organic solvent described in the foregoing table, or dissolved together with a polymer insoluble in water but soluble in an organic solvent, and then emulsified and dispersed into an aqueous hydrophilic colloid solution. Examples of the water-insoluble but organic-solvent-soluble polymer which can be preferably used, include the homo-polymers and co-polymers as disclosed in U.S. Pat. No. 4,857,449, from column 7 to column 15, and WO 88/00723, from page 12 to page 30. Use of a methacrylate-series or acrylamide-series polymer, especially an acrylamide-series polymer is more preferable, in view of color-image stabilization and the like.

In the present invention, any of known color mixing-inhibitors may be used. Among these compounds, those described in the following patent publications are preferred.

For example, high molecular weight redox compounds described in JP-A-5-333501; phenidone- or hydrazine-series compounds as described in, for example, WO 98/33760 and U.S. Pat. No. 4,923,787; and white couplers as described in, for example, JP-A-5-249637, JP-A-10-282615, and German Patent No. 19629142 A1, may be used. Particularly, in order to accelerate developing speed by increasing the pH of a developing solution, redox compounds described in, for example, German Patent No. 19,618,786 A1, European Patent Nos. 839,623 A1 and 842,975 A1, German Patent No. 19,806,846 A1 and French Patent No. 2,760,460 A1, are also preferably used.

In the present invention, as an ultraviolet ray absorbent, it is preferred to use a compound having a high molar extinction coefficient and a triazine skeleton. For example, compounds described in the following patent publications can be used. These compounds are preferably added to the light-sensitive layers or/and the light-insensitive layers. For example, use can be made of those described in JP-A-46-3335, JP-A-55-152776, JP-A-5-197074, JP-A-5-232630, JP-A-5-307232, JP-A-6-211813, JP-A-8-53427, JP-A-8-234364, JP-A-8-239368, JP-A-9-31067, JP-A-10-115898, JP-A-10-147577, JP-A-10-182621, German Patent No. 19,739,797A, European Patent No. 711,804 A, and JP-T-8-501291 (“JP-T” means searched and published International patent application), and the like.

As the binder or protective colloid which can be used in the light-sensitive material of the present invention, gelatin is used advantageously, but another hydrophilic colloid can be used singly or in combination with gelatin. It is preferable that, in the gelatin, the content of heavy metals, such as Fe, Cu, Zn, and Mn, included as impurities, be reduced to 5 ppm or less, more preferably 3 ppm or less. Further, the amount of calcium contained in the light-sensitive material is preferably 20 mg/m² or less, more preferably 10 mg/m² or less, and most preferably 5 mg/m² or less.

In the present invention, it is preferred to add an antibacterial (fungi-preventing) agent and antimold agent, as described in JP-A-63-271247, in order to destroy various kinds of molds and bacteria which propagate in a hydrophilic colloid layer and deteriorate the image. Further, the film pH of the light-sensitive material is preferably in the range of 4.0 to 7.0, more preferably in the range of 4.0 to 6.5.

In the present invention, the total amount of gelatin to be applied in the photographic structural layers is preferably 3 g/m² or more and 6 g/m² or less, more preferably 3 g/m² or more and 5 g/m² or less. The film thickness of the entire photographic structural layers is preferably 3 μm to 7.5 μm, more preferably 3 μm to 6.5 μm, to satisfy development progress characteristics, fixing-bleaching property, and residual color, even in ultra-rapid processing. As to a method of measuring a dried film thickness, the film thickness can be measured based on a change in film thickness before and after the dried film is peeled off, or by observing the section with an optical microscope or an electron microscope. In the present invention, the swelled film thickness is preferably 8 μm to 19 μm, more preferably 9 μm to 18 μm, to achieve both the improvement in development progress characteristics and the increase in a drying speed. The swelled film thickness may be measured by immersing a dried light-sensitive material in a 35° C. aqueous solution to allow the material to be swelled into a sufficiently equilibrated condition, under which condition the thickness is measured by a known dotting method. The total coating amount of silver in photographic constituent layers is preferably 0.2 g/m² to 0.5 g/m², further preferably from 0.2 g/m² to 0.45 g/m², and most preferably 0.2 g/m² to 0.40 g/m².

In the present invention, a surfactant may be added to the light-sensitive material, in view of improvement in coating-stability, prevention of static electricity from being occurred, and adjustment of the charge amount. As the surfactant, mention can be made of anionic surfactants, cationic surfactants, betaine surfactants, and nonionic surfactants. Examples thereof include those described in JP-A-5-333492. As the surfactant that can be used in the present invention, a fluorine-containing surfactant is particularly preferred. The fluorine-containing surfactant may be used singly, or in combination with known other surfactant. The fluorine-containing surfactant is preferably used in combination with known other surfactant. The amount of the surfactant to be added to the light-sensitive material is not particularly limited, but it is generally in the range of 1×10⁻⁵ to 1 g/m², preferably in the range of 1×10⁻⁴ to 1×10⁻¹ g/m², and more preferably in the range of 1×10⁻³ to 1×10⁻² g/m².

The photosensitive material of the present invention can form an image, via an exposure step in which the photosensitive material is irradiated with light according to image information (image data), and a development step in which the photosensitive material irradiated with light is developed.

The light-sensitive material of the present invention can preferably be used, in a scanning exposure system using a cathode ray tube (CRT), in addition to the printing system using a usual negative printer. The cathode ray tube exposure apparatus is simpler and more compact, and therefore less expensive than an apparatus using a laser. Further, optical axis and color (hue) can easily be adjusted. In a cathode ray tube which is used for image-wise exposure, various light-emitting materials which emit a light in the spectral region, are used as occasion demands. For example, any one of red-light-emitting materials, green-light-emitting materials, blue-light-emitting materials, or a mixture of two or more of these light-emitting materials may be used. The spectral regions are not limited to the above red, green, and blue, and fluorophoroes which can emit a light in a region of yellow, orange, purple, or infrared can also be used. Particularly, a cathode ray tube which emits a white light by means of a mixture of these light-emitting materials, is often used.

In the case where the light-sensitive material has a plurality of light-sensitive layers each having different spectral sensitivity distribution from each other, and also the cathode ray tube has a fluorescent substance which emits light in a plurality of spectral regions, exposure to a plurality of colors may be carried out at the same time. Namely, a plurality of color image signals may be input into a cathode ray tube, to allow light to be emitted from the surface of the tube. Alternatively, a method in which an image signal of each of colors is successively input and light of each of colors is emitted in order, and then exposure is carried out through a film capable of cutting colors other than the emitted color, i.e., an area (or surface) sequential exposure, may be used. Generally, among these methods, the area sequential exposure is preferred from the viewpoint of high image quality enhancement, because a cathode ray tube having a high resolving power can be used.

The light-sensitive material of the present invention can preferably be used in the digital scanning exposure system using monochromatic high density light, such as a gas laser, a light-emitting diode, a semiconductor laser, a second harmonic generation light source (SHG) comprising a combination of nonlinear optical crystal with a semiconductor laser or a solid state laser using a semiconductor laser as an excitation light source. It is preferred to use a semiconductor laser, or a second harmonic generation light source (SHG) comprising a combination of nonlinear optical crystal with a solid state laser or a semiconductor laser, to make a system more compact and inexpensive. In particular, to design a compact and inexpensive apparatus having a longer duration of life and high stability, use of a semiconductor laser is preferable; and it is preferred that at least one of exposure light sources be a semiconductor laser.

When such a scanning exposure light source is used, the maximum spectral sensitivity wavelength of the light-sensitive material of the present invention can be arbitrarily set up in accordance with the wavelength of a scanning exposure light source to be used. Since oscillation wavelength of a laser can be made half, using a SHG light source obtainable by a combination of a nonlinear optical crystal with a semiconductor laser or a solid state laser using a semiconductor as an excitation light source, blue light and green light can be obtained. Accordingly, it is possible to have the spectral sensitivity maximum of a light-sensitive material in usual three wavelength regions of blue, green, and red. The exposure time in such a scanning exposure is defined as the time period necessary to expose the size of a picture element (pixel) with the density of the picture element being 400 dpi, and a preferred exposure time is 1×10⁻⁴ sec or less, more preferably 1×10⁻⁶ sec or less.

When the present invention is applied to silver halide color photographic light-sensitive materials, it is preferable to perform image-wise exposure using coherent light of blue lasers with emission wavelengths of 420 nm to 460 nm. Of the blue lasers, blue semiconductor lasers are used to particular advantage.

Specific examples of the laser light source that can be preferably used, include a blue-light semiconductor laser having a wavelength of 430 to 450 nm (Presentation by Nichia Corporation at the 48th Applied Physics Related Joint Meeting, in March of 2001); a blue laser at about 470 nm obtained by wavelength modulation of a semiconductor laser (oscillation wavelength about 940 nm) with a SHG crystal of LiNbO₃ having a reversed domain structure in the form of a wave guide; a green-light laser at about 530 nm obtained by wavelength modulation of a semiconductor laser (oscillation wavelength about 1,060 nm) with SHG crystal of LiNbO₃ having a reversed domain structure in the form of a wave guide; a red-light semiconductor laser of the wavelength at about 685 nm (Type No. HL6738MG (trade name) manufactured by Hitachi, Ltd.); and a red-light semiconductor laser of the wavelength at about 650 nm (Type No. HL6501MG (trade name) manufactured by Hitachi, Ltd.).

The silver halide color photographic light-sensitive material of the present invention is preferably used in combination with the exposure and development systems described in the following known literatures. Example of the development system include the automatic print and development system described in JP-A-10-333253, the photosensitive material conveying apparatus described in JP-A-2000-10206, a recording system including the image reading apparatus, as described in JP-A-11-215312, exposure systems with the color image recording method, as described in JP-A-11-88619 and JP-A-10-202950, a digital photo print system including the remote diagnosis method, as described in JP-A-10-210206, and a photo print system including the image recording apparatus, as described in JP-A-2000-310822.

The preferred scanning exposure methods which can be applied to the present invention are described in detail in the publications listed in the table shown above.

It is preferred to use a band stop filter, as described in U.S. Pat. No. 4,880,726, when the light-sensitive material of the present invention is subjected to exposure with a printer. Color mixing of light can be excluded and color reproducibility is remarkably improved by the above means.

In the present invention, a yellow microdot pattern may be previously formed by pre-exposure before giving an image information, to thereby perform a copy restraint, as described in European Patent Nos. 0789270 A1 and 0789480 A1.

In order to process the light-sensitive material of the present invention, processing materials and processing methods described in JP-A-2-207250, page 26, right lower column, line 1, to page 34, right upper column, line 9, and in JP-A-4-97355, page 5, left upper column, line 17, to page 18, right lower column, line 20, can be applied. Further, as the preservative for use in the developing solution, compounds described in the patent publications listed in the above table can be used.

The present invention can also be preferably applied to a light-sensitive material having rapid processing suitability. In the case of conducting rapid processing, the color-developing time is preferably 28 sec or less, more preferably from 25 sec to 6 sec, and further more preferably from 20 sec to 6 sec. Likewise, the blix time is preferably 30 sec or less, more preferably from 25 sec to 6 sec, and further preferably from 20 sec to 6 sec. Further, the washing or stabilizing time is preferably 60 sec or less, and more preferably from 40 sec to 6 sec.

Herein, the term “color-developing time” as used herein means a period of time required from the beginning of dipping a light-sensitive material into a color developing solution until the light-sensitive material is dipped into a blix solution in the subsequent processing step. For example, when processing is carried out using an autoprocessor or the like, the color developing time is the sum total of a time in which a light-sensitive material has been dipped in a color developing solution (so-called “time in the solution”) and a time in which the light-sensitive material has left the color developing solution and been conveyed in air toward a bleach-fixing bath in the step subsequent to color development (so-called “time in the air”). Likewise, the term “blix time” as used herein means a period of time required from the beginning of dipping a light-sensitive material into a blix solution until the light-sensitive material is dipped into a washing bath or a stabilizing bath in the subsequent processing step. Further, the term “washing or stabilizing time” as used herein means a period of time required from the beginning of dipping a light-sensitive material into a washing solution or a stabilizing solution until the end of the dipping toward a drying step (so-called “time in the solution”).

Examples of a development method after exposure, applicable to the light-sensitive material of the present invention, include a conventional wet method, such as a development method using a developing solution containing an alkali agent and a developing agent (notably, p-phenylenediamine color developing agent), and a development method wherein a developing agent is incorporated in a light-sensitive material and an activator solution, e.g., an alkaline solution free of developing agent is employed for the development, as well as a heat development method using no processing solution. In particular, the activator method is preferred over the other methods, because the processing solutions contain no developing agent, thereby it enables easy management and handling of the processing solutions and reduction in waste solution disposal or processing-related load to make for environmental preservation.

In the present invention, it is preferable to adopt a method of carrying out development by use of a developing solution containing an alkali agent and a developing agent (notably, p-phenylenediamine color developing agent).

The preferable developing agents or their precursors incorporated in the light-sensitive materials in the case of adopting the activator method, include the hydrazine-type compounds described in, for example, JP-A-8-234388, JP-A-9-152686, JP-A-9-152693, JP-A-9-211814 and JP-A-9-160193.

Further, the processing method in which a light-sensitive material reduced in the amount of silver to be applied, undergoes the image amplification processing using hydrogen peroxide (intensification processing), can be employed preferably. In particular, it is preferable to apply this processing method to the activator method. Specifically, the image-forming methods utilizing an activator solution containing hydrogen peroxide, as disclosed in JP-A-8-297354 and JP-A-9-152695 can be preferably used. Although the processing with an activator solution is generally followed by a desilvering step in the activator method, the desilvering step can be omitted in the case of applying the image amplification processing method to light-sensitive materials having a reduced silver amount. In such a case, washing or stabilization processing can follow the processing with an activator solution to result in simplification of the processing process. On the other hand, when the system of reading the image information from light-sensitive materials by means of a scanner or the like, is employed, the processing form requiring no desilvering step can be applied, even if the photographic materials are those having a high silver amount, such as photographic materials for shooting.

As the processing materials and processing methods of the activator solution, desilvering solution (bleach/fixing solution), washing solution and stabilizing solution, which can be used in the present invention, known ones can be used. Preferably, those described in Research Disclosure, Item 36544, pp. 536-541 (September 1994), and JP-A-8-234388 can be used in the present invention.

The present invention will be described in more detail based on the following examples, but the invention is not intended to be limited thereto.

### EXAMPLES

In the following examples and comparative examples, “%” to show a composition means mass %, unless otherwise specified.

### Example 1

### Preparation of Blue-Sensitive-Layer Emulsion BH-1 High-silver-chloride cubic grains were prepared using a method of adding an aqueous silver nitrate solution and an aqueous sodium chloride solution simultaneously to stirring deionized and distilled water containing deionized gelatin. In the process of this preparation, a period when 0% to 5% of the silver nitrate addition finished was assigned for nucleation. Over the period between the instant when 5% of silver nitrate addition finished and the instant when 85% of the silver nitrate addition finished, addition speeds of the aqueous silver nitrate solution and the aqueous sodium chloride solution were each increased as a linear function of time. The solute addition speed at the time of finish of the accelerated addition was set at 85% of the critical growth speed. Over the period between the instant when 85% of the silver nitrate addition finished and the instant when 100% of the silver nitrate addition finished, potassium bromide (2.5 mol % per mole of finished silver halide) was added. Over the period between the instant when 95% of the silver nitrate addition finished and the instant when 96% of the silver nitrate addition finished, potassium iodide (0.2 mol % per mole of finished silver halide) was added with vigorous stirring. K₂[RuCl₅(NO)] was added over the period between the instant when 5% of the silver nitrate addition finished and the instant when 50% of the silver nitrate addition finished. K₄[Fe(CN)₆] was added over the period between the instant when 85% of the silver nitrate addition finished and the instant when 90% of the silver nitrate addition finished. K₂[IrCl₆] and K₂[IrCl₅(5-methylthiazole)] were added over the period between the instant when 90% of the silver nitrate addition finished and the instant when 95% of the silver nitrate addition finished. K₂[IrCl₅(H₂O)], K[IrCl₄(H₂O)₂], and K₂[IrCl₄Br(H₂O)] were added over the period between the instant when 95% of the silver nitrate addition finished and the instant when 98% of the silver nitrate addition finished. The emulsion grains thus prepared were monodisperse cubic silver iodobromochloride grains having an average side length of 0.35 μm and a variation coefficient of 9.0%, and therein the silver bromide content was 2.5 mol %, the silver iodide content was 0.2 mol %, and the silver chloride content was 97.3 mol %. This emulsion underwent desalting treatment by flocculation, and then mixing with gelatin, Compounds Ab-1, Ab-2, and Ab-3, and calcium nitrate, followed by re-dispersion.

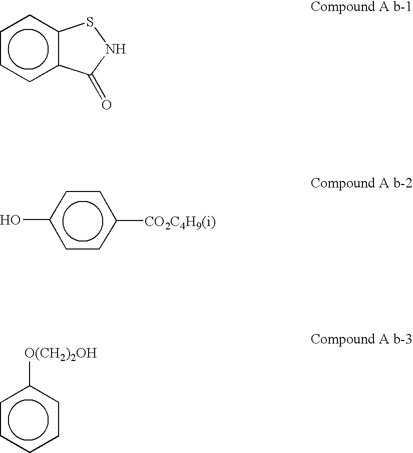

The re-dispersed emulsion was melted at 40° C., and thereto Sensitizing dyes S-1, S-2, S-3, and S-9 were added so that optimum spectral sensitization was achieved. Further thereto, sodium benzenethiosulfonate, Compound A (N,N-dimethylselenourea (in an amount of 4.0×10⁻⁶ mole per mole of finished silver halide)), bis(1,4,5-trimethyl-1,2,4-triazolium-3-thiolate)aurate(I) tetrafluoroborate, and p-glutaramidophenyldisulfide were added in order of mention. Then, the resulting emulsion was heated to a temperature of 60° C., and ripened so as to achieve optimum chemical sensitization. Thereafter, the thus-ripened emulsion was admixed with 1-phenyl-5-mercaptotetrazole, 1-(5-methylureidophenyl)-5-mercaptotetrazole, and 1-(3-acetamidophenyl)-5-mercaptotetrazole, and the temperature thereof was lowered to 40° C. Thereto, Compound-2; a mixture whose major components were compounds represented by Compound-3 in which the number of the repeating unit (n) was 2 or 3 (both ends X₁ and X₂ were each a hydroxyl group); Compound-4, and potassium bromide (0.3 mol % per mole of fished siver halide) were further added, to complete chemical sensitization. The emulsion thus obtained was designated as Emulsion BH-1.

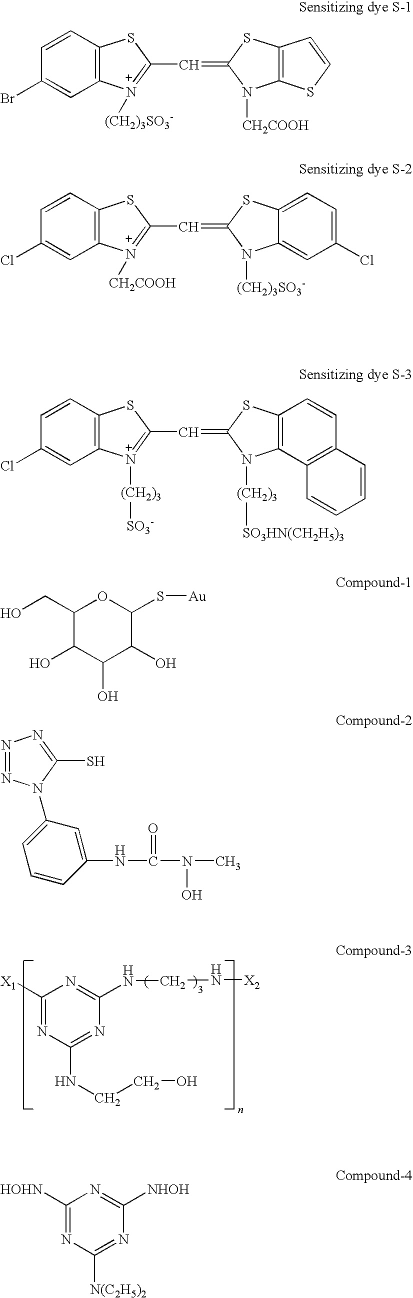

(Preparation of Blue-Sensitive Layer Emulsion BL-1) Emulsion grains were prepared in the same manner as in the preparation of Emulsion BH-1, except that the temperature and the addition rate at the step of mixing silver nitrate aqueous solution and sodium chloride aqueous solution by simultaneous addition were changed, and the amounts of respective metal complexes that were to be added during the addition of the silver nitrate aqueous solution and sodium chloride aqueous solution were changed. The thus-obtained emulsion grains were monodisperse cubic silver iodobromochloride grains having a side length of 0.30 μm and a variation coefficient of 9.5% (silver chloride content: 97.3 mol %). After re-dispersion of this emulsion, Emulsion BL-1 was subjected to spectral sensitization and chemical sensitization in the same manner as Emulsion BH-1, except that the amounts of compounds to be added in the preparation of BH-1 were changed.

### (Preparation of Green-Sensitive-Layer Emulsion GH-1)

High-silver-chloride cubic grains were prepared using a method of adding an aqueous silver nitrate solution and an aqueous sodium chloride solution simultaneously to stirring deionized and distilled water containing deionized gelatin. In the process of this preparation, a period when 0% to 5% of the silver nitrate addition finished was assigned for nucleation. Over the period between the instant when 5% of silver nitrate addition finished and the instant when 70% of the silver nitrate addition finished, addition rates of the aqueous silver nitrate solution and the aqueous sodium chloride solution were each increased as a linear function of time. The solute addition rate at the time of finish of the accelerated addition was set at 90% of the critical growth rate. Over the period between the instant when 70% of the silver nitrate addition finished and the instant when 90% of the silver nitrate addition finished, potassium bromide (3.0 mol % per mole of finished silver halide) was added. In the instant when 93% of the silver nitrate addition finished, potassium iodide (0.15 mol % per mole of finished silver halide) was added within 10 seconds with vigorous stirring. K₂[RhCl₅(H₂O)] was added over the period between the instant when 5% of the silver nitrate addition finished and the instant when 40% of the silver nitrate addition finished. K₂[IrCl₆] was added over the period between the instant when 75% of the silver nitrate addition finished and the instant when 85% of the silver nitrate addition finished. K₄[Fe(CN)₆] was added over the period between the instant when 85% of the silver nitrate addition finished and the instant when 90% of the silver nitrate addition finished. K₂[IrCl₅(H₂O)] and K[IrCl₄(H₂O)₂] were added over the period between the instant when 90% of the silver nitrate addition finished and the instant when 100% of the silver nitrate addition finished. K₂[IrCl₅(5-methylthiazole)] was added over the period between the instant when 93% of the silver nitrate addition finished and the instant when 98% of the silver nitrate addition finished. The emulsion grains thus prepared were monodisperse cubic silver iodobromochloride grains having an average side length of 0.25 μm and a variation coefficient of 9.5%, and therein the silver bromide content was 3.0 mol %, the silver iodide content was 0.15 mol %, and the silver chloride content was 96.85 mol %. This emulsion underwent desalting treatment by flocculation, and then mixing with gelatin, Compounds Ab-1, Ab-2, and Ab-3, and calcium nitrate, followed by re-dispersion.

The re-dispersed emulsion was melted at 40° C., and thereto Sensitizing dyes S-4, S-5, S-6, and S-7 were added so that optimum spectral sensitization was achieved. Further thereto, 1-(5-methylureidophenyl)-5-mercaptotetrazole, sodium benzenethiosulfonate, sodium benzenesulfinate, inorganic sulfur, sodium thiosulfate pentahydrade, and bis(1,4,5-trimethyl-1,2,4-triazolium-3-thiolate)aurate(I) tetrafluoroborate were added in order of mention. Then, the resulting emulsion was heated to a temperature of 65° C., and ripened so as to achieve optimum chemical sensitization. Thereafter, the thus-ripened emulsion was added with 1-(3-acetamidophenyl)-5-mercaptotetrazole, 1-(5-methylureidophenyl)-5-mercaptotetrazole and Compound 2. The temperature thereof was lowered to 40° C., and Compound 4 and potassium bromide (0.4 mol % per mole of fished silver halide) were further added thereto to complete chemical sensitization. The emulsion thus obtained was designated as Emulsion GH-1.

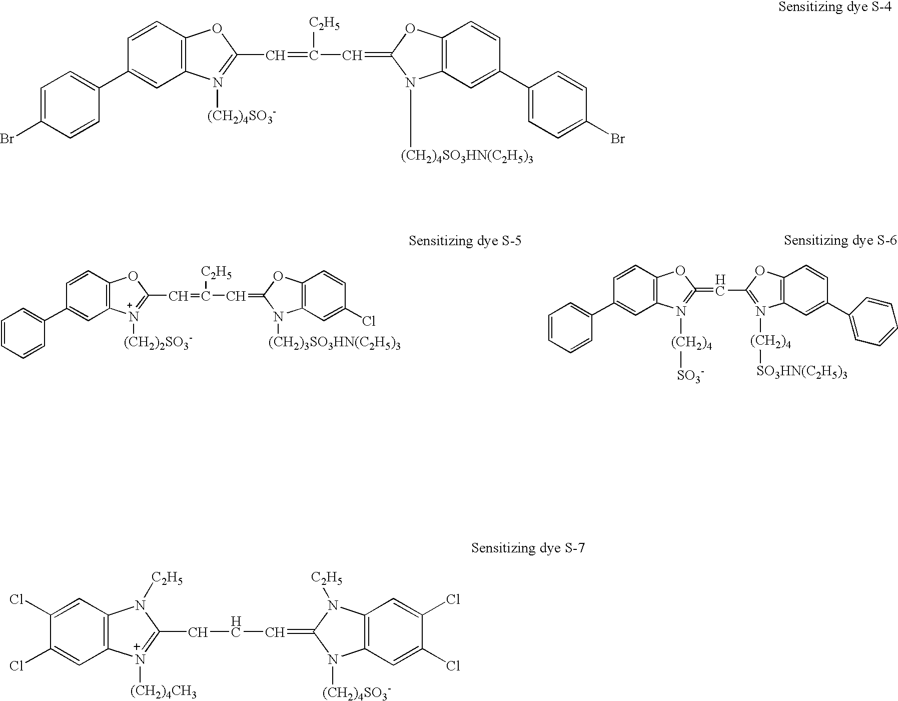

### (Preparation of Green-Sensitive-Layer Emulsion GL-1)

Emulsion grains were prepared in the same manner as in the preparation of Emulsion GH-1, except that the amount of K₂[RhCl₅(H₂O)] added over the period between the instant when 5% of the silver nitrate addition finished and the instant when 40% of the silver nitrate addition finished was increased by a factor of 1.5. The thus-obtained emulsion grains were monodisperse cubic silver iodobromochloride grains (silver chloride content: 96.85 mol %) having an average side length of 0.25 μm and a variation coefficient of 9.5%. After the re-dispersion of this emulsion, the same spectral sensitization and chemical sensitization as in the preparation of Emulsion GH-1 were performed, thereby preparing Emulsion GL-1.

(Preparation of Red-sensitive-layer emulsion RH-1)

High-silver-chloride cubic grains were prepared using a method of adding an aqueous silver nitrate solution and an aqueous sodium chloride solution simultaneously to stirring deionized and distilled water containing deionized gelatin. In the process of this preparation, a period when 0% to 5% of the silver nitrate addition finished was assigned for nucleation. Over the period between the instant when 5% of silver nitrate addition finished and the instant when 70% of the silver nitrate addition finished, addition rates of the aqueous silver nitrate solution and the aqueous sodium chloride solution were each increased as a linear function of time. The solute addition rate at the time of finish of the accelerated addition was set at 90% of the critical growth rate. Over the period between the instant when 70% of the silver nitrate addition finished and the instant when 90% of the silver nitrate addition finished, potassium bromide (4.0 mol % per mole of finished silver halide) was added. Over the period between the instant when 90% of the silver nitrate addition finished and the instant when 100% of the silver nitrate addition finished, potassium bromide (0.5 mol % per mole of finished silver halide) was added. Over the period between the instant when 97% of the silver nitrate addition finished and the instant when 98% of the silver nitrate addition finished, potassium iodide (0.05 mol % per mole of finished silver halide) was added with vigorous stirring. K₂[RhBr₅(H₂O)] was added over the period between the instant when 70% of the silver nitrate addition finished and the instant when 80% of the silver nitrate addition finished. K₂[IrCl₆] was added over the period between the instant when 75% of the silver nitrate addition finished and the instant when 85% of the silver nitrate addition finished. K₄[Ru(CN)₆] was added over the period between the instant when 80% of the silver nitrate addition finished and the instant when 90% of the silver nitrate addition finished. K₂[IrCl₅(5-methylthiazole)] was added over the period between the instant when 90% of the silver nitrate addition finished and the instant when 95% of the silver nitrate addition finished. K₂[IrCl₅(H₂O)], K[IrCl₄(H₂O)₂], and K₂[IrCl₄Br(H₂O)] were added over the period between the instant when 95% of the silver nitrate addition finished and the instant when 100% of the silver nitrate addition finished. The emulsion grains thus prepared were monodisperse cubic silver iodobromochloride grains having an average side length of 0.25 μm and a variation coefficient of 9.5%, and therein the silver bromide content was 4.5 mol %, the silver iodide content was 0.05 mol %, and the silver chloride content was 95.45 mol %. This emulsion underwent desalting treatment by flocculation, and then mixing with gelatin, Compounds Ab-1, Ab-2, and Ab-3, and calcium nitrate, followed by re-dispersion.

The re-dispersed emulsion was melted at 40° C., and thereto inorganic sulfur, sodium benzenethiosulfonate, Sensitizing dye S-8, and Compound-5 were added so that optimum spectral sensitization was achieved. Further thereto, triethylthiourea, Compound-1, and p-glutaramidophenyldisulfide were added in order of mention. Then, the resulting emulsion was heated to a temperature of 55° C., and ripened so as to achieve optimum chemical sensitization. Thereafter, the temperature of the emulsion was lowered to 40° C., and the resulting emulsion was added with 1-(5-methylureidophenyl)-5-mercaptotetrazole, and 1-(3-acetamidophenyl)-5-mercaptotetrazole, and further added with Compound-2, Compound-4, Compound-5, and potassium bromide (0.3 mol % per mole of finished silver halide), thereby completing chemical sensitization. The emulsion thus obtained was designated as Emulsion RH-1.

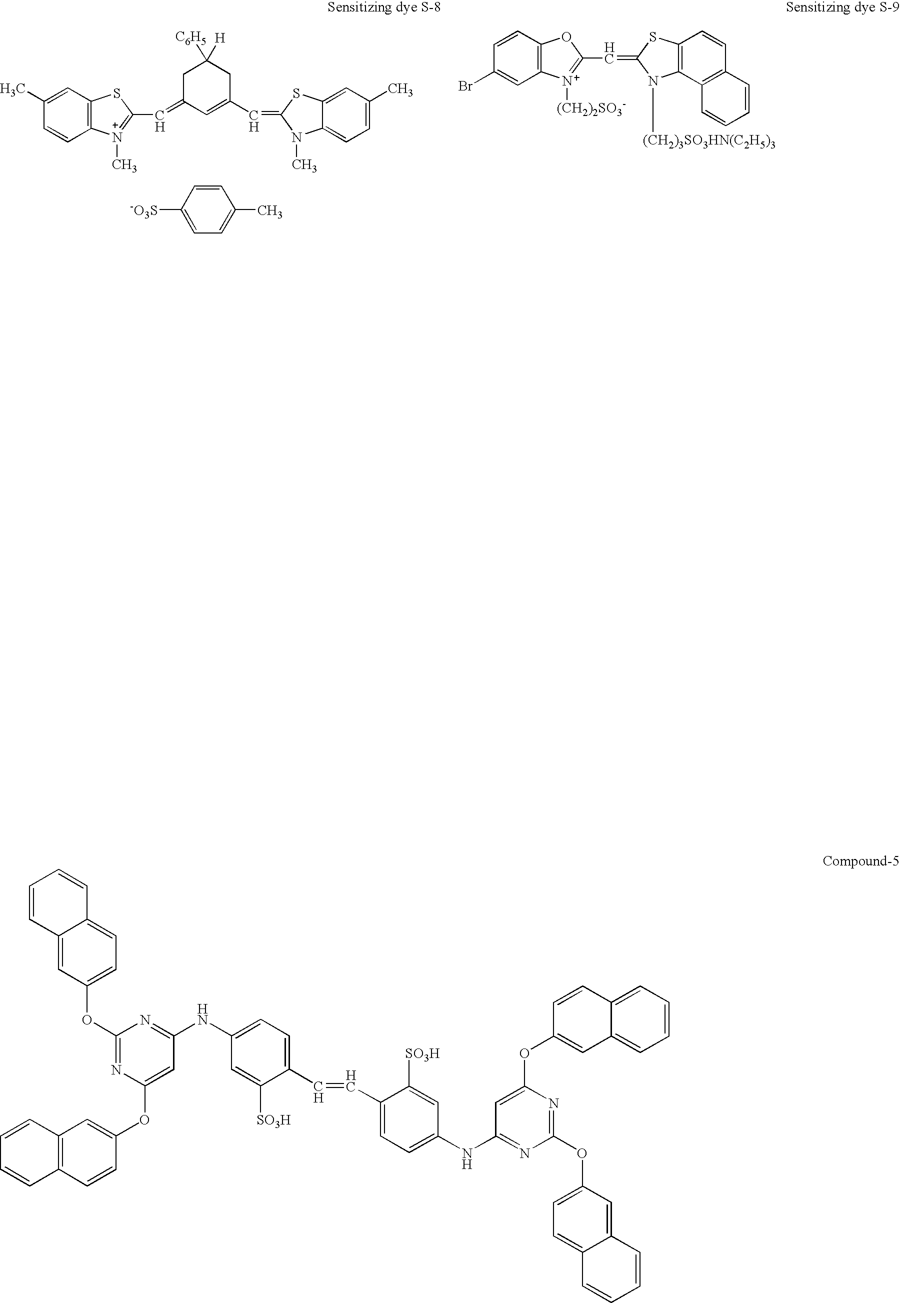

Emulsion RL-1 was prepared in the same manner as in the preparation of Emulsion RH-1, except that the amounts of 1-(5-methylureidophenyl)-5-mercaptotetrazole and 1-(3-acetamidophenyl)-5-mercaptotetrazole added at the conclusion of chemical sensitization were each increased by a factor of 1.5.

(Preparation of coating solution for the first layer)

Into 17 g of a solvent (Solv-4), 3 g of a solvent (Solv-6), 17 g of a solvent (Solv-9), and 45 ml of ethyl acetate, were dissolved 24 g of a yellow coupler (Ex-Y), 6 g of a color-image stabilizer (Cpd-8), 1 g of a color-image stabilizer (Cpd-16), 1 g of a color-image stabilizer (Cpd-17), and 11 g of a color-image stabilizer (Cpd-18), 1 g of a color-image stabilizer (Cpd-19), 11 g of a color-image stabilizer (Cpd-21), 0.1 g of an additive (ExC-3), and 1 g of a color-image stabilizer (UV-A). This solution was emulsified and dispersed in 205 g of a 20 mass % aqueous gelatin solution containing 3 g of sodium dodecylbenzenesulfonate, with a high-speed stirring emulsifier (dissolver). Water was added thereto, to prepare 700 g of Emulsified dispersion A.

Then, the above Emulsified dispersion A and Emulsions BH-1 and BL-1 were mixed in the form of solution, to prepare the first-layer coating solution, so that it would have the composition shown below. A coating amount of emulsion is in terms of silver.

The coating solutions for the second layer to the seventh layer were prepared in the similar manner as that for the first-layer coating solution. As a gelatin hardener for each layer, (H-1), (H-2), and (H-3) were used. Further, to each layer, were added (Ab-1), (Ab-2), (Ab-3), and (Ab-4), so that the total amounts would be 1.0 mg/m², 43.0 mg/m², 3.5 mg/m², and 7.0 mg/m², respectively. Further, 2-methyl-4-isothiazoline-3-one was added in an amount of 10.0 mg/m².

Further, to the second layer, the third layer, and the fifth layer, was added 1-(3-methylureidophenyl)-5-mercaptotetrazole in amounts of 1.20 mg/m², 0.36 mg/m², and 0.44 mg/m², respectively. To the first layer and the fourth layer, was added 4-hydroxy-6-methyl-1,3,3a,7-tetrazaindene in amounts of 1.5×10⁻⁴ mol and 1.8×10⁻⁴ mol, respectively, per mol of silver halide. To the red-sensitive emulsion layer, was added a copolymer latex of methacrylic acid and butyl acrylate (1:1 in mass ratio; average molecular weight, 200,000 to 400,000) in an amount of 0.05 g/m². Disodium catecol-3,5-disulfonate was added to the second layer, the third layer, and the fifth layer so that coating amounts would be 25 mg/m², II mg/m², and 14 mg/m², respectively. Further, to each layer, sodium polystyrene sulfonate was added to adjust viscosity of the coating solutions, if necessary. Further, in order to prevent irradiation, the following water-soluble dyes (Dye-1) to (Dye-4) were added (coating amounts are shown in parentheses).

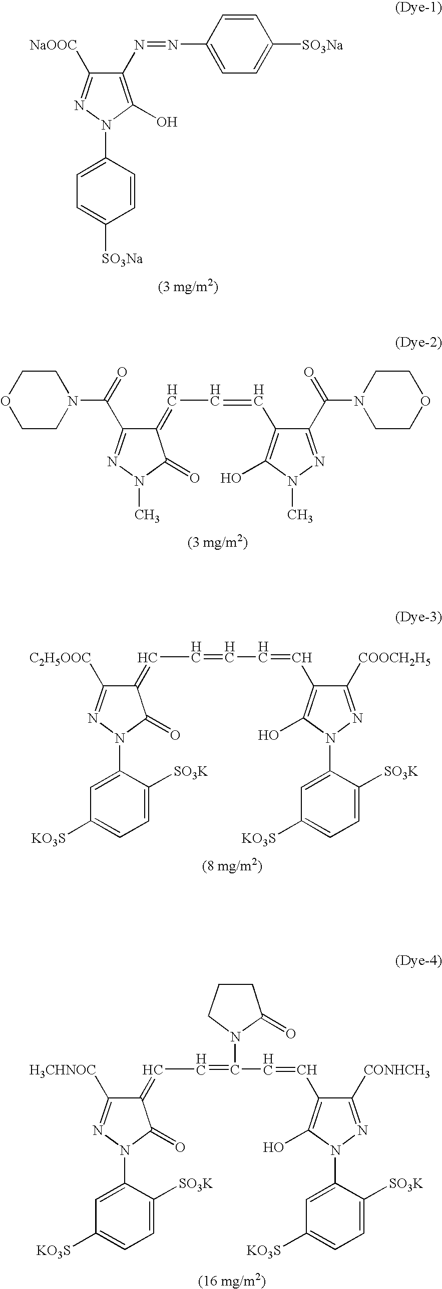

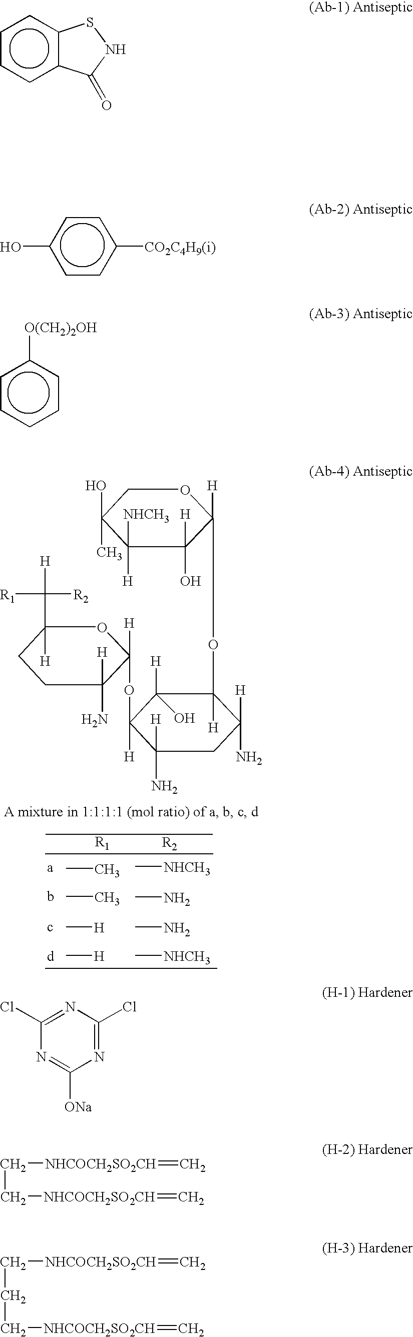

### (Layer Structure)

The composition of each layer is shown below. The numerals show coating amounts (g/m²). In the case of silver halide emulsions, the coating amounts are in terms of silver.

In Sample 101, the total coating amount of gelatin was 4.44 g/m², the total coating amount of silver was 0.33 g/m², the dry thickness was 6.2 μm, and the total swelled film thickness was 16.7 μm.

### Support

Polyethylene resin laminated paper
{The polyethylene resin on the first layer side contained white pigments (TiO₂, content of 16 mass %; ZnO, content of 4 mass %), a fluorescent whitening agent (4,4′-bis(5-methylbenzoxazolyl)stilbene, content of 0.03 mass %), and a bluish dye (ultramarine, content of 0.33 mass %); and the amount of the polyethylene resin was 29.2 g/m².}

| First layer (Blue-sensitive emulsion layer) | |
|---|---|
| Emulsion (a 4:6 mixture of BH-1 and BL-1 | 0.14 |
| (mol ratio for silver)) | |
| Gelatin | 1.00 |
| Yellow coupler (Ex-Y) | 0.250 |
| Color-image stabilizer (Cpd-8) | 0.063 |
| Color-image stabilizer (Cpd-16) | 0.010 |
| Color-image stabilizer (Cpd-17) | 0.010 |
| Color-image stabilizer (Cpd-18) | 0.115 |
| Color-image stabilizer (Cpd-19) | 0.010 |
| Color-image stabilizer (Cpd-21) | 0.115 |
| Additive (ExC-3) | 0.001 |
| Color-image stabilizer (UV-A) | 0.010 |
| Solvent (Solv-4) | 0.177 |
| Solvent (Solv-6) | 0.031 |
| Solvent (Solv-9) | 0.177 |
| Second layer (Intermediate color-forming layer) | |
| Gelatin | 0.34 |
| Yellow coupler (Ex-Y) | 0.085 |
| Color-image stabilizer (Cpd-8) | 0.021 |
| Color-image stabilizer (Cpd-16) | 0.004 |
| Color-image stabilizer (Cpd-17) | 0.004 |
| Color-image stabilizer (Cpd-18) | 0.039 |
| Color-image stabilizer (Cpd-19) | 0.004 |
| Color-image stabilizer (Cpd-21) | 0.039 |
| Additive (ExC-3) | 0.0004 |
| Color-image stabilizer (UV-A) | 0.004 |
| Solvent (Solv-4) | 0.060 |
| Solvent (Solv-6) | 0.011 |
| Solvent (Solv-9) | 0.060 |
| Third layer (Color-mixing-inhibiting layer) | |
| Gelatin | 0.32 |
| Color-mixing inhibitor (Cpd-4) | 0.020 |
| Color-mixing inhibitor (Cpd-12) | 0.004 |
| Color-image stabilizer (Cpd-3) | 0.004 |
| Color-image stabilizer (Cpd-5) | 0.004 |
| Color-image stabilizer (Cpd-6) | 0.020 |
| Color-image stabilizer (UV-A) | 0.020 |
| Color-image stabilizer (Cpd-7) | 0.002 |
| Solvent (Solv-1) | 0.024 |
| Solvent (Solv-2) | 0.024 |
| Solvent (Solv-5) | 0.028 |
| Solvent (Solv-8) | 0.028 |
| Fourth Layer (Red-sensitive emulsion layer) | |
| Emulsion (a 5:5 mixture of RH-1 and RL-1 | 0.10 |
| (in terms of mol for silver)) | |
| Gelatin | 0.80 |
| Cyan coupler (ExC-1) | 0.175 |
| Cyan coupler (ExC-2) | 0.005 |
| Cyan coupler (ExC-3) | 0.015 |
| Color-image stabilizer (Cpd-1) | 0.011 |
| Color-image stabilizer (Cpd-7) | 0.011 |
| Color-image stabilizer (Cpd-9) | 0.033 |
| Color-image stabilizer (Cpd-10) | 0.001 |
| Color-image stabilizer (Cpd-14) | 0.001 |
| Color-image stabilizer (Cpd-15) | 0.165 |
| Color-image stabilizer (Cpd-16) | 0.035 |
| Color-image stabilizer (Cpd-17) | 0.022 |
| Color-image stabilizer (UV-5) | 0.077 |
| Solvent (Solv-5) | 0.077 |
| Fifth Layer (Color-mixing-inhibiting layer) | |
| Gelatin | 0.38 |
| Color-mixing inhibitor (Cpd-4) | 0.024 |
| Color-mixing inhibitor (Cpd-12) | 0.005 |
| Color-image stabilizer (Cpd-3) | 0.005 |
| Color-image stabilizer (Cpd-5) | 0.005 |
| Color-image stabilizer (Cpd-6) | 0.024 |
| Color-image stabilizer (UV-A) | 0.024 |
| Color-image stabilizer (Cpd-7) | 0.002 |
| Solvent (Solv-1) | 0.029 |
| Solvent (Solv-2) | 0.029 |
| Solvent (Solv-5) | 0.033 |
| Solvent (Solv-8) | 0.033 |
| Sixth layer (Green-sensitive emulsion layer) | |
| Emulsion (a 3:7 mixture of GH-1 and GL-1 | 0.09 |
| (in terms of mol of silver)) | |
| Gelatin | 1.10 |
| Magenta coupler (Ex-M) | 0.14 |
| Color-image stabilizer (Cpd-2) | 0.01 |
| Color-image stabilizer (Cpd-8) | 0.01 |
| Color-image stabilizer (Cpd-9) | 0.005 |
| Color-image stabilizer (Cpd-10) | 0.005 |
| Color-image stabilizer (Cpd-11) | 0.0001 |
| Color-image stabilizer (Cpd-18) | 0.01 |
| Ultraviolet absorber (UV-B) | 0.26 |
| Solvent (Solv-3) | 0.04 |
| Solvent (Solv-4) | 0.08 |
| Solvent (Solv-6) | 0.05 |
| Solvent (Solv-9) | 0.12 |
| Solvent (Solv-7) | 0.11 |
| Compound (S1-4) | 0.0015 |
| Seventh layer (Protective layer) | |
| Gelatin | 0.50 |
| Additive (Cpd-20) | 0.015 |
| Liquid paraffin | 0.01 |
| Surfactant (Cpd-13) | 0.01 |

(Ex-Y)Yellow coupler

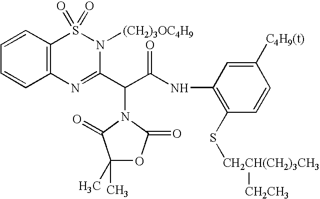

(Ex-M) Magenta coupler
A mixture in 40:40:20 (mol ratio) of

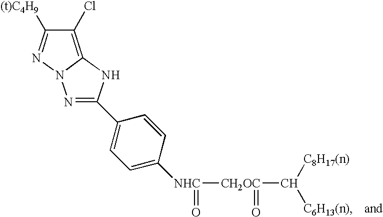

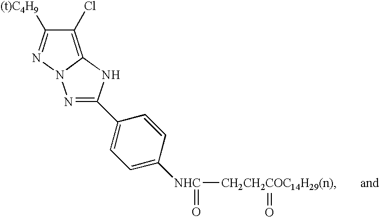

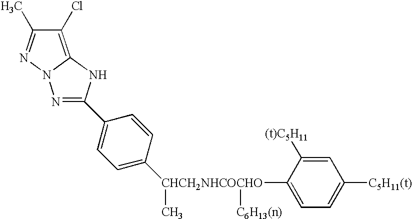

(ExC-1)Cyan coupler

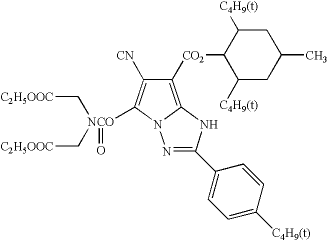

(ExC-2)Cyan coupler

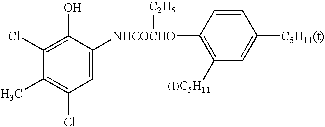

(ExC-3)Cyan coupler

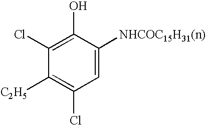

(Cpd-1) Color-image stabilizer

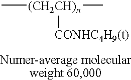

(Cpd-2) Color-image stabilizer

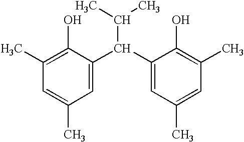

(Cpd-3) Color-image stabilizer

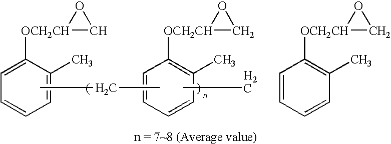

(Cpd-4) Color-image stabilizer

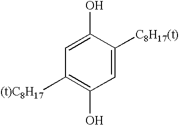

(Cpd-5) Color-image stabilizer

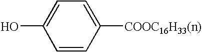

(Cpd-6) Color-image stabilizer

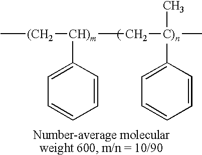

(Cpd-7) Color-image stabilizer

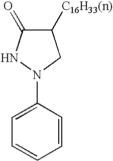

(Cpd-8) Color-image stabilizer

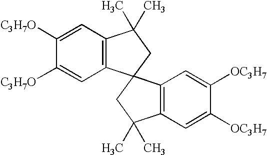

(Cpd 9) Color-image stabilizer

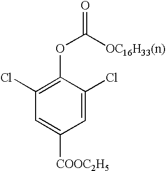

(Cpd 10) Color-image stabilizer

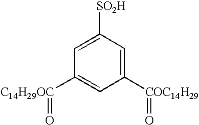

(Cpd-11)

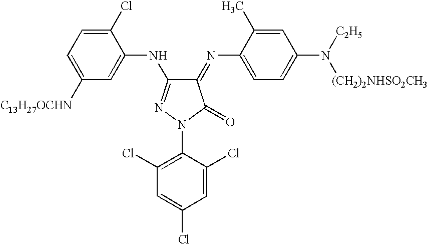

(Cpd-12)

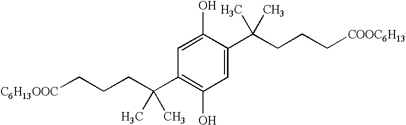

(Cpd-13) A mixture in 6:2:2 (mol ratio) of (a)/(b)/(c)
(a)

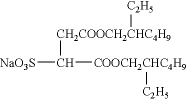

(b)

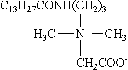

(c)

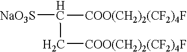

(Cpd-14)

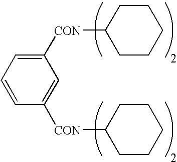

(Cpd-15)

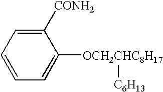

(Cpd-16)

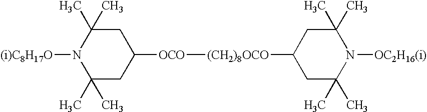

(Cpd-17)

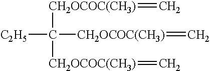

(Cpd-18)

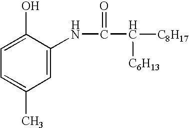

(Cpd-19)

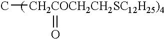

(Cpd-20)

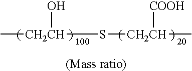

(Cpd-21)
KAYARAD DPCA-30
trade name, manufactured by
Nippon Kayaku Co. Ltd.
(Solv-1)

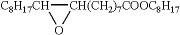

(Solv-2)

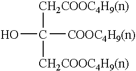

(Solv-3)

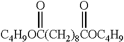

(Solv-4)

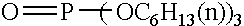

(Solv-5)

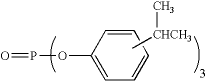

(Solv-6)

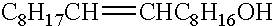

(Solv-7)

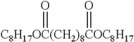

(Solv-8)

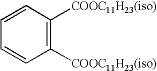

(Solv-9)

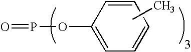

(S1-4)

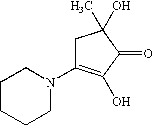

UV-A: A mixture in 1/7/2 (Mass ratio) of (UV-1)/(UV-4)/(UV-5)
UV-B: A mixture in 1/1/2/3/3 (Mass ratio) of
(UV-1)/(UV-2)/(UV-3)/(UV-4)/(UV-5)
(UV-1)

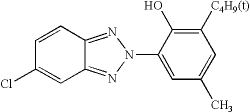

(UV-2)

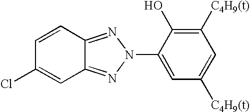

(UV-3)

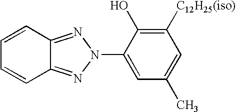

(UV-4)

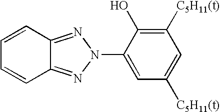

(UV-5)

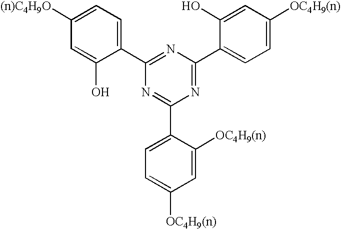

The thus-obtained sample was designated to as Sample 101. Samples 102 to 111 were prepared in the same manner as Sample 101, except that Compound A used in the preparation of Emulsions BH-1 and BL-1 was changed, as shown in Table 2 below.

Each sample after coating was aged for ten days in an atmosphere regulated at 25° C. and 55% R.H., thereby fully advancing in hardening reaction. Then, evaluations thereof were made.

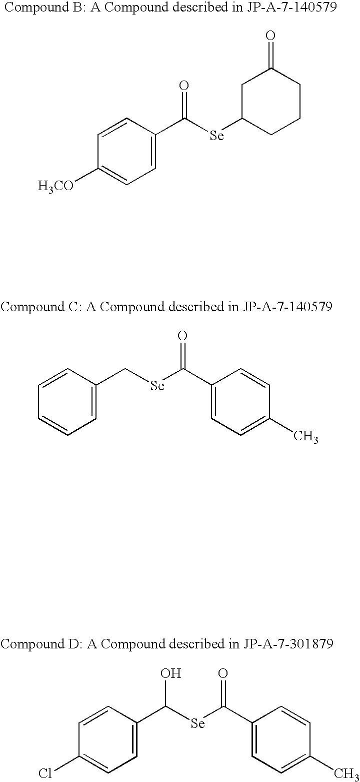

### Processing

The aforementioned Sample 101 was made into a roll with width 127 mm; the resultant sample was exposed to light with a standard photographic image, using Digital Minilab Frontier 350 (trade name, manufactured by Fuji Photo Film Co., Ltd.); and then, the exposed sample was continuously processed (running test) in the following processing steps, until an accumulated replenisher amount of the color developing solution reached to be equal to twice the color developer tank volume.

<Processing A>

| Processing step | Temperature | Time | Replenishment rate* |
|---|---|---|---|
| Color development | 38.5° C. | 45 sec | 45 mL |
| Bleach-fixing | 38.0° C. | 45 sec | Replenisher A 17.5 mL |
| | | | Replenisher B 17.5 mL |
| Rinse 1 | 38.0° C. | 20 sec | — |
| Rinse 2 | 38.0° C. | 20 sec | — |
| Rinse 3 | 38.0° C. | 20 sec | — |
| Rinse 4 | 38.0° C. | 20 sec | 121 mL |
| Drying | 80° C. | | |

The compositions of each processing solution were as follows.

| (Color developer) | (Tank solution) | | (Replenisher) | |
|---|---|---|---|---|
| Water | 800 | ml | 800 | ml |
| Fluorescent whitening agent | 2.2 | g | 5.1 | g |
| (FL-1) | | | | |
| Fluorescent whitening agent | 0.35 | g | 1.75 | g |
| (FL-2) | | | | |
| Triisopropanolamine | 8.8 | g | 8.8 | g |
| Polyethyleneglycol | 10.0 | g | 10.0 | g |
| (Average molecular weight: 300) | | | | |
| Ethylenediaminetetraacetic acid | 4.0 | g | 4.0 | g |
| Sodium sulfite | 0.10 | g | 0.20 | g |
| Potassium chloride | 10.0 | g | — | |
| Sodium 4,5-dihydroxybenzene- | 0.50 | g | 0.50 | g |
| 1,3-disulfonate | | | | |
| Disodium-N,N-bis | 8.5 | g | 14.0 | g |
| (sulfonatoethyl)hydroxylamine | | | | |
| 4-Amino-3-methyl-N-ethyl-N- | 4.8 | g | 14.0 | g |
| (β-methanesulfonamidoethyl) | | | | |
| aniline•3/2 sulfate•monohydrate | | | | |
| Potassium carbonate | 26.3 | g | 26.3 | g |
| Water to make | 1,000 | ml | 1,000 | ml |

| | | |
|---|---|---|
| pH (25° C., adjusted using | 10.15 | 12.40 |
| sulfuric acid and KOH) | | |

| (Bleach-fixing solution) | (Tank solution) | | (Replenisher A) | | (Replenisher B) | |
|---|---|---|---|---|---|---|
| Water | 800 | mL | 500 | mL | 300 | mL |
| Ammonium thiosulfate | 107 | mL | — | | 386 | mL |
| (750 g/L) | | | | | | |
| Ammonium bisulfite (65%) | 30.0 | g | — | | 190 | g |
| Ethylenediamine tetraacetate | 47.0 | g | 133 | g | — | |
| iron (III) ammonium | | | | | | |
| Ethylenediamine tetraacetic acid | 1.4 | g | 5 | g | 6 | g |
| Nitric acid (67%) | 16.5 | g | 66.0 | g | — | |
| Imidazole | 14.6 | g | 50.0 | g | — | |
| m-Carboxybenzenesulfinic acid | 8.3 | g | 33.0 | g | — | |
| Water to make | 1,000 | ml | 1,000 | ml | 1,000 | ml |

| | | | |
|---|---|---|---|
| pH (25° C.; adjusted | 6.5 | 6.0 | 6.0 |
| using nitric acid and | | | |
| aqua ammonia) | | | |

| (Rinse solution) | (Tank solution) | | (Replenisher) | |
|---|---|---|---|---|
| Sodium chlorinated-isocyanurate | 0.02 | g | 0.02 | g |
| Deionized water (conductivity | 1,000 | ml | 1,000 | ml |
| 5 μS/cm or less) | | | | |

| | | |
|---|---|---|
| pH (25° C.) | 6.5 | 6.5 |

(Note)
*Replenishment rate per m² of the photosensitive material to be processed
**A rinse cleaning system RC50D, trade name, manufactured by Fuji
Photo Film Co., Ltd., was installed in the above Rinse 3,
and the rinse solution was taken out from Rinse 3
and sent to a reverse osmosis membrane module (RC50D) by using
a pump. The permeated water obtained in that tank was supplied
to Rinse 4, and the concentrated liquid was returned to Rinse 3.
Pump pressure was controlled such that the permeated water in the
reverse osmosis module would be maintained in an amount of
50 to 300 ml/min, and the rinse solution was circulated under controlled
temperature for 10 hours a day. The rinse was made in a four-tank
counter-current system from Rinse 1 to Rinse 4.
FL-1

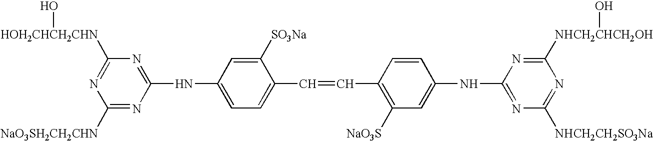

FL-2

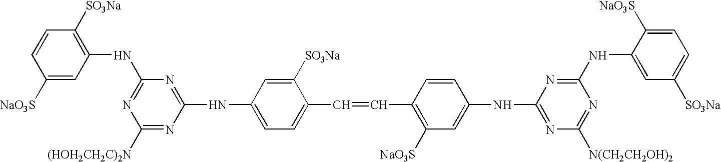

Each sample was subjected to gradation exposure to impart gray, with the following exposure apparatus; and then, at five seconds after the exposure was finished, the sample was subject to color-development processing by the above processing. As the laser light sources, used were a blue-light laser of wavelength about 470 nm which was taken out of a semiconductor laser (oscillation wavelength about 940 nm) by converting the wavelength by an SHG crystal of LiNbO₃ having a waveguide-like inverse domain structure, a green-light laser of wavelength about 530 nm which was taken out of a semiconductor laser (oscillation wavelength about 1,060 nm) by converting the wavelength by an SHG crystal of LiNbO₃ having a waveguide-like inverse domain structure, and a red-light semiconductor laser (Type No. HL6501 MG, manufactured by Hitachi, Ltd.) of wavelength about 650 nm. Each of these three color laser lights was moved in a direction perpendicular to the scanning direction by a polygon mirror so that it could be scanned to expose successively on a sample. Each of the semiconductor lasers is maintained at a constant temperature by means of a Peltier element, to obviate light intensity variations associated with temperature variations. The laser beam had an effective diameter of 80 μm and a scanning pitch of 42.3 μm (600 dpi), and an average exposure time per pixel was 1.7×10⁻⁷ seconds. The sensitivity (S) was the antilogarithm of the inverse number of an exposure amount giving a developed color density higher by 1.0 than the minimum developed yellow color density (Dmin), and it was expressed as a relative value when the sensitivity of Sample 101 was set to 100.

To evaluate the processing variation tolerance of each photosensitive material, the increment of the minimum yellow density (ΔDmin) by extension of a color development time to 120 seconds was determined as the differential between this 120-second processing and foregoing 45-second processing. A smaller increment herein means more effective suppression of the increase in fog density by processing variation.

TABLE 2

| | | Relative | | |
|---|---|---|---|---|
| Sample | Compound added | sensitivity | ΔDmin | Remarks |
| 101 | Compound A | 100 | 0.063 | Comparative example |
| 102 | Compound B | 107 | 0.050 | Comparative example |
| 103 | Compound C | 102 | 0.053 | Comparative example |
| 104 | Compound D | 105 | 0.050 | Comparative example |
| 105 | Exemplified | 141 | 0.035 | This invention |
| | compound 1 | | | |
| 106 | Exemplified | 138 | 0.033 | This invention |
| | compound 21 | | | |
| 107 | Exemplified | 141 | 0.035 | This invention |
| | compound 31 | | | |
| 108 | Exemplified | 138 | 0.030 | This invention |
| | compound 41 | | | |
| 109 | Exemplified | 145 | 0.033 | This invention |
| | compound 51 | | | |
| 110 | Exemplified | 135 | 0.028 | This invention |
| | compound 57 | | | |
| 111 | Exemplified | 135 | 0.030 | This invention |
| | compound 71 | | | |

As can be seen from Table 2, the photosensitive materials containing silver halide emulsions chemically sensitized with compounds represented by formula (1) had high sensitivities and excellent tolerance to fogging under processing variations.

### Example 2

### Preparation of Blue-Sensitive Layer Emulsion BH-2

Emulsion grains were prepared in the same manner as in the preparation of Emulsion BH-1 in Example 1, except that the temperature and the addition speed at the step of mixing silver nitrate aqueous solution and sodium chloride aqueous solution by simultaneous addition were changed, and that the amounts of respective metal complexes added in the course of the addition of silver nitrate aqueous solution and sodium chloride aqueous solution were changed. The thus-obtained emulsion grains were monodisperse cubic silver iodobromochloride grains having a side length of 0.45 μm and a variation coefficient of 8.9%. After re-dispersion of this emulsion, Emulsion BH-2 was prepared by subjecting spectral sensitization and chemical sensitization in the same manner as Emulsion BH-1, except that the amounts of various compounds added in Emulsion BH-1 were changed.

### (Preparation of Blue-Sensitive Layer Emulsion BH-3)

Emulsion grains were prepared in the same manner as in the preparation of Emulsion BH-1 in Example 1, except that the temperature and the addition speed at the step of mixing silver nitrate aqueous solution and sodium chloride aqueous solution by simultaneous addition were changed, and that the amounts of respective metal complexes added in the course of the addition of silver nitrate aqueous solution and sodium chloride aqueous solution were changed. The thus-obtained emulsion grains were monodisperse cubic silver iodobromochloride grains having a side length of 0.55 μm and a variation coefficient of 8.5%. After re-dispersion of this emulsion, Emulsion BH-3 was prepared by subjecting spectral sensitization and chemical sensitization in the same manner as Emulsion BH-1, except that the amounts of various compounds added in Emulsion BH-1 were changed.

### (Preparation of Sample 201)

Sample 201 was prepared in the same manner as Sample 101 in Example 1, except that the emulsions in the first layer (i.e. bleu-sensitive emulsion layer) were replaced with Emulsion BH-1 alone in an equivalent amount based on silver.

### (Preparation of Samples 211, 221, 231, and 241)

Coating samples were each produced in the same manner as Sample 201, except that the emulsions in the first layer (blue-sensitive emulsion layer) were replaced as shown in Table 3. All mixing ratios shown in Table 3 with respect to the emulsions are based on silver amount. The proportion of emulsion grains having side lengths greater than 0.50 μm is denoted as “L>0.50 μm” and expressed in percentage (%), the proportion of emulsion grains having side lengths greater than 0.45 μm and the proportion of emulsion grains having side lengths greater than 0.40 μm are denoted similarly to the above.

TABLE 3

| Sample | 1st layer emulsion | L > 0.50 μm | L > 0.45 μm | L > 0.40 μm |
|---|---|---|---|---|
| 201 | BH-1 | 0% | 0% | 10% |
| 211 | BH-1/BH-2 mixture | 5% | 15% | 40% |
| | 50/50 | | | |
| 221 | BH-2 | 10% | 55% | 85% |
| 231 | BH-2/BH-3 mixture | 35% | 75% | 95% |
| | 50/50 | | | |
| 241 | BH-3 | 90% | 100% | 100% |

Samples were produced in the same manners as Sample 201, 211, 221, 231, and 241, respectively, except that Compound A used for the chemical sensitization of the emulsion in the first layer was replaced with the compounds exemplifying the present invention as shown in Table 4. These samples were evaluated by the same method as in Example 1, and their individual relative sensitivities (S) and stabilities to processing variations (ΔDmin) are shown in Table 4 as values relative to those of the samples using Compound A.

TABLE 4

| Sample | Compound added | Relative sensitivity | ΔDmin | Remarks |
|---|---|---|---|---|
| 201 | Compound A | 100 | 0.070 | Comparative example |
| 202 | Exemplified compound 1 | 138 | 0.038 | This invention |
| 203 | Exemplified compound 41 | 135 | 0.035 | This invention |
| 204 | Exemplified compound 51 | 141 | 0.038 | This invention |
| 205 | Exemplified compound 57 | 135 | 0.033 | This invention |
| 211 | Compound A | 100 | 0.078 | Comparative example |
| 212 | Exemplified compound 1 | 135 | 0.045 | This invention |
| 213 | Exemplified compound 41 | 132 | 0.043 | This invention |
| 214 | Exemplified compound 51 | 138 | 0.043 | This invention |
| 215 | Exemplified compound 57 | 132 | 0.040 | This invention |
| 221 | Compound A | 100 | 0.088 | Comparative example |
| 222 | Exemplified compound 1 | 132 | 0.055 | This invention |
| 223 | Exemplified compound 41 | 132 | 0.053 | This invention |
| 224 | Exemplified compound 51 | 135 | 0.058 | This invention |
| 225 | Exemplified compound 57 | 132 | 0.050 | This invention |
| 231 | Compound A | 100 | 0.105 | Comparative example |
| 232 | Exemplified compound 1 | 126 | 0.090 | This invention |
| 233 | Exemplified compound 41 | 123 | 0.085 | This invention |
| 234 | Exemplified compound 51 | 129 | 0.088 | This invention |
| 235 | Exemplified compound 57 | 120 | 0.085 | This invention |
| 241 | Compound A | 100 | 0.125 | Comparative example |
| 242 | Exemplified compound 1 | 126 | 0.115 | This invention |
| 243 | Exemplified compound 41 | 120 | 0.113 | This invention |
| 244 | Exemplified compound 51 | 126 | 0.115 | This invention |
| 245 | Exemplified compound 57 | 117 | 0.110 | This invention |

From the results shown in Table 4, it can be seen that the photosensitive materials using the compounds according to the present invention had high sensitivities and superiority in antifogging properties under processing variations. In addition, performance differentials between the compounds according to the invention and the comparative compounds were found to be noticeable in cases in which large-sized grains were not included in the emulsion grains. More specifically, Samples 202 to 205, 212 to 215, and 222 to 225, which were substantially free of grains having side lengths of 0.50 μm or more, had especially marked increases in sensitivity, compared with samples using comparative compounds, and were noticeably prevented from suffering fog increases under processing variations, so these samples are preferred embodiments of the present invention.

### Example 3

Evaluations were made in the same manner as in Example 1, except that the following Processing B was used in place of Processing A in Example 1. The tolerance to processing variations was expressed in terms of the increment of Dmin (ΔDmin) between the processing in which the color development time was set at 30 seconds and the processing in which the color development time was set at 12 seconds. The results of evaluations made on the yellow images are shown in Table 5.

The aforementioned Sample 101 was made into a roll with width 127 mm; the resultant sample was exposed to light with a standard photographic image, using a laser exposure described below; and then, the exposed sample was continuously processed (running test) in the following processing steps, using Digital Minilab Frontier 340 (trade name, manufactured by Fuji Photo Film Co., Ltd.), until an accumulated replenisher amount of the color developing solution reached to be equal to twice the color developer tank volume. A processing with this running processing solutions was named processing B. The processor was modified by modifying the processing racks thereby to change the conveyance speed, so as to set the following processing time conditions.

<Processing B>

| Processing step | Temperature | Time | Replenishment rate* |
|---|---|---|---|
| Color development | 45.0° C. | 12 sec | 35 mL |
| Bleach-fixing | 40.0° C. | 12 sec | Replenisher A 15 mL |
| | | | Replenisher B 15 mL |
| Rinse 1 | 45.0° C. | 4 sec | — |
| Rinse 2 | 45.0° C. | 2 sec | — |
| Rinse 3 | 45.0° C. | 2 sec | — |
| Rinse 4 | 45.0° C. | 3 sec | 175 mL |
| Drying | 80° C. | 15 sec | |

(Note)
*Replenisher amount per m² of the light-sensitive material to be processed

As the laser light sources, used were a blue-light laser of wavelength about 440 nm (Presentation by Nichia Corporation at the 48th Applied Physics Related Joint Meeting, in March of 2001), a green-light laser of wavelength about 530 nm which was taken out of a semiconductor laser (oscillation wavelength about 1,060 nm) by converting the wavelength by an SHG crystal of LiNbO₃ having a waveguide-like inverse domain structure, and a red-light semiconductor laser (Type No. HL6501 MG, manufactured by Hitachi, Ltd.) of wavelength about 650 nm. Each of these three color laser lights was moved in a direction perpendicular to the scanning direction by a polygon mirror so that it could be scanned to expose successively on a sample. Each of the semiconductor lasers is maintained at a constant temperature by means of a Peltier element, to obviate light intensity variations associated with temperature variations. The laser beam had an effective diameter of 80 μm and a scanning pitch of 42.3 μm (600 dpi), and an average exposure time per pixel was 1.7×10⁻⁷ seconds. The temperature of the semiconductor laser was kept constant by using a Peltier device to prevent the quantity of light from being changed by temperature.

The compositions of each processing solution were as follows.

| (Color developer) | (Tank solution) | | (Replenisher) | |
|---|---|---|---|---|
| Water | 800 | mL | 800 | mL |
| Fluorescent whitening agent (FL-3) | 4.0 | g | 10.0 | g |
| Residual-color-reducing agent (SR-1) | 3.0 | g | 3.0 | g |
| m-Carboxybenzenesulfinic acid | 2.0 | g | 4.0 | g |
| Sodium p-toluenesulfonate | 10.0 | g | 10.0 | g |
| Ethylenediaminetetraacetic acid | 4.0 | g | 4.0 | g |
| Sodium sulfite | 0.10 | g | 0.10 | g |
| Potassium chloride | 10.0 | g | — | |
| Sodium 4,5-dihydroxybenzene- | 0.50 | g | 0.50 | g |
| 1,3-disulfonate | | | | |
| Disodium-N,N-bis(sulfonatoethyl) | 8.5 | g | 14.0 | g |
| hydroxylamine | | | | |
| 4-Amino-3-methyl-N-ethyl-N- | 7.0 | g | 19.0 | g |
| (β-methanesulfonamidoethyl)- | | | | |
| aniline•3/2 sulfate•monohydrate | | | | |
| Potassium carbonate | 26.3 | g | 26.3 | g |
| Water to make | 1000 | mL | 1000 | mL |
| pH (25° C.; adjusted by using | 10.25 | 12.8 | | |
| sulfuric acid and KOH) | | | | |

| (Bleach-fixing solution) | (Tank solution) | | (Replenisher A) | | (Replenisher B) | |
|---|---|---|---|---|---|---|
| Water | 700 | mL | 300 | mL | 300 | mL |
| Ammonium thiosulfate (750 g/L) | 107 | mL | — | | 400 | mL |
| Ammonium sulfite | 30.0 | g | — | | — | |
| Ammonium iron (III) | 47.0 | g | 200 | g | — | |
| ethylenediaminetetraacetate | | | | | | |
| Ethylenediaminetetraacetic acid | 1.4 | g | 0.5 | g | 10.0 | g |
| Nitric acid (67%) | 7.0 | g | 30.0 | g | — | |
| m-Carboxybenzenesulfinic acid | 3.0 | g | 13.0 | g | — | |
| Ammonium bisulfite (65%) | — | | — | | 200 | g |
| Succinic acid | 7.0 | g | 30.0 | g | — | |
| Water to make | 1,000 | mL | 1,000 | mL | 1,000 | mL |

| | | | |
|---|---|---|---|
| pH (25° C.; adjusted by using nitric | 6.0 | 2.0 | 5.6 |
| acid and aqua ammonia) | | | |

| (Rinse solution) | (Tank solution) | | (Replenisher) | |
|---|---|---|---|---|
| Sodium chlorinated-isocyanurate | 0.02 | g | 0.02 | g |
| Deionized water | 1,000 | ml | 1,000 | ml |
| (conductivity 5 μS/cm or less) | | | | |

| | | |
|---|---|---|
| pH (25° C.) | 6.5 | 6.5 |

FL-3

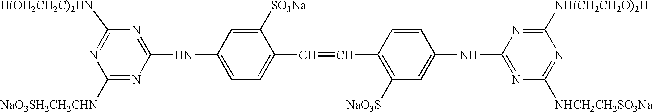

SR-1

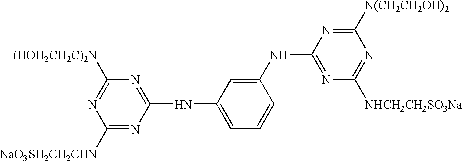

TABLE 5

| | | Relative | | |
|---|---|---|---|---|
| Sample | Compound added | sensitivity | ΔDmin | Remarks |
| 101 | Compound A | 100 | 0.072 | Comparative example |
| 102 | Compound B | 105 | 0.059 | Comparative example |
| 103 | Compound C | 100 | 0.062 | Comparative example |
| 104 | Compound D | 102 | 0.058 | Comparative example |
| 105 | Exemplified | 148 | 0.036 | This invention |
| | compound 1 | | | |
| 106 | Exemplified | 145 | 0.035 | This invention |
| | compound 21 | | | |
| 107 | Exemplified | 148 | 0.036 | This invention |
| | compound 31 | | | |
| 108 | Exemplified | 148 | 0.031 | This invention |
| | compound 41 | | | |
| 109 | Exemplified | 151 | 0.035 | This invention |
| | compound 51 | | | |
| 110 | Exemplified | 141 | 0.030 | This invention |
| | compound 57 | | | |
| 111 | Exemplified | 145 | 0.032 | This invention |
| | compound 71 | | | |

As shown in Table 5, the samples according to the present invention were high in sensitivity and superior in tolerance to processing variations, compared with the comparative samples. Compared with the results obtained in Example 1, the present samples offered significant performance improvements over the samples using the comparative compounds. These evaluation results indicate that the photosensitive materials of the invention are suitable for rapid processing.

### Example 4

When evaluations on magenta images were made in the same manner as in Example 1, except that emulsions were prepared using Compounds A to D, or the compounds according to the present invention, in place of sodium thiosulfate pentahydrate in Emulsions GH-1 and GL-1, and substituted in equivalent amounts based on silver for the emulsions in the sixth layer of Sample 105, it was found that the same results as in Example 1 were obtained.

In addition, when evaluations were made on cyan images in the same manner as in Example 1, except that emulsions were prepared using Compounds A to D, or the compounds according to the present invention, in place of triethylthiourea in Emulsions RH-1 and RL-1, and substituted in equivalent amounts based on silver for the emulsions in the fourth layer of Sample 105, it was found that the same results as in Example 1 were obtained.

### INDUSTRIAL APPLICABILITY

The silver halide color photographic light-sensitive material of the present invention is preferably employed to achieve rapid-processing, and an improvement in fog attributable to processing variations.

Having described our invention as related to the present embodiments, it is our intention that the invention not be limited by any of the details of the description, unless otherwise specified, but rather be construed broadly within its spirit and scope as set out in the accompanying claims.

1. A silver halide color photographic light-sensitive material having, on a support, at least one red-sensitive silver halide emulsion layer, at least one green-sensitive silver halide emulsion layer, and at least one blue-sensitive silver halide emulsion layer, wherein at least one of the silver halide emulsion layers contains a silver halide emulsion having a silver chloride content of at least 90 mol % and being chemically sensitized with at least one compound represented by the following formula (1): 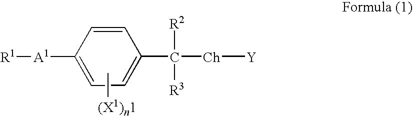
wherein, in formula (1), Ch represents a sulfur atom, a selenium atom, or a tellurium atom; A¹ represents an oxygen atom, a sulfur atom, or NR⁴; R¹ represents a hydrogen atom, an alkyl group, an alkenyl group, an alkynyl group, an aryl group, a heterocyclic group, or an acyl group; R², R³, and R⁴ each independently represent a hydrogen atom, an alkyl group, an alkenyl group, an alkynyl group, an aryl group, or a heterocyclic group; X¹ represents a substituent; n¹ is an integer from 0 to 4; when n¹ is 2 or more, X¹s may be the same or different; and Y represents a group selected from groups represented by the following formula (2), (3), (4), or (5): 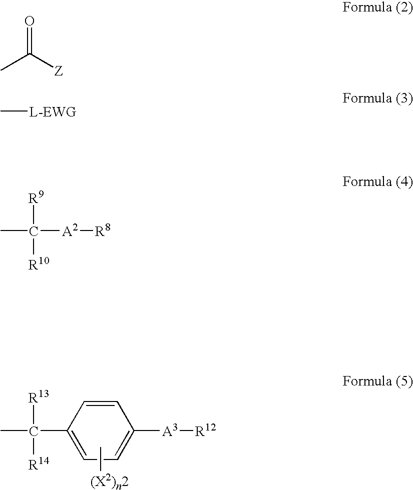
wherein, in formula (2), Z represents an alkyl group, an alkenyl group, an alkynyl group, an aryl group, a heterocyclic group, OR⁵, or NR⁶R⁷, in which R⁵, R⁶ and R⁷ each independently represent an alkyl group, an alkenyl group, an alkynyl group, an aryl group, or a heterocyclic group;
wherein, in formula (3), L represents a divalent linking group; and EWG represents an electron withdrawing group;
wherein, in formula (4), A² represents an oxygen atom, a sulfur atom, or NR¹¹; and R⁸, R⁹, R¹⁰, and R¹¹ each independently represent a hydrogen atom, an alkyl group, an alkenyl group, an alkynyl group, an aryl group, or a heterocyclic group; and
wherein, in formula (5), A³ represents an oxygen atom, a sulfur atom, or NR¹⁵; R¹² represents a hydrogen atom, an alkyl group, an alkenyl group, an alkynyl group, an aryl group, a heterocyclic group, or an acyl group; R¹³, R¹⁴, and R¹⁵ each independently represent a hydrogen atom, an alkyl group, an alkenyl group, an alkynyl group, an aryl group, or a heterocyclic group; X² represents a substituent; n² is an integer from 0 to 4; when n² is 2 or more, X²s may be the same or different.

2. The silver halide color photographic light-sensitive material as claimed in claim 1, wherein the silver halide emulsion layer containing the silver halide emulsion chemically sensitized with at least one compound represented by formula (1) is substantially free of silver halide grains greater than 0.50 μm in side length.

3. The silver halide color photographic light-sensitive material as claimed in claim 1, wherein the silver halide emulsion layer containing the silver halide emulsion chemically sensitized with at least one compound represented by formula (1) is substantially free of silver halide grains grater than 0.45 μm in side length.

4. The silver halide color photographic light-sensitive material as claimed in claim 1, wherein the blue-sensitive silver halide emulsion layer is substantially free of silver halide grains greater than 0.50 μm in side length.

5. The silver halide color photographic light-sensitive material as claimed in claim 1, wherein the blue-sensitive silver halide emulsion layer is substantially free of silver halide grains greater than 0.45 μm in side length.

6. The silver halide color photographic light-sensitive material as claimed in claim 1, wherein Ch represents a selenium atom, A¹ represents an oxygen atom or a sulfur atom, R¹ represents a hydrogen atom, an alkyl group, an aryl group, or an acyl group, R² and R³ each represent a hydrogen atom, an alkyl group, or an aryl group, n¹ represents an integer of 0 to 2, X¹ represents an alkyl group, an aryl group, a carboxyl group including a salt thereof, a hydroxyl group, an alkoxy group, an aryloxy group, an alkyl-, aryl-, or heterocyclic-amino group, an ureido group, an alkylthio group, an arylthio group, or a sulfo group including a salt thereof, and Z represents an alkyl group, an aryl group, or a heterocyclic group, and Y represents a group represented by formula (2).

7. The silver halide color photographic light-sensitive material as claimed in claim 1, wherein Ch represents a selenium atom, A¹ represents an oxygen atom or a sulfur atom, R¹ represents a hydrogen atom, an alkyl group, an aryl group, or an acyl group, R² and R³ each independently represent a hydrogen atom, an alkyl group, or an aryl group, n¹ represents an integer of 0 to 2, X¹ represents an alkyl group, an aryl group, a carboxyl group including a salt thereof, a hydroxyl group, an alkoxy group, an aryloxy group, an alkyl-, aryl-, or heterocyclic-amino group, an ureido group, an alkylthio group, an arylthio group, or a sulfo group including a salt thereof L represents a group represented by formula (L1) or formula (L2), and EWG represents an acyl group, a formyl group, a carbamoyl group, an alkoxycarbonyl group, an aryloxycarbonyl group, a cyano group, a nitro group, an alkylsulfonyl group, an arylsulfonyl group, a carboxyl group, or an alkyl group substituted by at least two halogen atoms, and Y represents a group represented by formula (3); 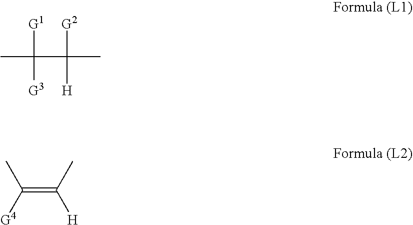
wherein, in formulae (L1) and (L2), G¹, G², G³, and G⁴ each independently represent a hydrogen atom, an alkyl group having 1 to 10 carbon atoms, an aryl group having 6 to 20 carbon atoms, or a heterocyclic group having 1 to 10 carbon atoms.

8. The silver halide color photographic light-sensitive material as claimed in claim 1, wherein Ch represents a selenium atom, A¹ represents an oxygen atom or a sulfur atom, R¹ represents a hydrogen atom, an alkyl group, an aryl group, or an acyl group, R² and R³ each independently represent a hydrogen atom, an alkyl group, or an aryl group, n¹ represents an integer of 0 to 2, X¹ represents an alkyl group, an aryl group, a carboxyl group including a salt thereof, a hydroxyl group, an alkoxy group, an aryloxy group, an alkyl-, aryl-, or heterocyclic-amino group, an ureido group, an alkylthio group, an arylthio group, or a sulfo group including a salt thereof, A² represents an oxygen atom or a sulfur atom, R⁸ represents an alkyl group or an aryl group, and R⁹ and R¹⁰ each independently represents a hydrogen atom, an alkyl group, an aryl group, or a heterocyclic group, and Y represents a group represented by formula (4).

9. The silver halide color photographic light-sensitive material as claimed in claim 1, wherein Ch represents a selenium atom, A¹ represents an oxygen atom or a sulfur atom, R¹ represents a hydrogen atom, an alkyl group, an aryl group, or an acyl group, R² and R³ each independently represent a hydrogen atom, an alkyl group, or an aryl group, n¹ represents an integer of 0 to 2, X¹ represents an alkyl group, an aryl group, a carboxyl group including a salt thereof, a hydroxyl group, an alkoxy group, an aryloxy group, an alkyl-, aryl-, or heterocyclic-amino group, an ureido group, an alkylthio group, an arylthio group, or a sulfo group including a salt thereof, A³ represents an oxygen atom or a sulfur atom, R¹² represents a hydrogen atom, an alkyl group, an aryl group, or an acyl group, R¹³ and R¹⁴ each represent a hydrogen atom, an alkyl group, or an aryl group, n2 represents an integer of 0 to 2, X² represents an alkyl group, an aryl group, a carboxyl group including a salt thereof, a hydroxyl group, an alkoxy group, an aryloxy group, an alkyl-, aryl-, or heterocyclic-amino group, an ureido group, an alkylthio group, an arylthio group, or a sulfo group including a salt thereof, and Y represents a group represented by formula (5).

10. The silver halide color photographic light-sensitive material as claimed in claim 1, wherein the silver chloride content is 95 mol % or more.

11. The silver halide color photographic light-sensitive material as claimed in claim 1, wherein the silver chloride content is 98 mol % or more.
